(19) United States
(12) Patent Application Publication
(10) Pub. No.: US 2012/0123865 A1
(43) Pub. Date: May 17, 2012

(54) ENHANCED SHOPPING EXPERIENCE FOR MOBILE STATION USERS

(75) Inventor: Doreen Lynn SALZANO, Valley Center, CA (US)

(73) Assignee: Cellco Partnership d/b/a Verizon Wireless, Basking Ridge, NJ (US)

(21) Appl. No.: 13/293,949

(22) Filed: Nov. 10, 2011

Related U.S. Application Data
(60) Provisional application No. 61/413,229, filed on Nov. 12, 2010.

(51) Int. Cl. G06Q 30/02

(52) U.S. Cl. 705/14.55; 705/26.4; 705/26.8

(57) ABSTRACT

An enhanced shopping experience is provided via a graphical user interface of a mobile station. The shopping experience may include a categorical hierarchy for a catalog of downloadable content items. The catalog may support any or all of several additional features, such as animated promotions, search capabilities, sharing a wishlist with and receiving a wishlist from another user of the shopping service. The shopping experience may also include an interactive virtual mall.

### RELATED APPLICATIONS

This application claims the benefit of priority from U.S. Provisional Patent Application Ser. No. 61/413,229, entitled ENHANCED SHOPPING EXPERIENCE FOR MOBILE STATION USERS, filed Nov. 12, 2010.

### BACKGROUND

In recent years, mobile communication services have expanded and increased in popularity, around the world. Many advanced networks offer wireless mobile communication service for voice calls, mobile messaging services (e.g. text and/or multimedia) and data communications. The data services, for example, enable surfing the World Wide Web, e.g. via a browser. The speeds of the data communications services have steadily increased as service providers have migrated the networks to newer generation technologies with broadband data communication capabilities, and the mobile stations have steadily advanced to take advantage of the new network technologies. The data communication capabilities of the mobile stations and the broadband data communication services offered by the networks enable users to perform more and more tasks from their mobile stations.

Shopping has also evolved with the evolution to telecommunications technologies. On-line shopping is now commonplace, and increasingly, users can do their on-line shopping using their mobile stations. On-line shopping may be for a product or service related to the mobile station, such as an application program for installation in the mobile station or an item of content (e.g. text, video, audio or mixed multimedia) for downloading to the mobile device. In such cases, the communications through the network also facilitate the delivery of the purchased product to the user via the mobile station. In other scenarios, the product or service purchased on-line using the mobile station may not be directly related to the device and may be delivered to the user or a third party by other means, e.g. by traditional delivery media.

Success of any on-line shopping service requires that the presentation be attractive to existing and potential customers, easy to understand and easy to use. Hence, the organization and presentation of the information regarding available products and services can be commercially crucial.

A variety of on-line shopping service presentations are now common, more have been tried, and even more have been proposed and/or are under development. The simplest on-line shopping presentations involve a group of linked web pages about the products or services of one or more sellers. These pages will also offer one or more search options, to help a user navigate through the various pages to the page about the item(s) of current interest to the particular shopper. The presentation of information on any given page may include any of a wide range of combinations of text, image, video, animation and audio information.

In addition, there have been a variety of proposals, both for PC based shopping and in at least some cases for mobile device shopping, which offer a user interface that approaches a virtual mall type presentation. The more sophisticated virtual malls allow a user to move through a representation of a three dimensional mall and view stores and items in various stores, in a manner intended to approximate an actual walk through a mall and its stores.

The trend toward more and more on-line shopping by mobile device users, the increased sophistication of the mobile stations and the increased bandwidth capacity of the mobile networks, however, offers a particular opportunity to develop further improvements in the user interface and delivery thereof through the mobile networks, to thereby further enhance the shopping experience and thus develop a more effective sales via the on-line shopping service to mobile customers.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIGS. 1 to 83 show mobile stations and user interface displays on such stations, as might be presented to a user during an example of an enhanced mobile on-line shopping service.

FIG. 84 is a high-level functional block diagram of an example of a system of networks/devices that provide various communications for mobile stations and support an example of the enhanced on-line shopping service.

FIG. 85 is a high-level functional block diagram of an exemplary non-touch type mobile station as may utilize the on-line shopping service through a network/system like that shown in FIG. 84.

FIG. 86 is a high-level functional block diagram of an exemplary touch screen type mobile station as may utilize the on-line shopping service through a network/system like that shown in FIG. 84.

FIG. 87 is a simplified functional block diagram of a computer that may be configured as a host or server, for example, to function as a shopping server in a system like that of FIG. 84.

FIG. 88 is a simplified functional block diagram of a personal computer or other work station or terminal device, although the device may also be configured to function as a server.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

The examples and discussion below relate to techniques and equipment to offer an enhanced shopping experience via a graphical user interface of a mobile station.

In a disclosed example, the shopping experience may include a categorical hierarchy for a catalog of downloadable content items. The catalog may support any or all of several additional features, such as animated promotions, search capabilities, sharing a wishlist with and receiving a wishlist from another user of the shopping service. In the disclosed example, the shopping experience may also include an interactive virtual mall.

In an exemplary method, a user's mobile station may provide a display of an initial shopping page of an on-line shopping service. The initial shopping page includes a user selectable object for a catalog of downloadable content items and a portion for identifications of any downloadable content items previously purchased and downloaded to the mobile station. In response to user selection of the object for the catalog, the mobile station communicates with a shopping application server through a mobile communication network to obtain information and provide a display of a page containing selectable objects representing top-level application categories for the downloadable content items in the catalog. In response to user selection of one or more objects representing top-level content categories, the mobile station communicates with the shopping application server to obtain information and provide a display of one or more pages containing selectable objects representing respective sub-categories for the downloadable content items in the catalog, under a selected top-level content category. Following a user selection of the object representing one of the sub-categories, the mobile station communicates with the shopping application server through the mobile communication network to obtain information and provide a display of a page containing selectable objects representing downloadable content items in the one sub-category.

In one example, the user selects an object representing one of the downloadable content items in the one sub-category displayed on the mobile station. In response, the mobile station communicates with the shopping application server to obtain information and provide a display via the mobile station of a page containing detail information about the one downloadable content item, including an offer price. Upon user indication of acceptance of the offer price, the mobile station communicates with the shopping application server communication network to complete a purchase transaction with respect to the selected content item. The user selected downloadable content item is downloaded through the mobile communication network to storage in the mobile station.

In another example, the mobile station and application server support navigation through pages of the catalog to allow the user to select a number of content items for downloading. In such a shopping flow, user selections of objects representing downloadable content items displayed on the mobile station enable communication between the mobile station and the shopping application server to identify a number of downloadable content items as user selections for purchase. Information including a total price for purchase of the selected downloadable content items is displayed to the user via the mobile station. Upon user indication of acceptance of the total price for content items, the mobile station and server communicate to complete a purchase transaction with respect to the content items; and the items are downloaded through the mobile communication network to storage in the mobile station.

As noted, the enhanced shopping experience may also incorporate a virtual mall. In an example of such a technique, the initial shopping page includes a user selectable object for a virtual mall for items offered by a number of vendors, as well as the user selectable object for the catalog and the portion for identifications of any content items previously purchased and downloaded to the mobile station. Browsing and shopping through the catalog may be similar to one of the techniques outlined above.

With this later example, however, the technique also includes a user selection of the object for the virtual mall at a time when the initial shopping page is displayed on the mobile station. In response, the mobile station communicates with the shopping application server to obtain information and provide a display of movement through a virtual representation of a shopping mall. Responsive to further user input during the display of movement through the virtual representation of the shopping mall, the mobile station displays information regarding goods available from one of a number of virtual stores of the virtual mall. In response to user selection of information regarding one of the available goods the mobile station communicates with the shopping application server, and based on that communication, interactively provides information to the user regarding the selected one of the goods. Upon input of the user's indication of acceptance of a price for the selected one of the goods, the mobile station communicates with the shopping application server to complete a purchase transaction with respect to the selected one of the goods.

The detailed description also encompasses a variety of other features or techniques related to the enhanced shopping experience. An example of such features relates to sharing a wishlist. By way of example, the user operates the mobile station to select objects of the on-line shopping service displayed on the mobile station. In response, the mobile station communicates with a shopping application server through a mobile communication network to obtain information and provide display via the mobile station to the user of one or more pages of the catalog of items available from the on-line shopping service. This allows the user to navigate to information about a number of the items available from the on-line shopping service. Further input(s) from the user via the mobile station identify one or more of the items for inclusion in a wishlist for the user. A short messaging service (SMS) message is transmitted through the mobile communication network to a mobile station of a party selected by the user to receive the user's wishlist. The SMS message contains a link for activating a shopping client application program in the selected party's mobile station to initiate communication through the mobile communication network with the shopping application server to obtain the user's wishlist, for presentation to the selected party via a user interface configured by the shopping client application program.

As another exemplary feature of the service, when a sub-category is selected, items available from the catalog in that sub-category are brightly displayed, with objects for the other sub-categories displayed in a darkened state. This nested navigation allows for increased discoverability and ease of use via the ability to return backwards from one screen to a screen that came earlier in the menu structure without complications.

In the case where an item has an animation, when the item is selected, an automatic preview can be displayed on the screen, e.g. for promotional purposes. The video content for the preview may be sent from the shopping application server to the mobile station.

As another exemplary feature of the service, a view in the mall can also be changed through user customizations via a configuration communication process with the shopping application server. These customizations allow for variations in physical indoor mall type, holiday season decorations, etc. These customizations could be purchased gaining additional revenue for the service provider.

The disclosure also encompasses examples of mobile stations, systems and software for implementing the enhanced shopping experience. A system, for example, may include a shopping application server and mobile stations for one or more users. A software product may include at least one machine-readable medium and programming carried by the medium for implementing one or more the various techniques involved in the enhanced shopping experience.

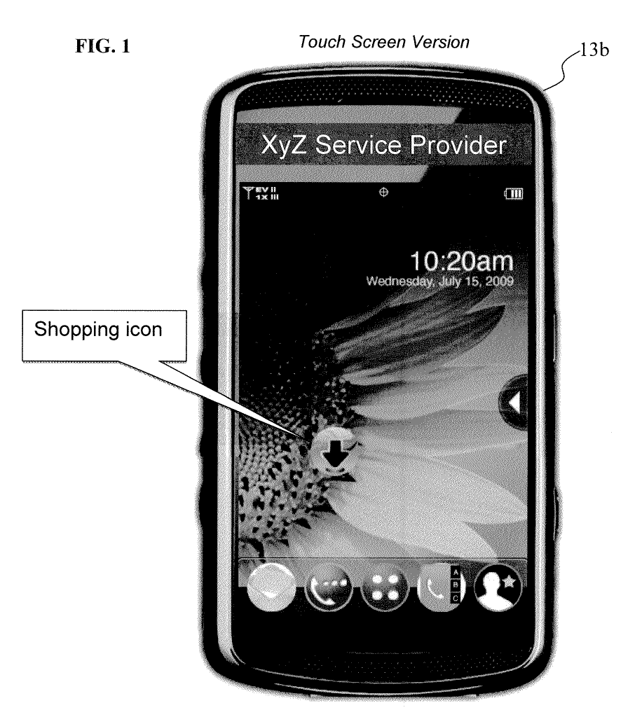

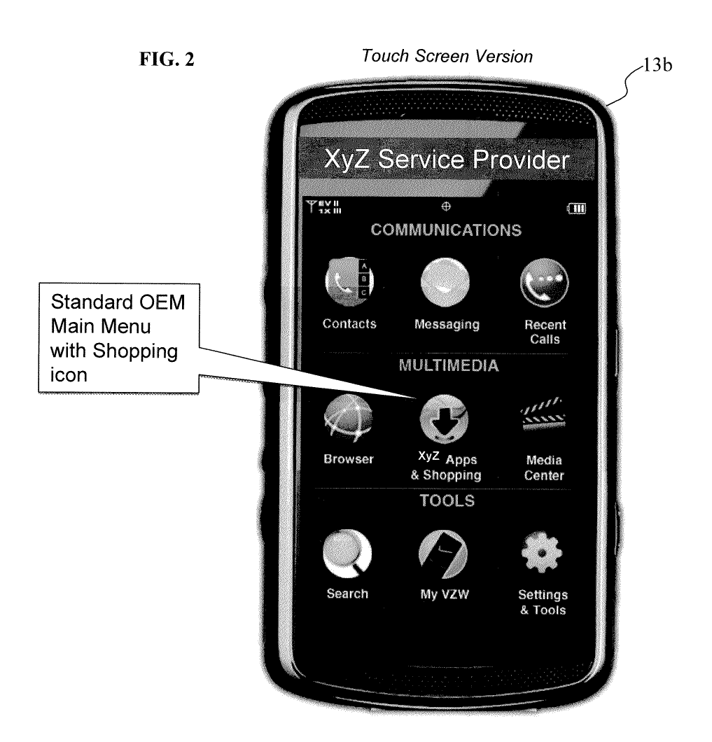

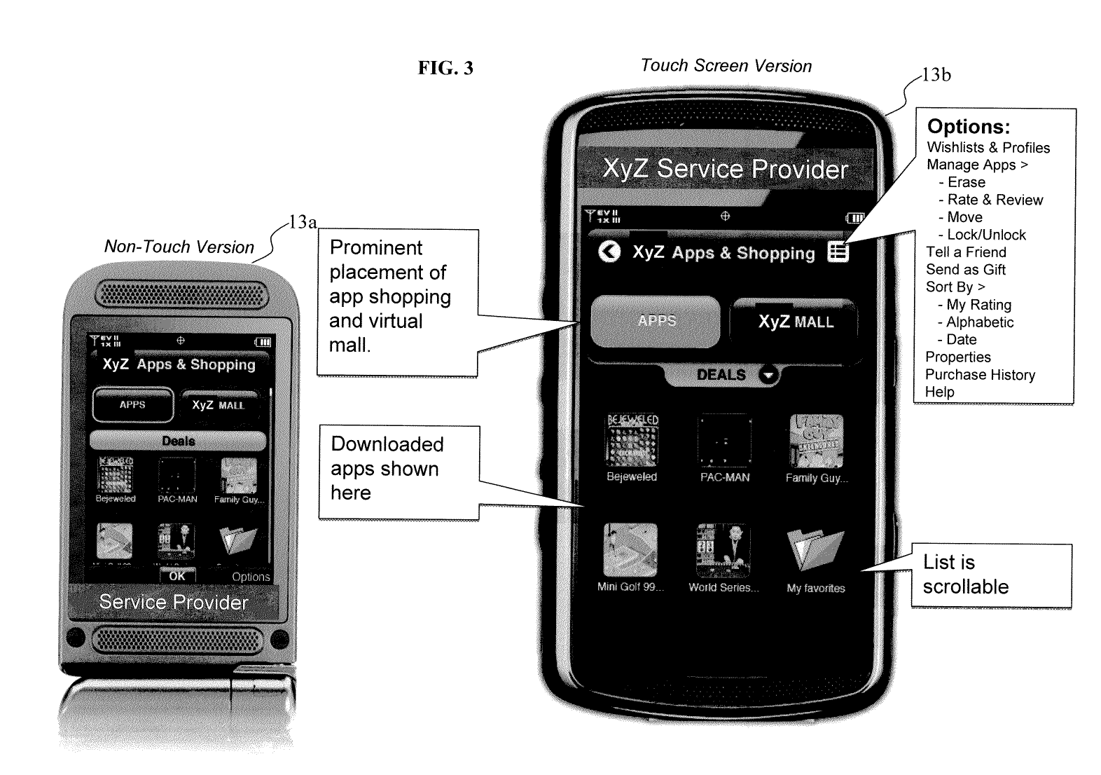

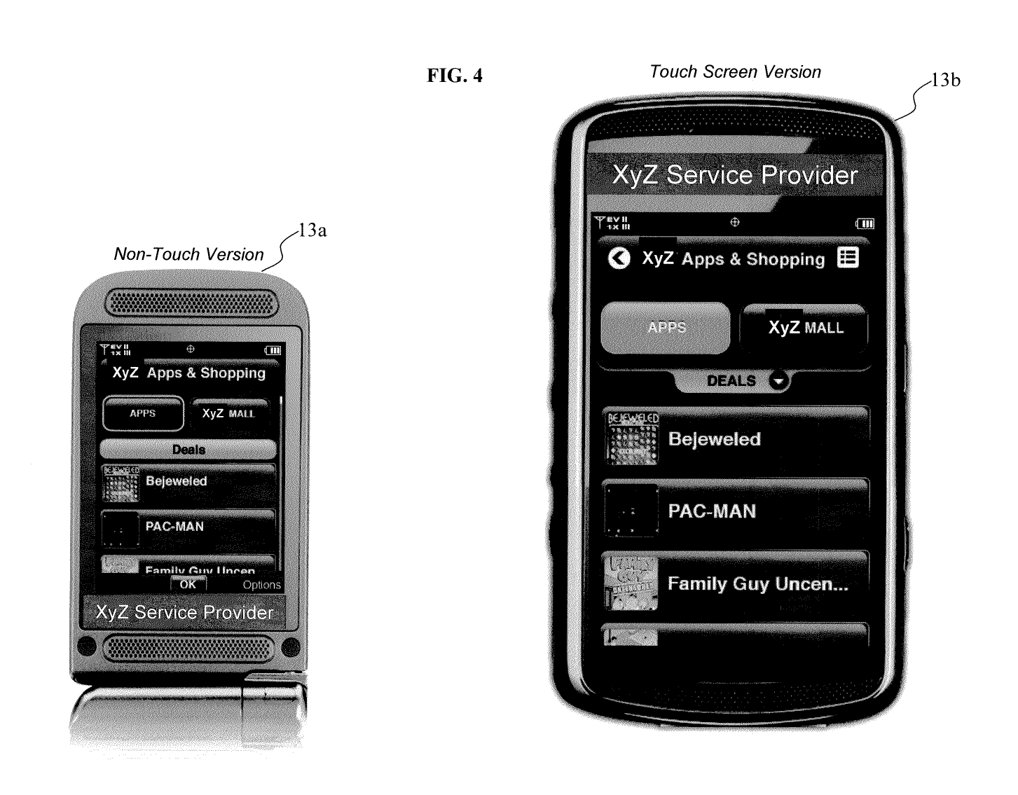

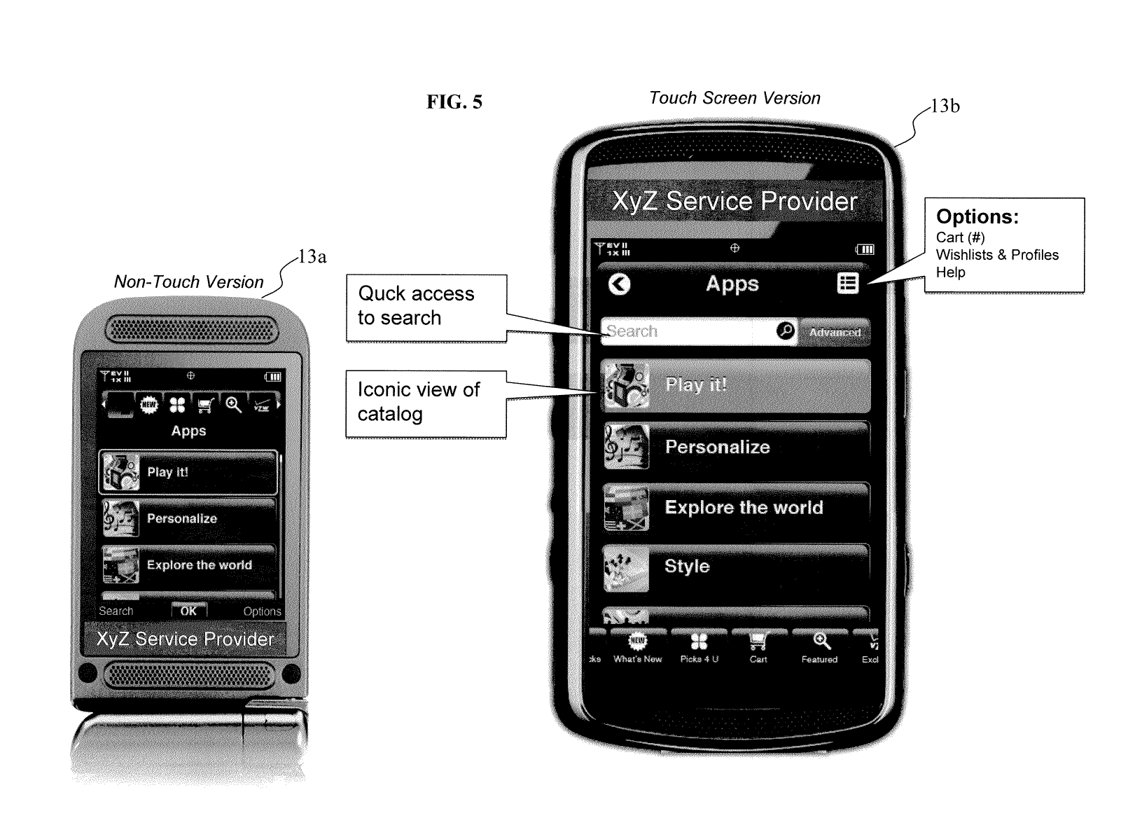

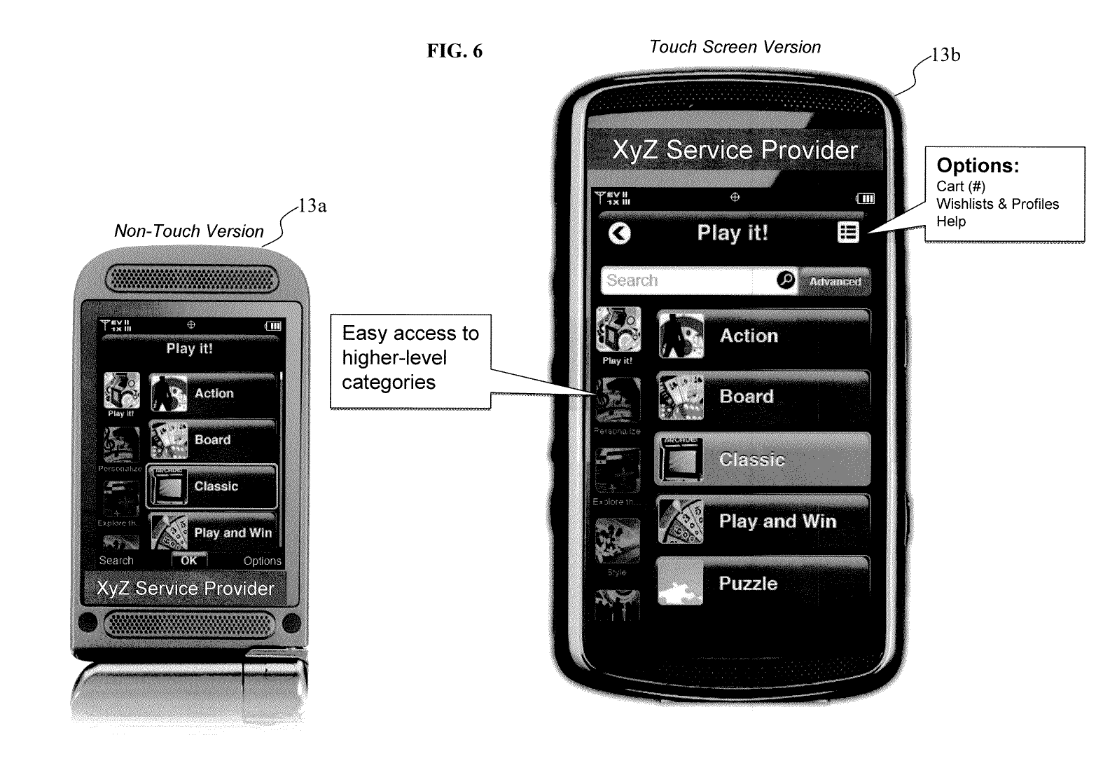

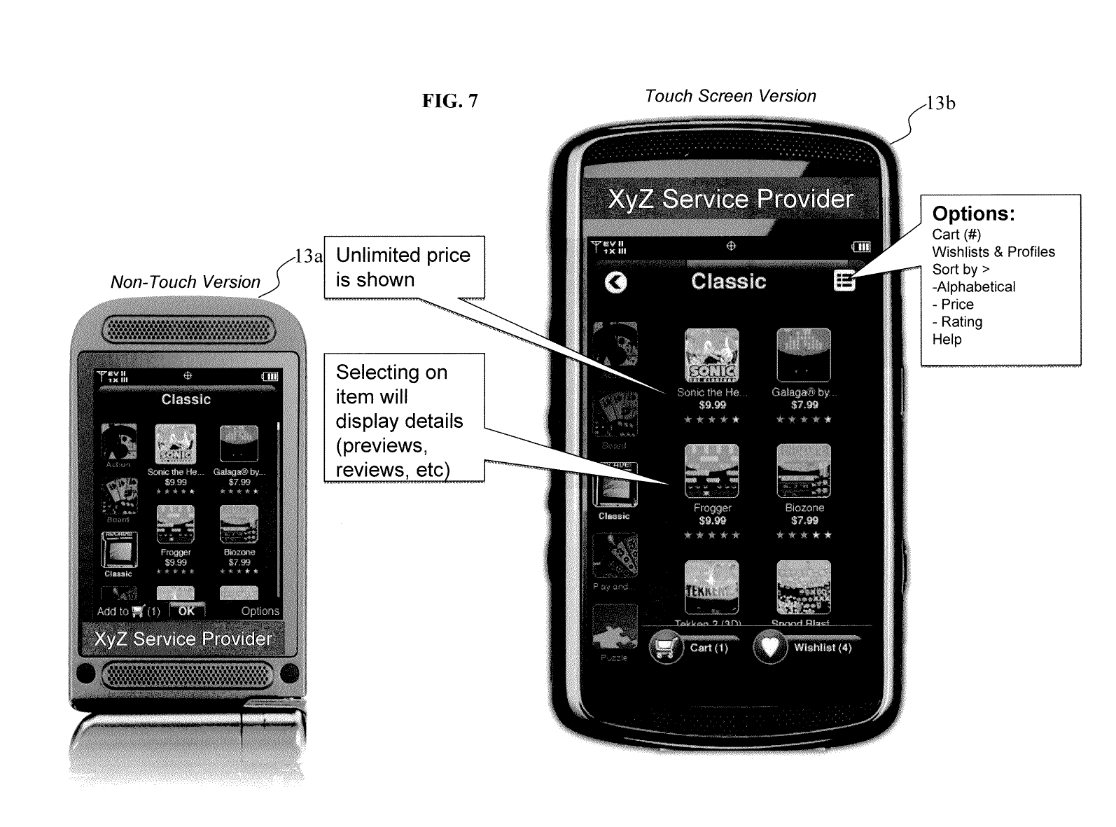

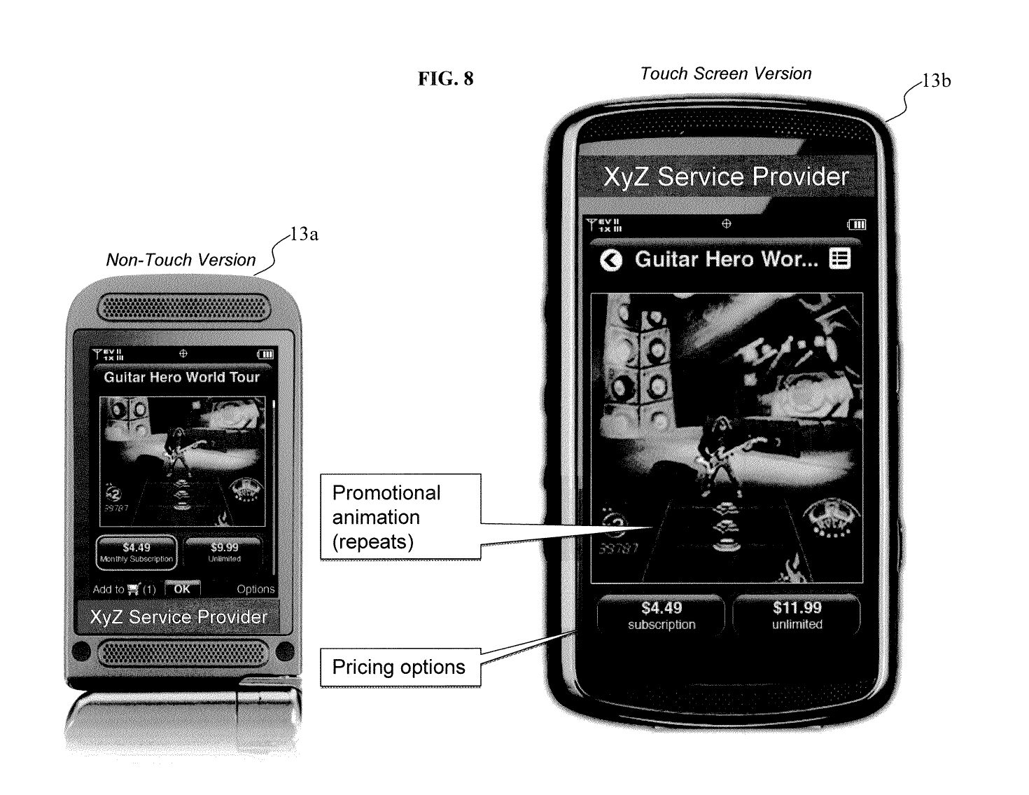

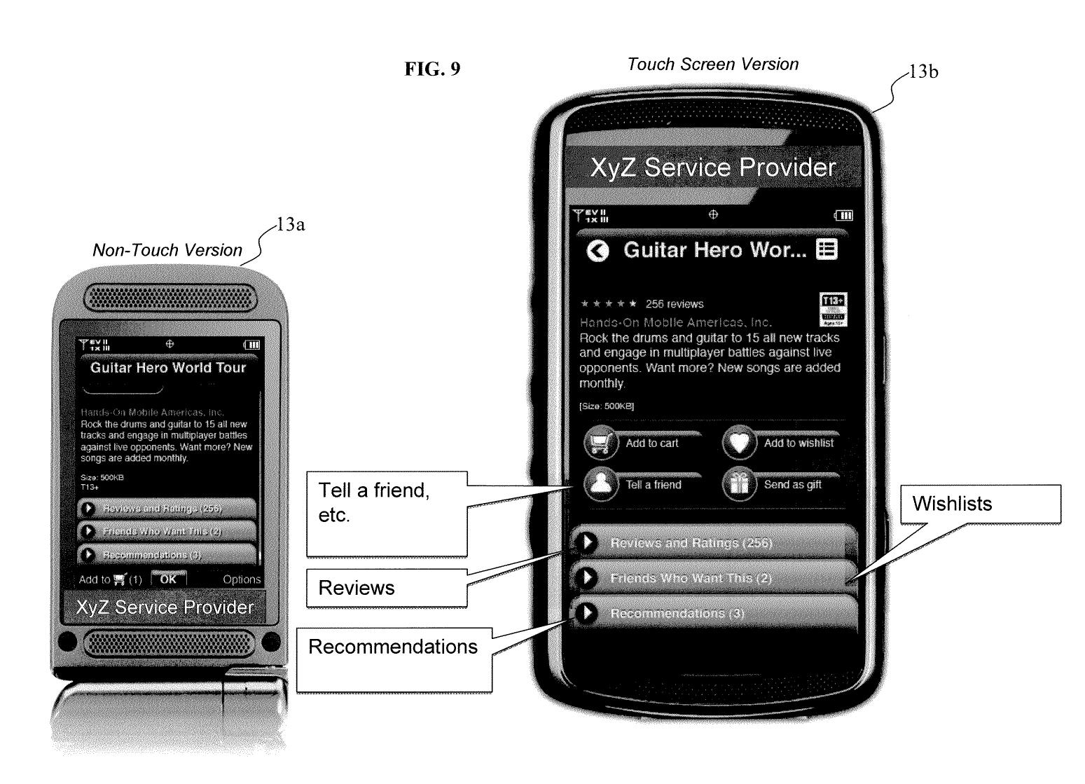

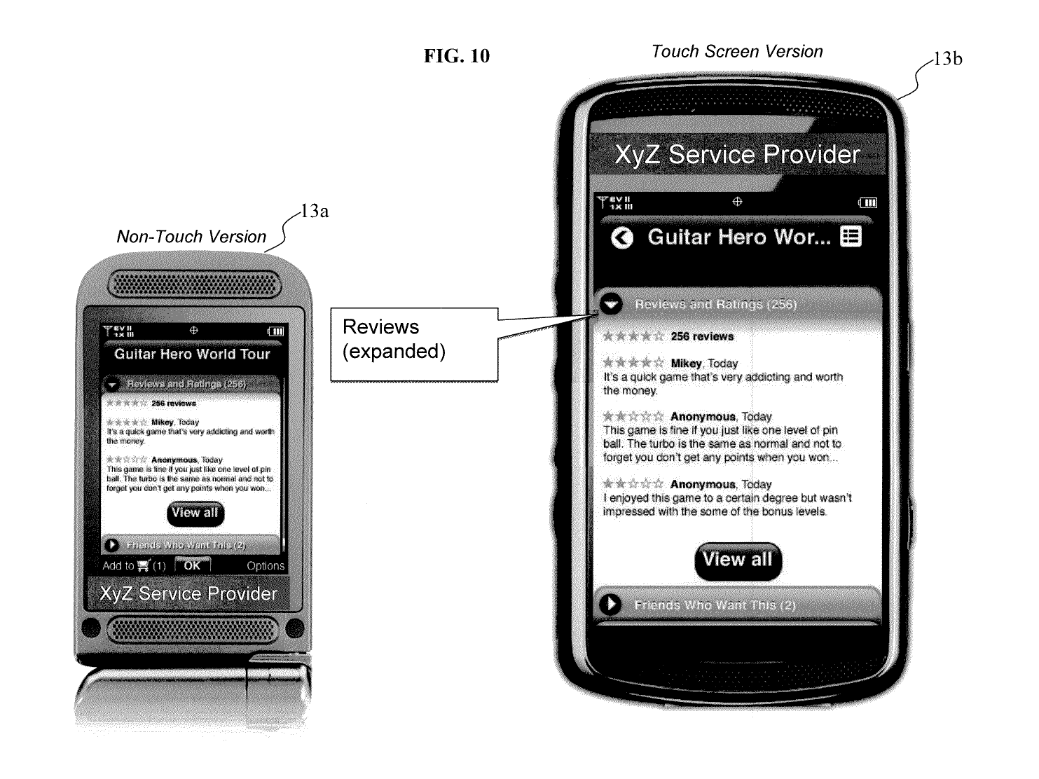

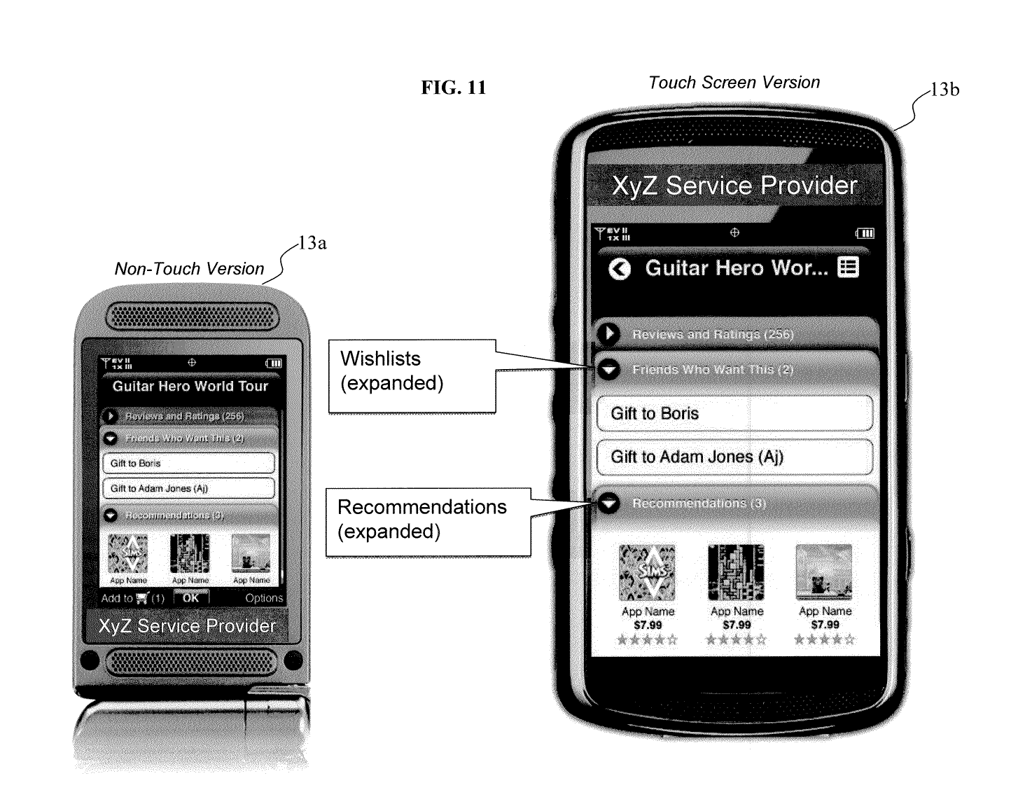

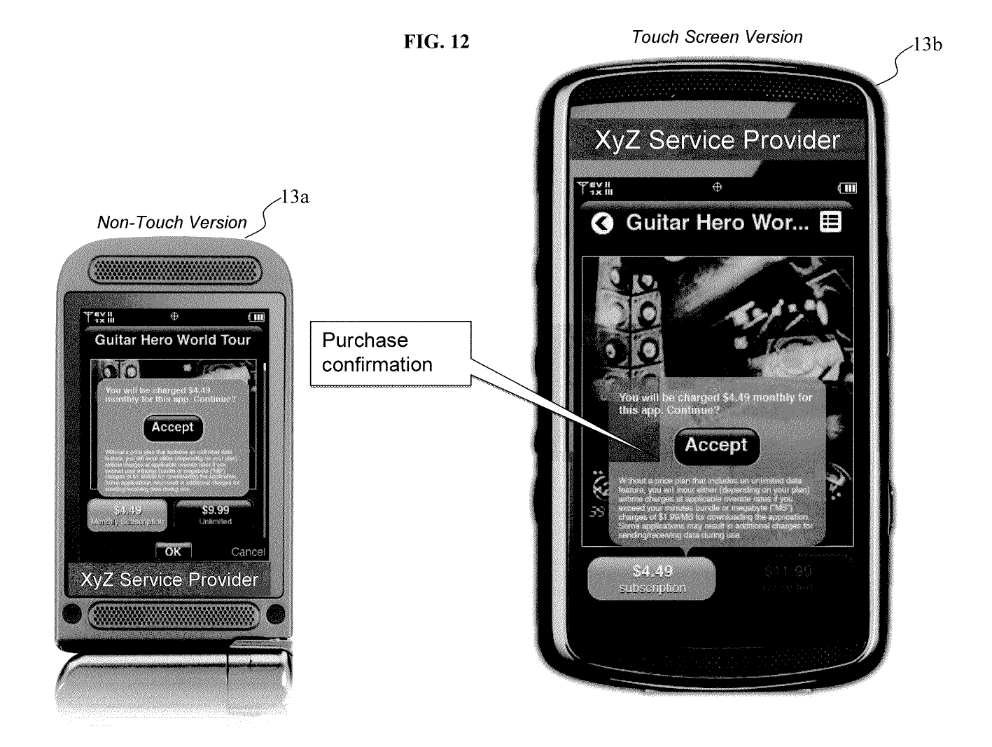

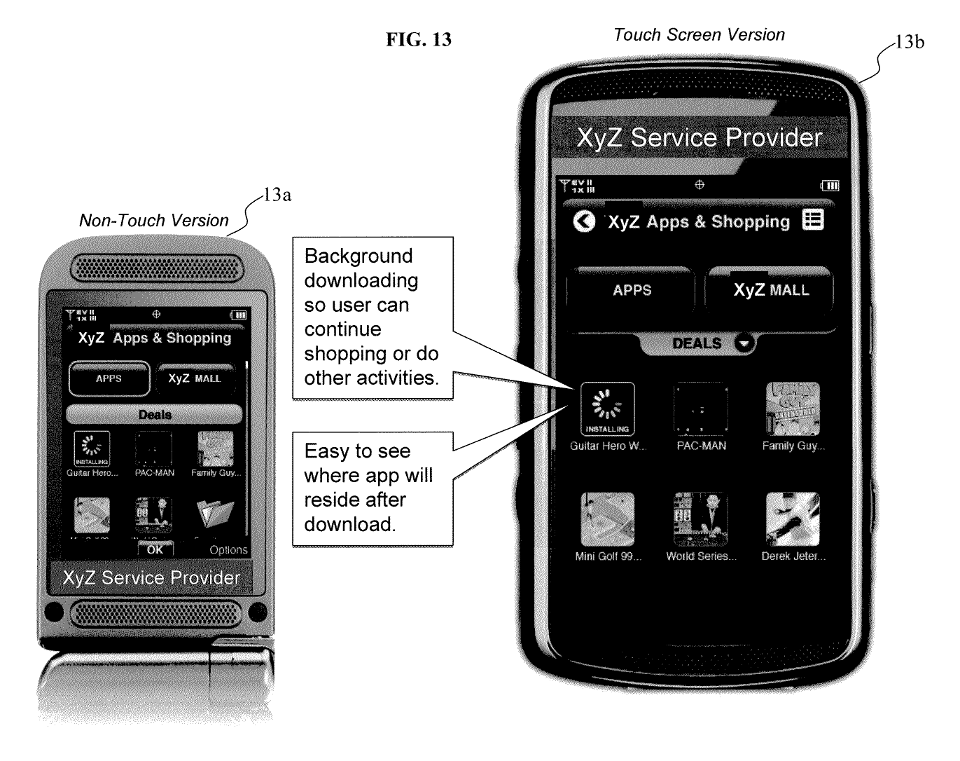

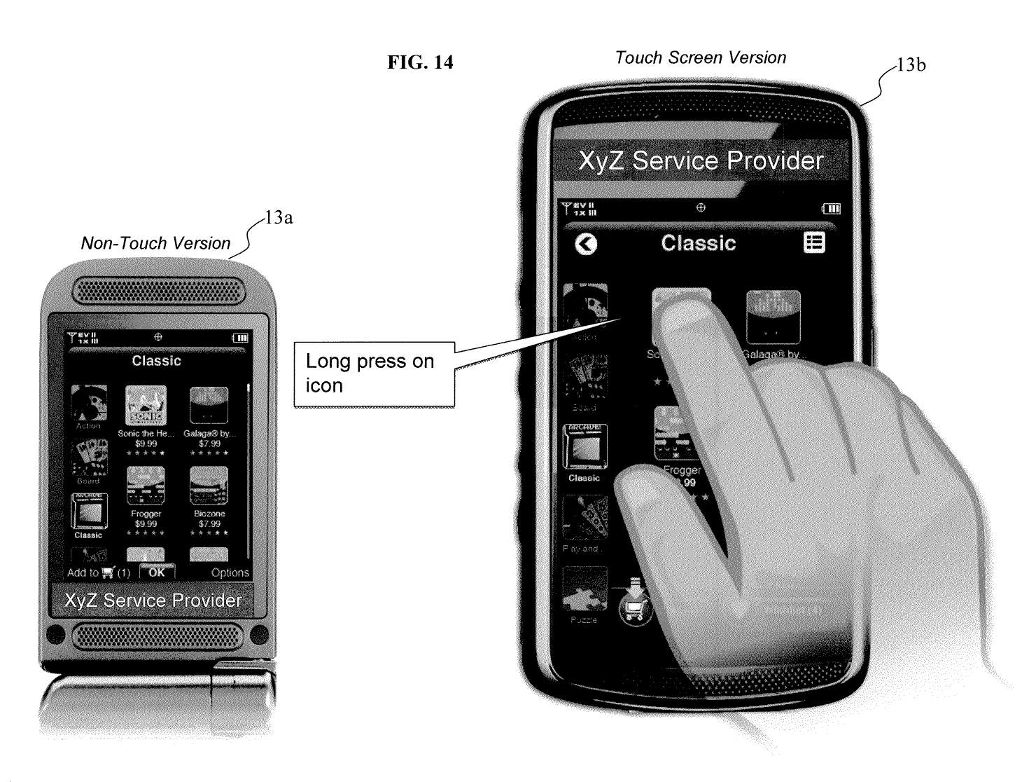

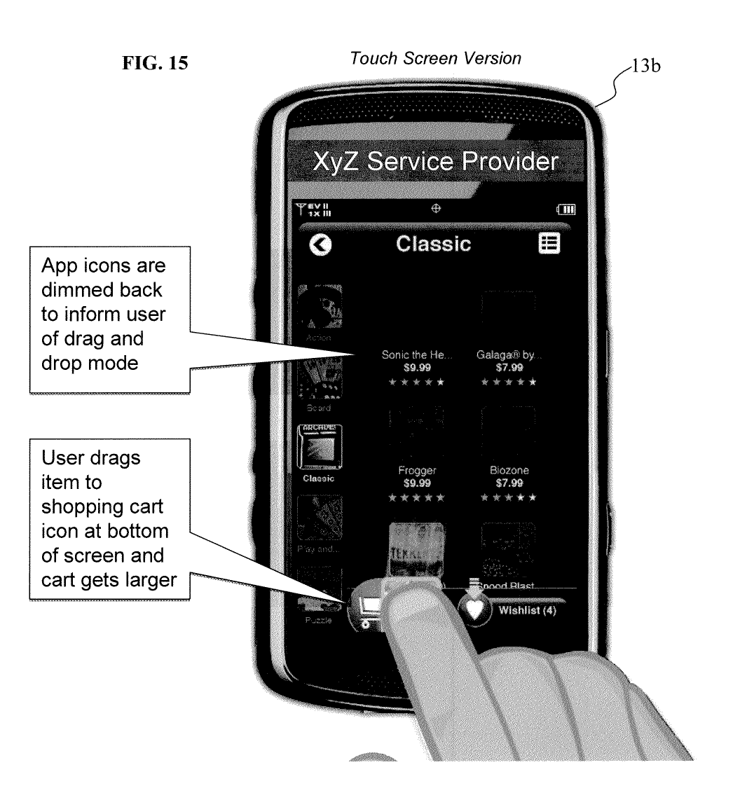

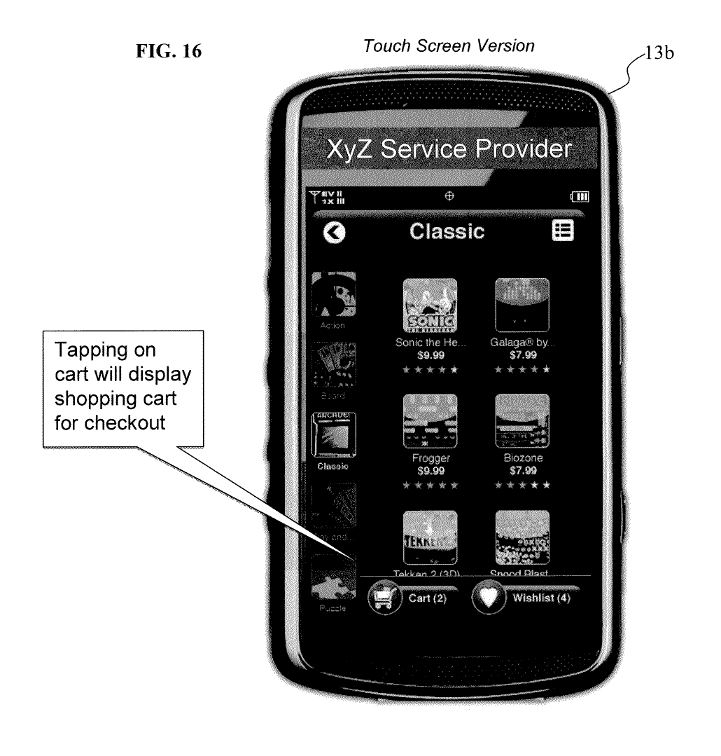

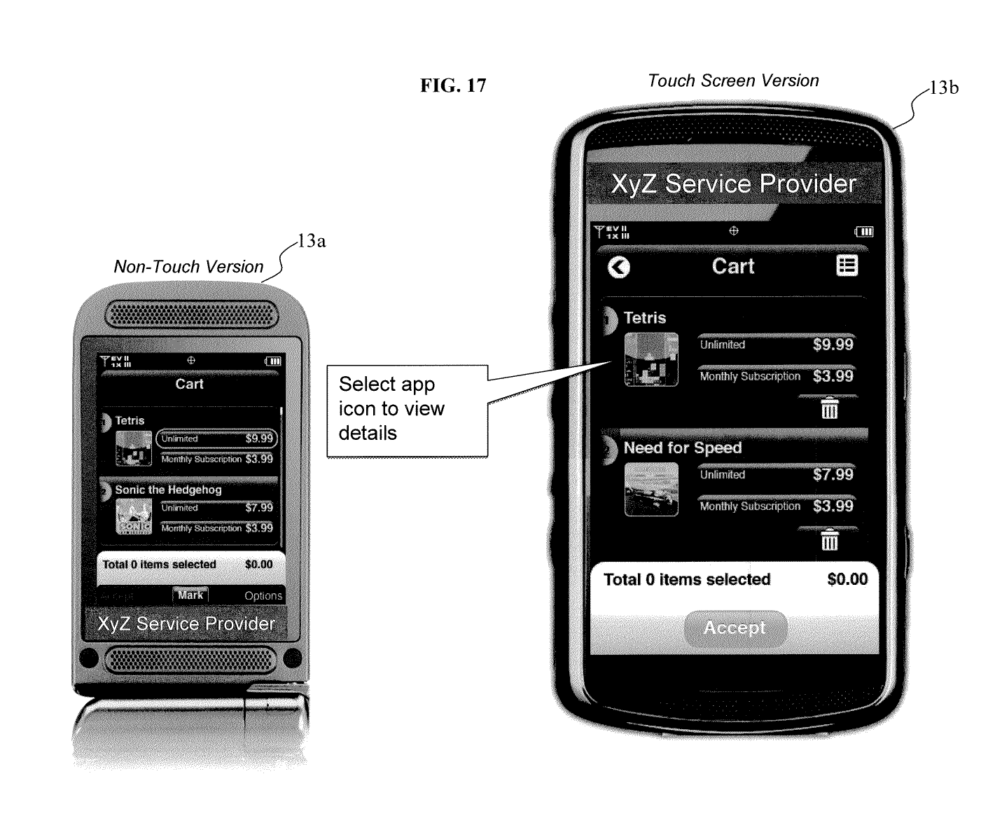

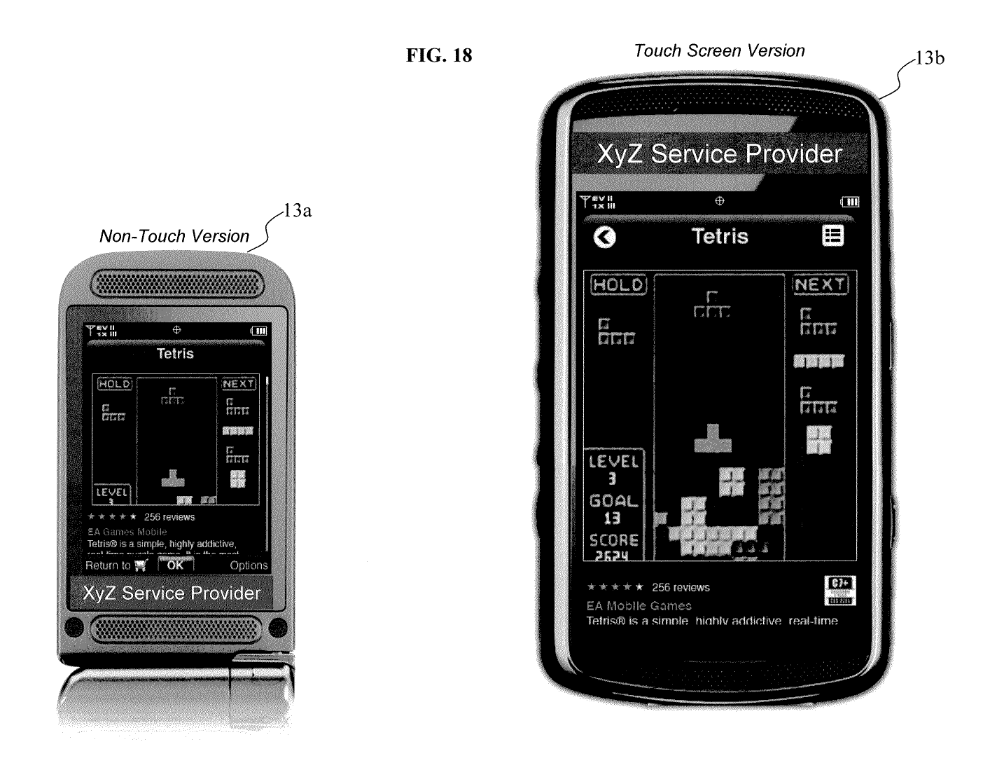

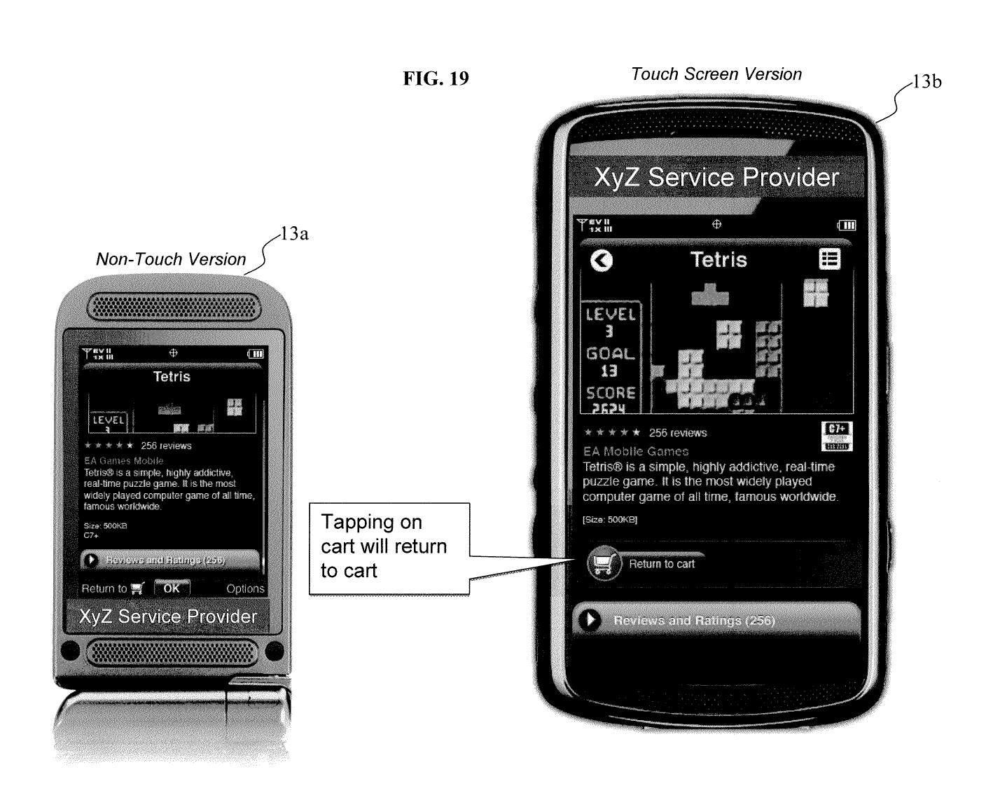

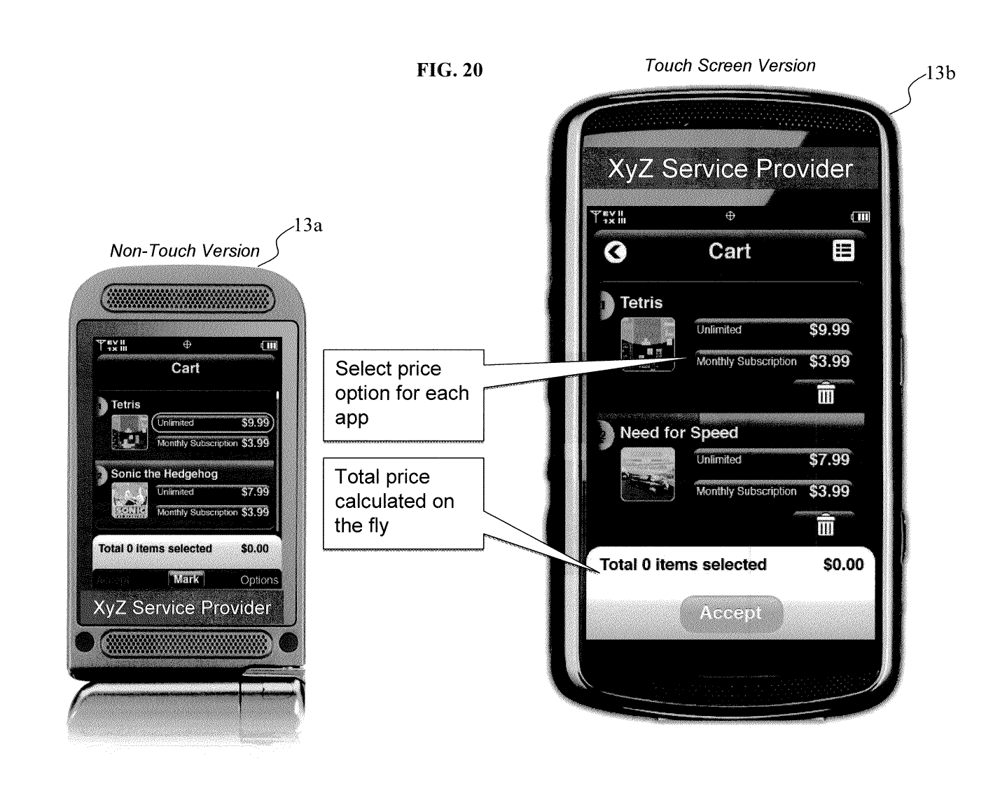

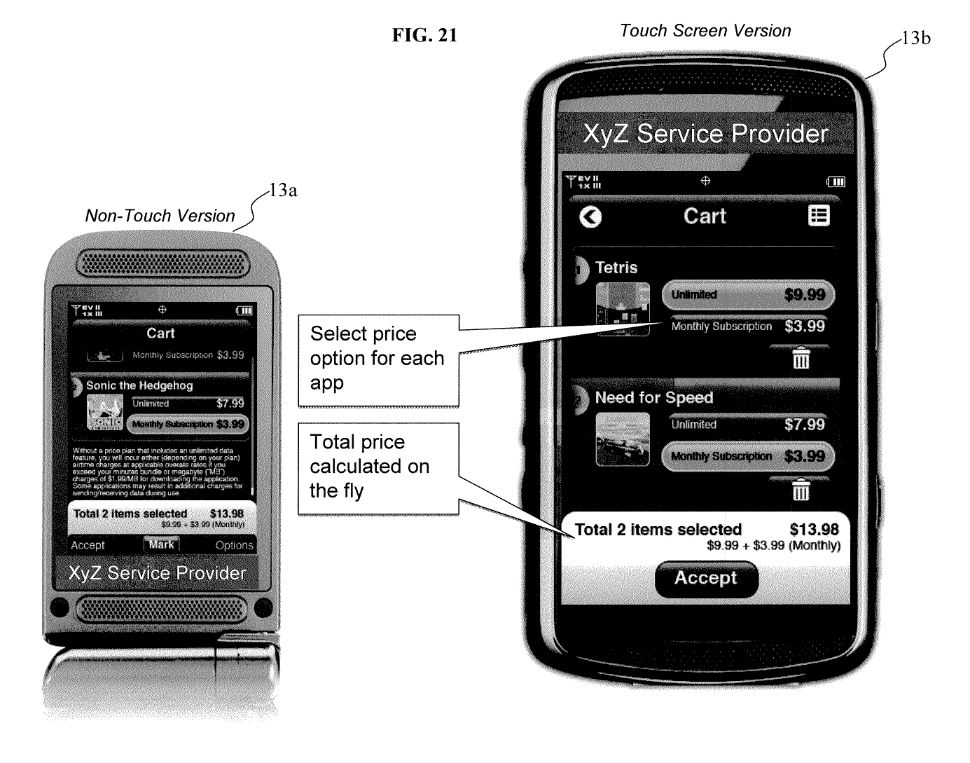

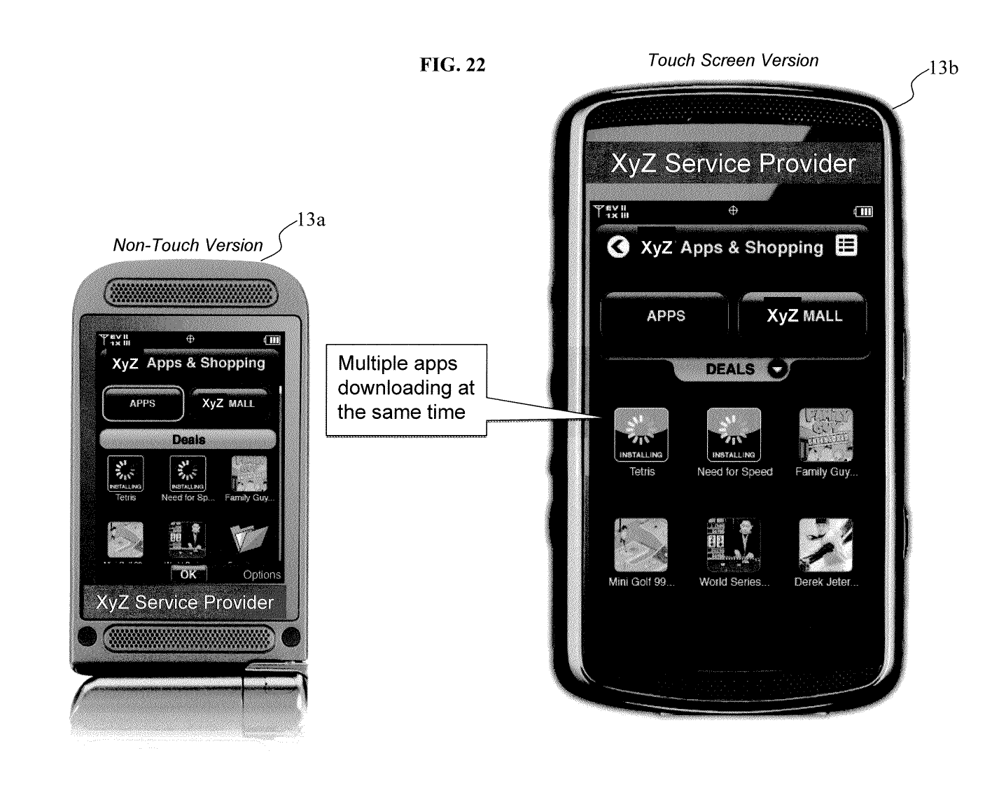

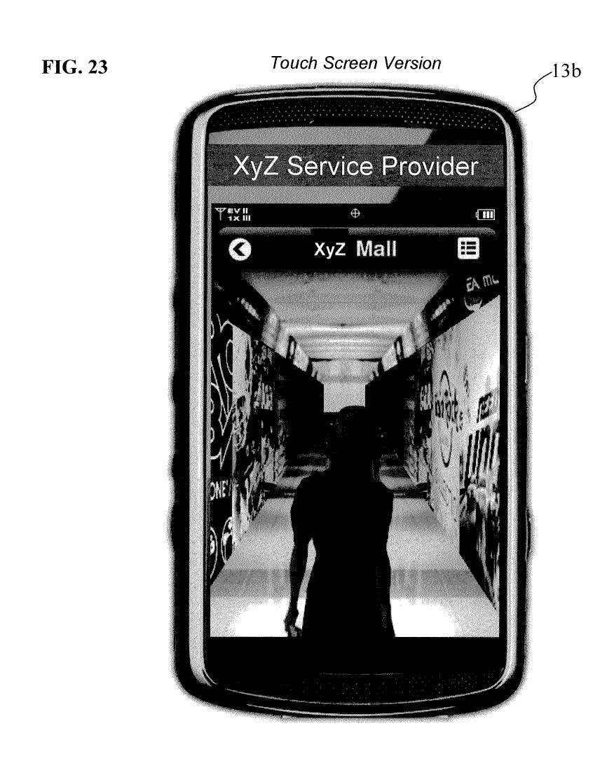

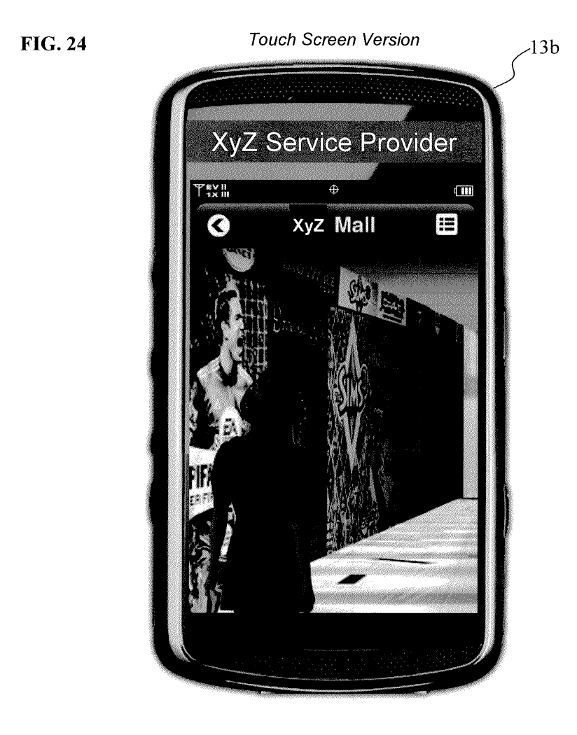

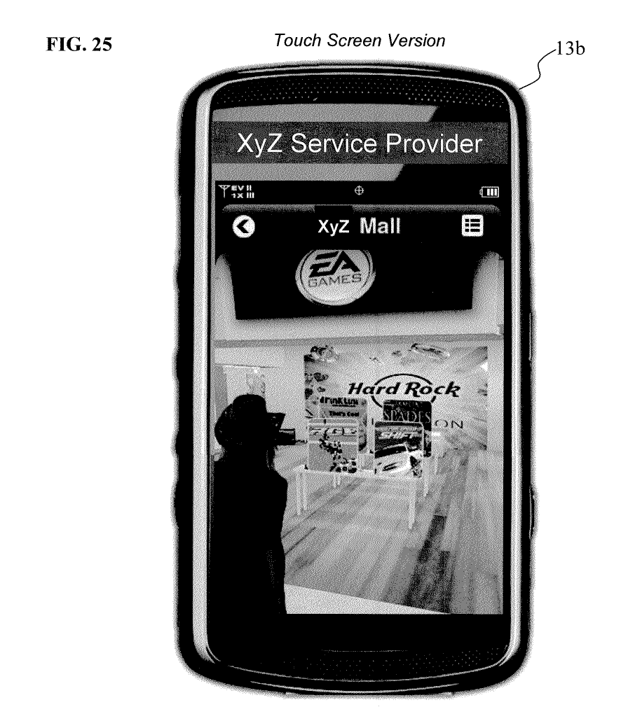

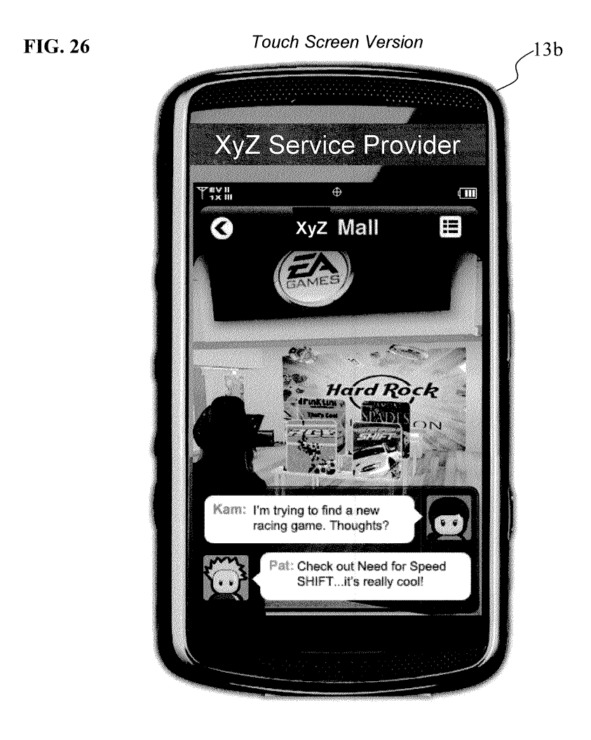

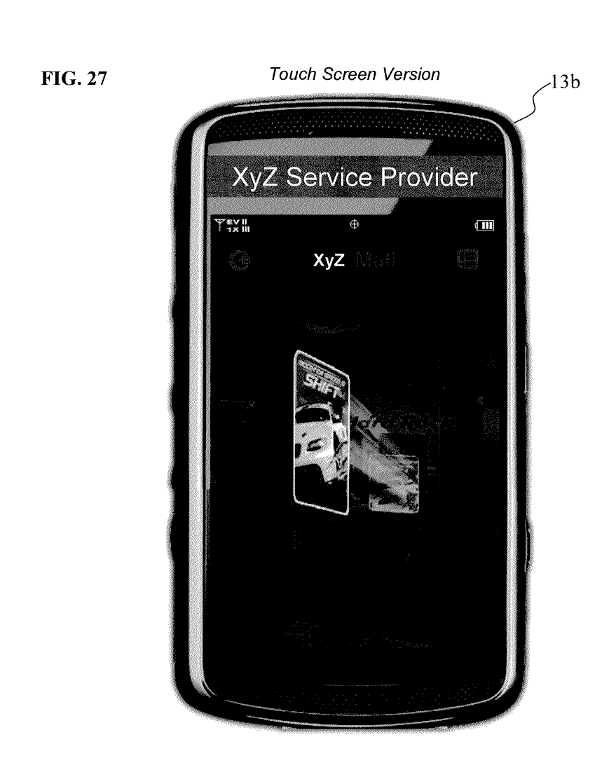

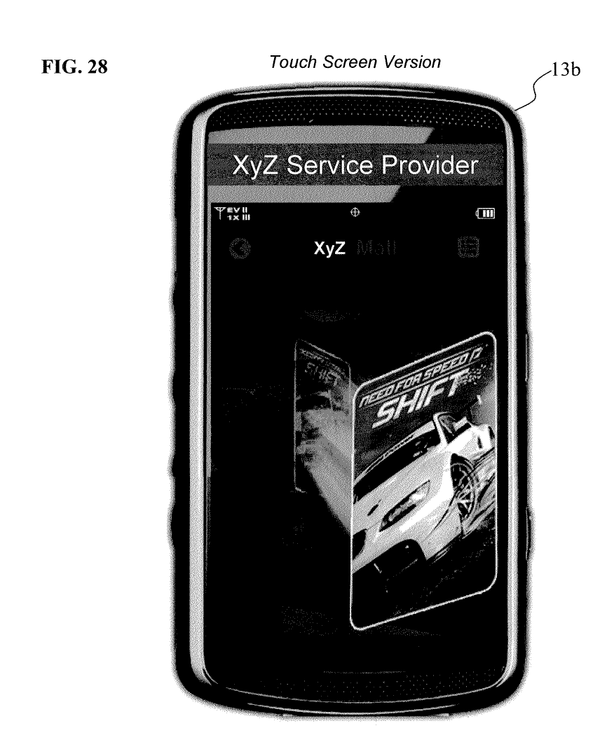

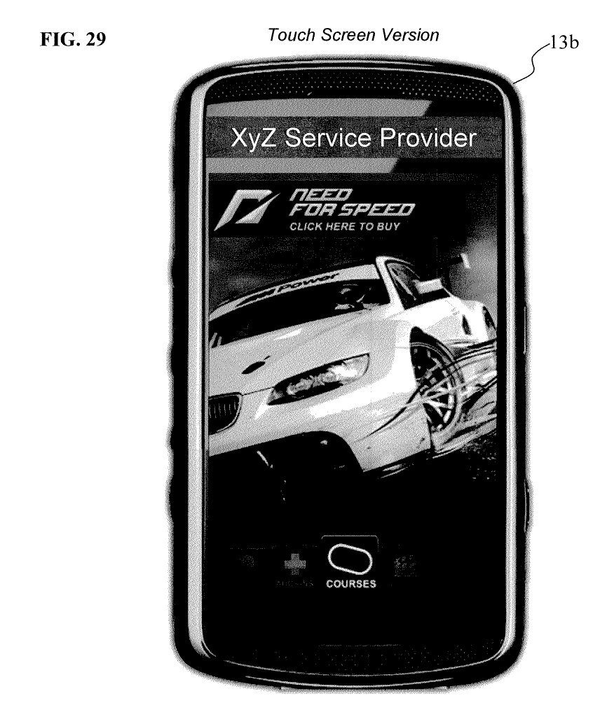

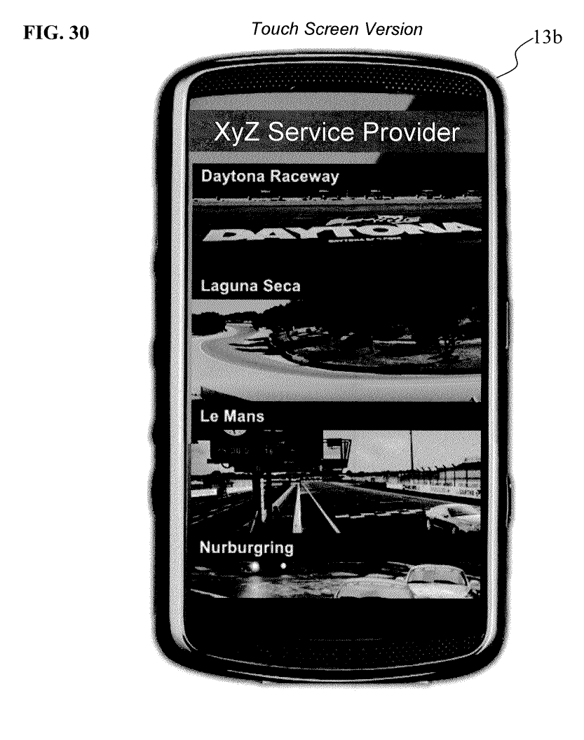

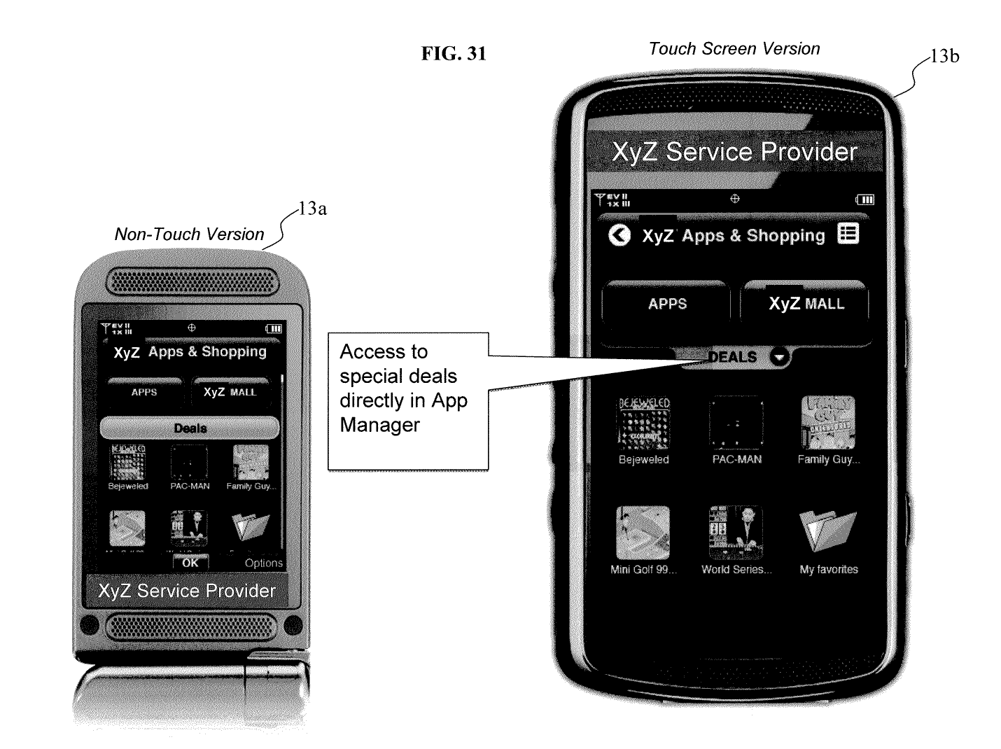

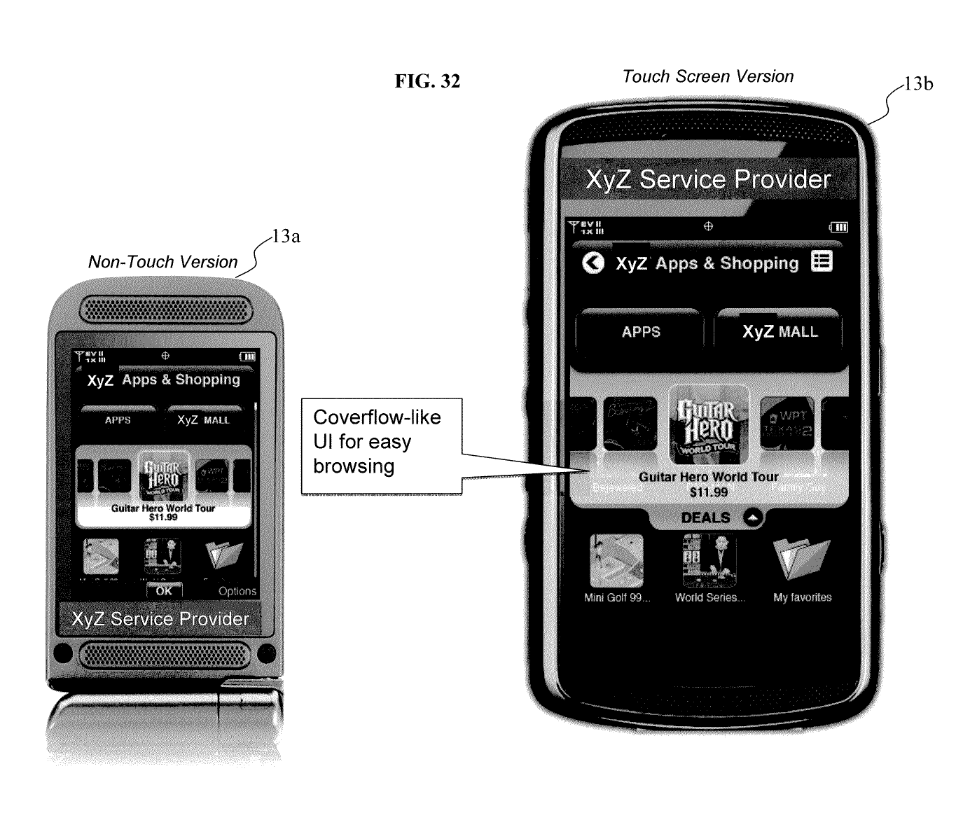

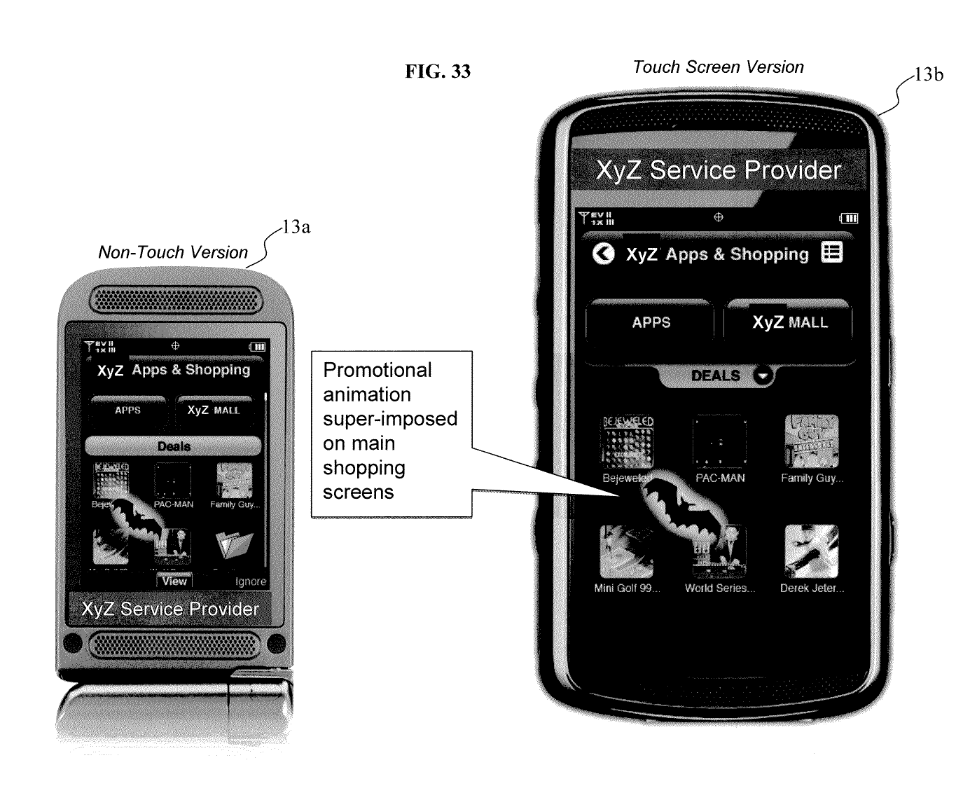

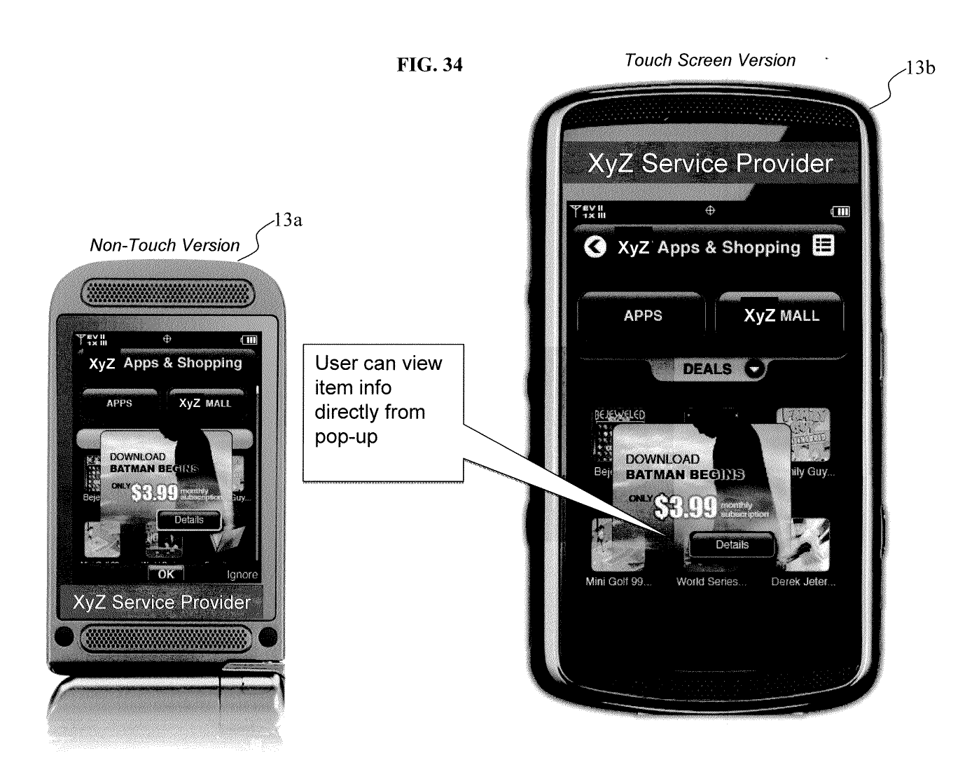

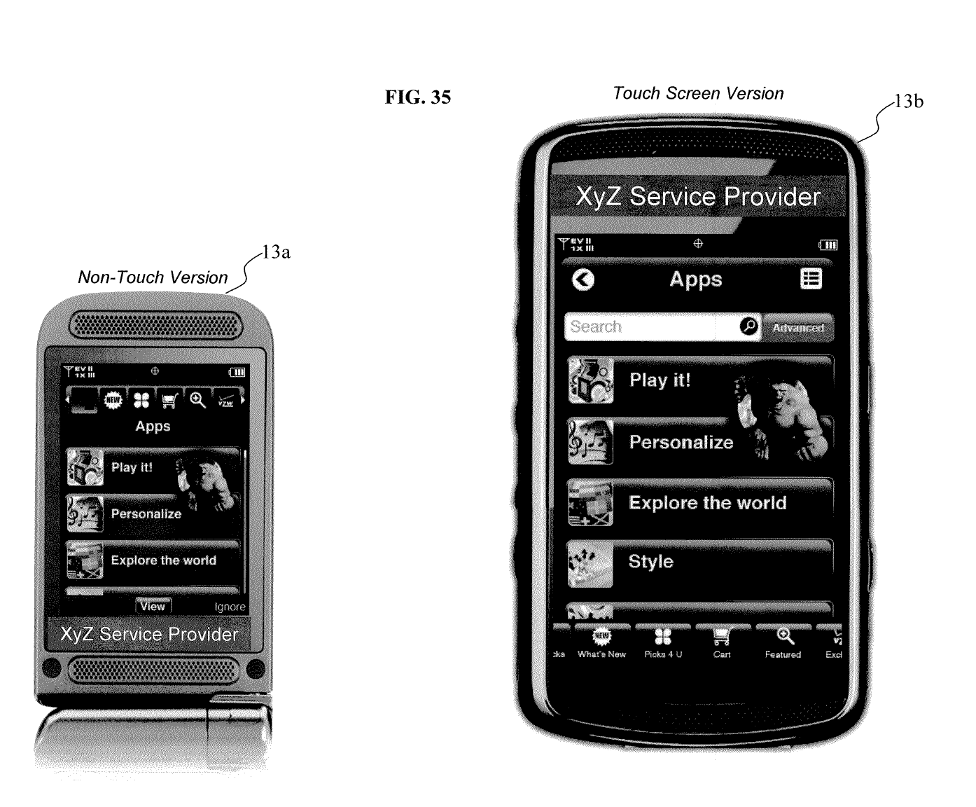

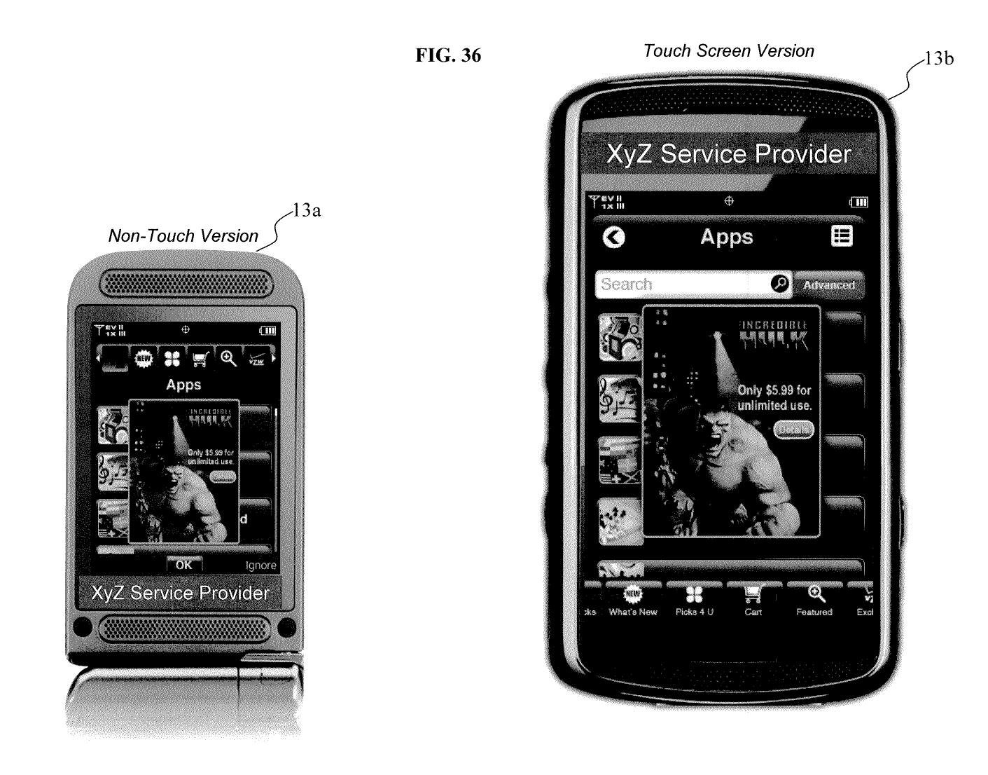

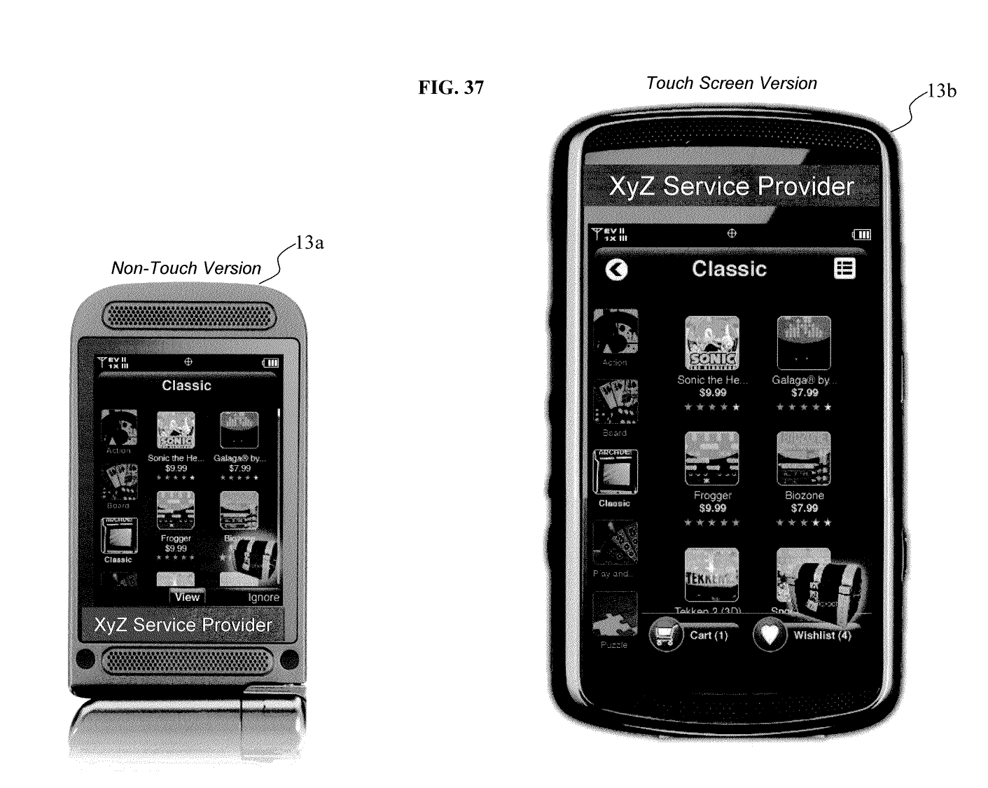

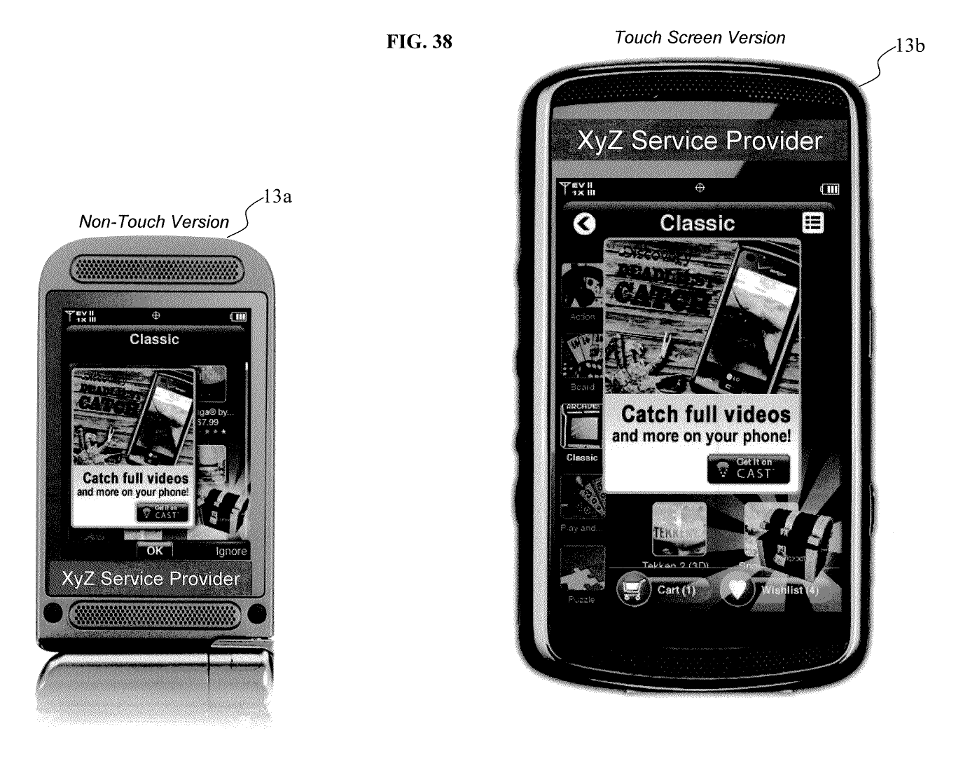

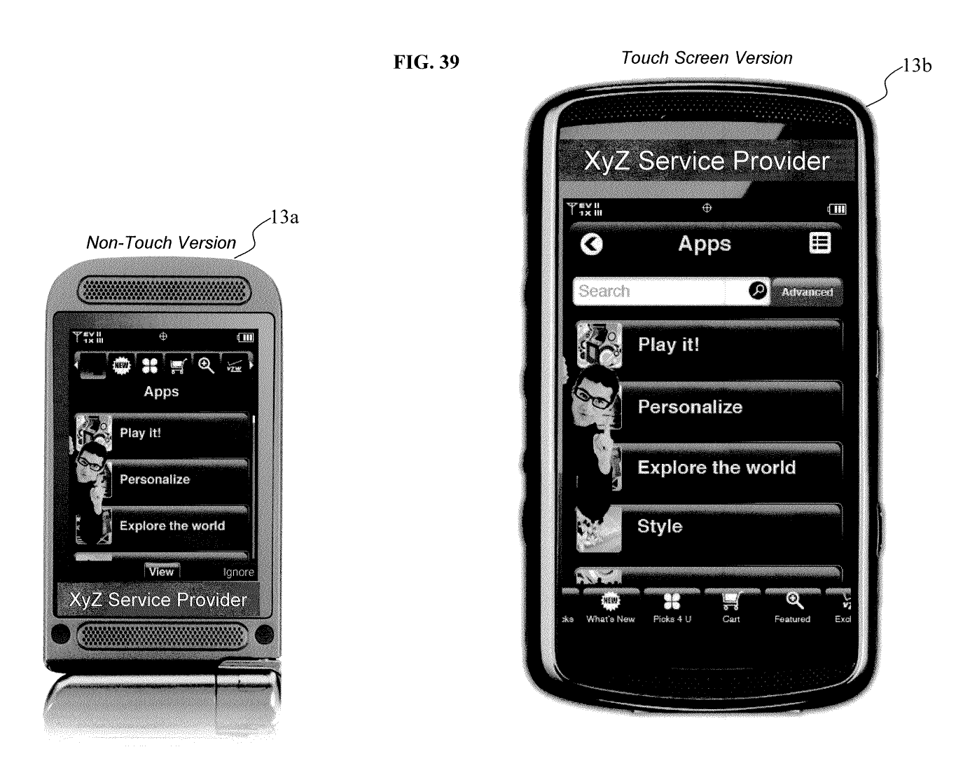

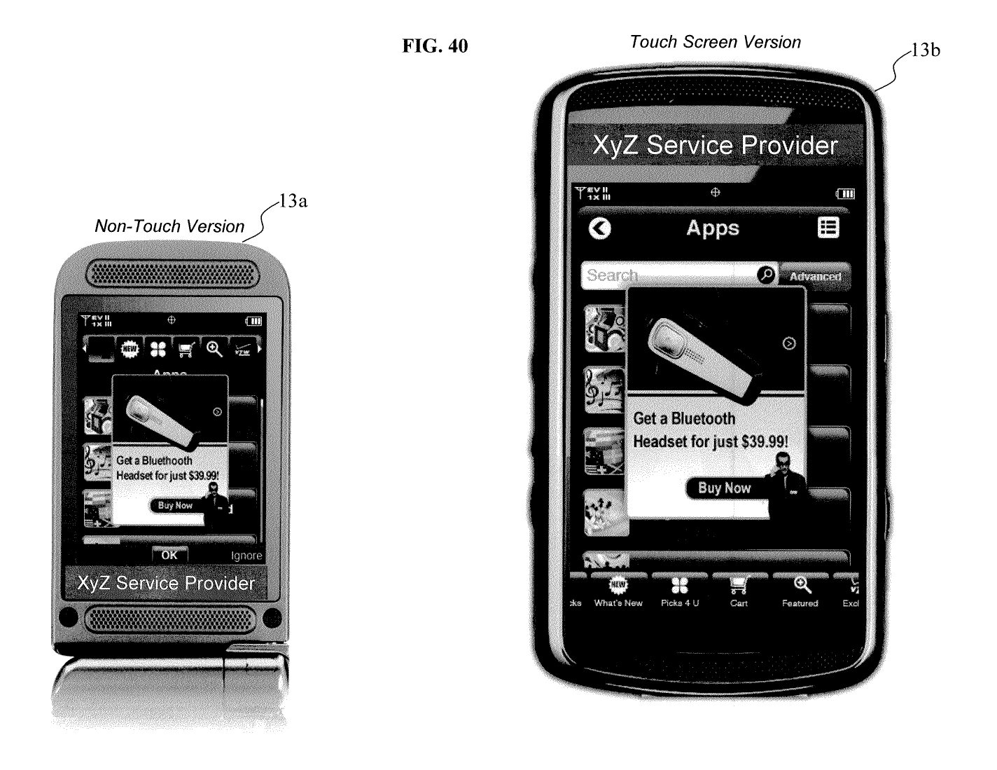

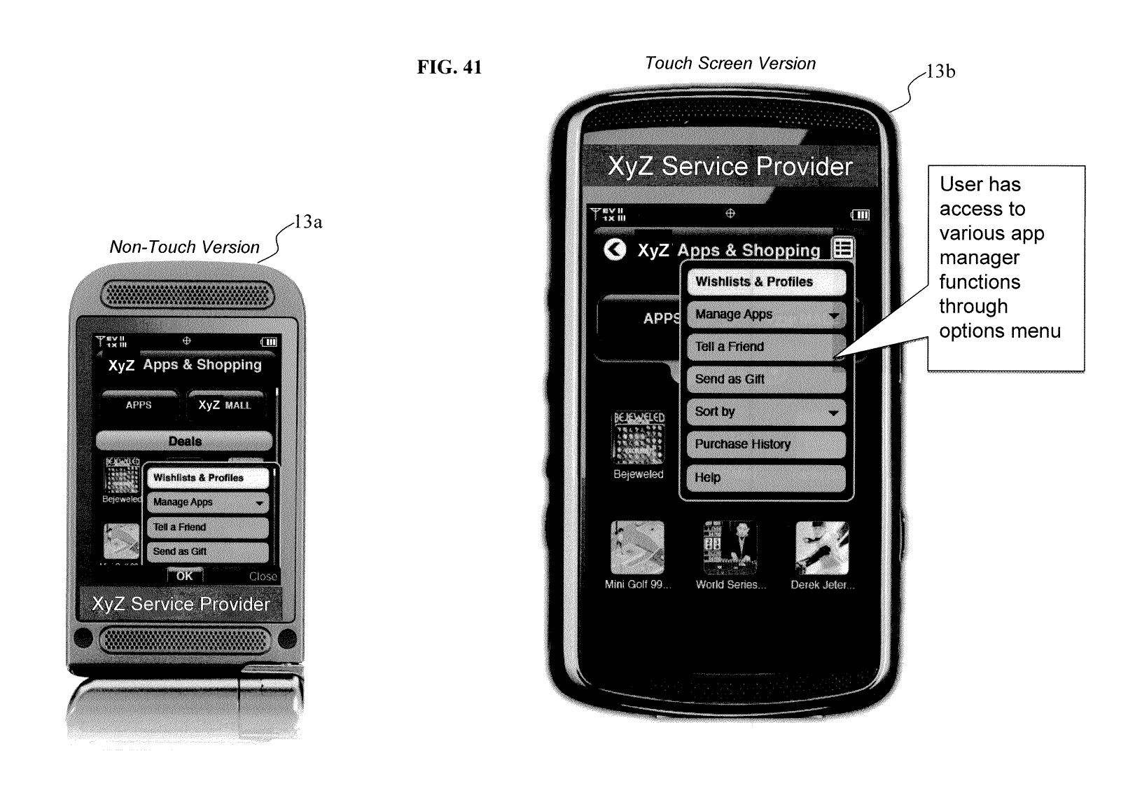

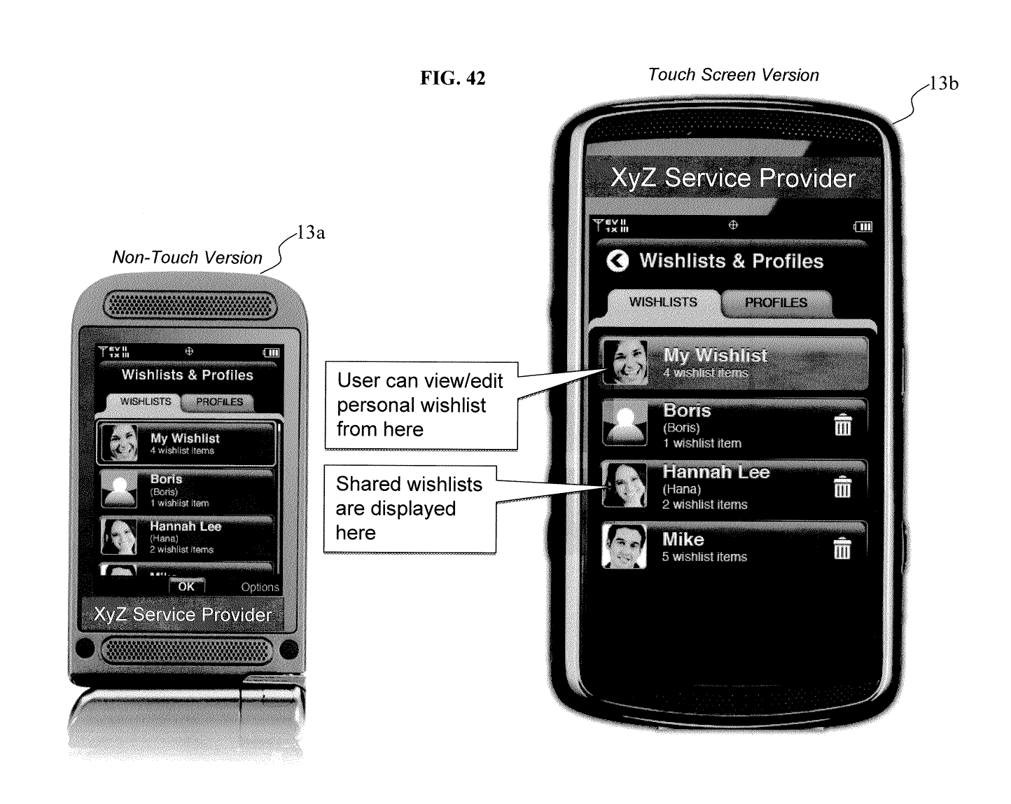

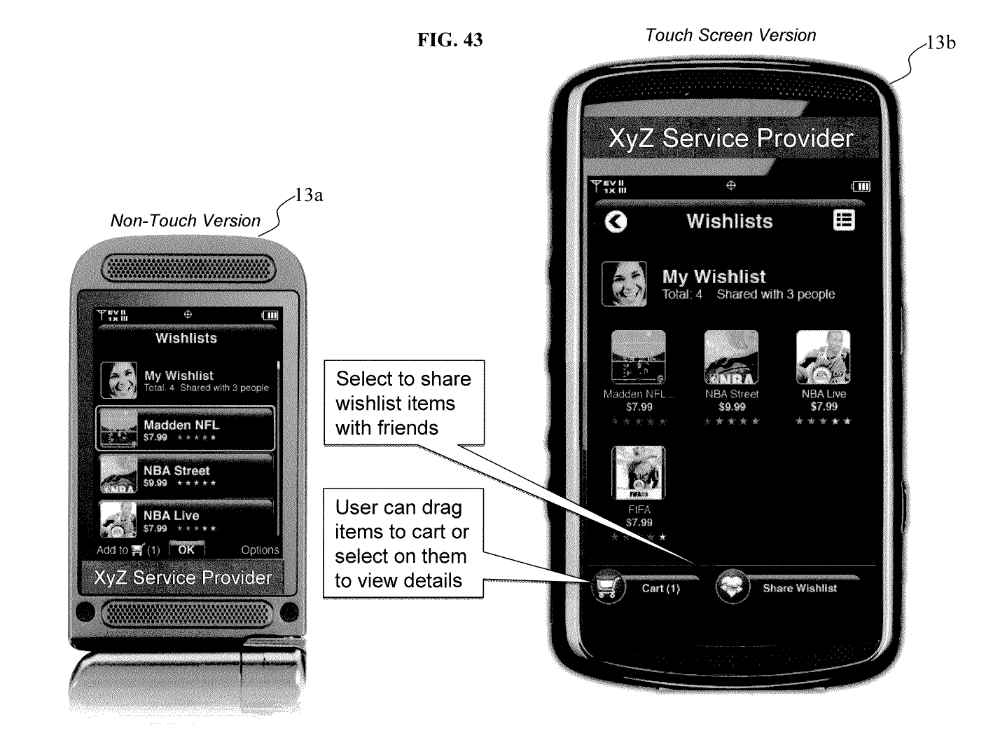

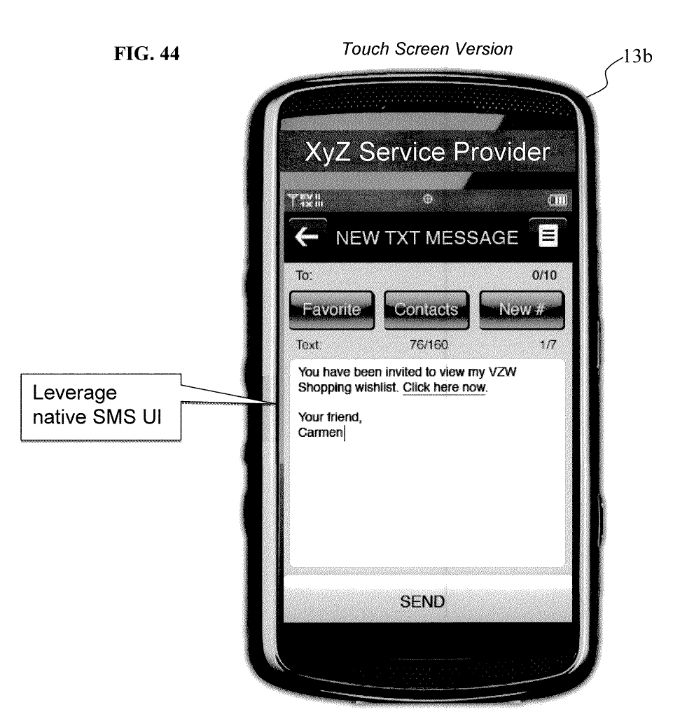

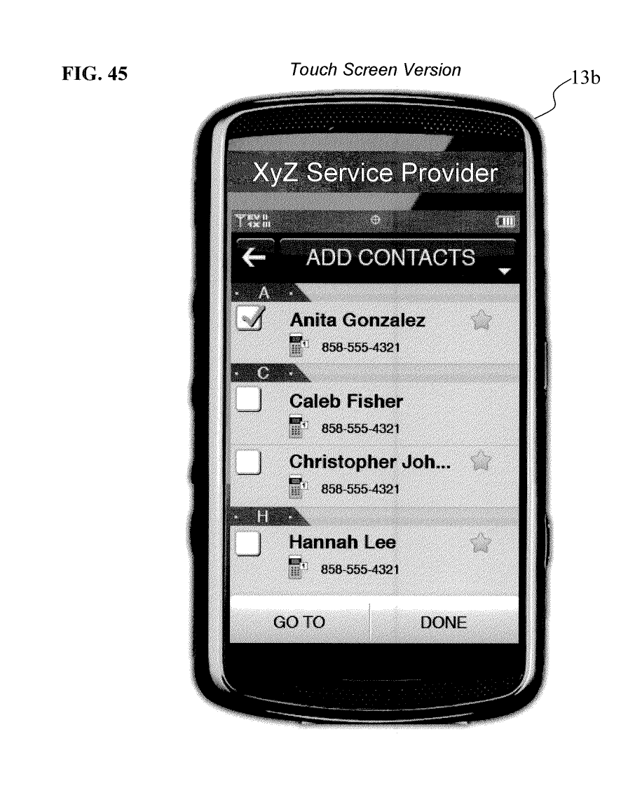

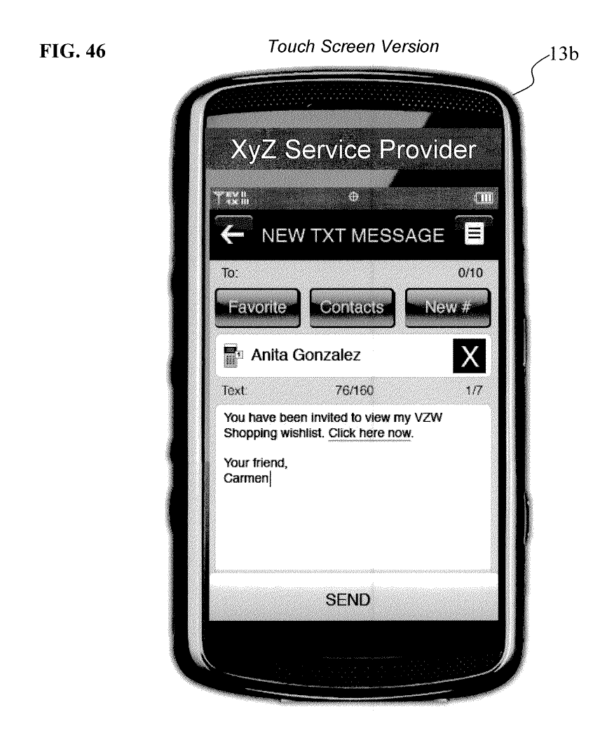

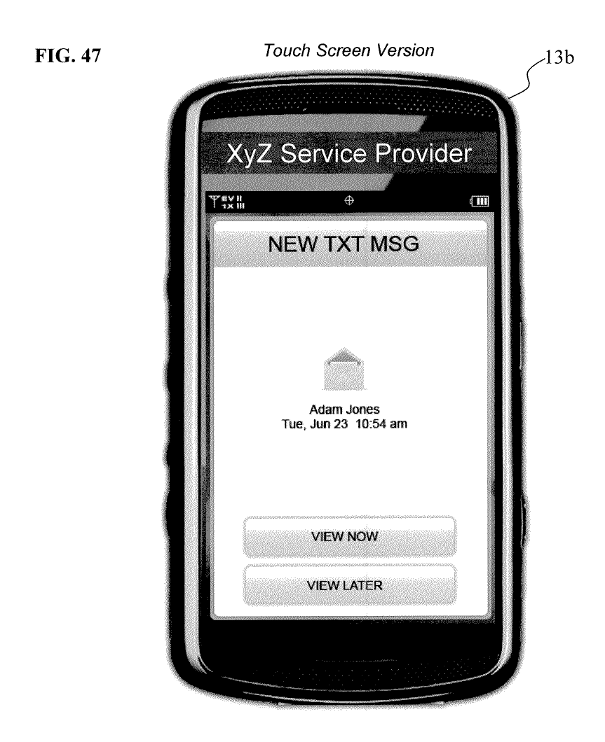

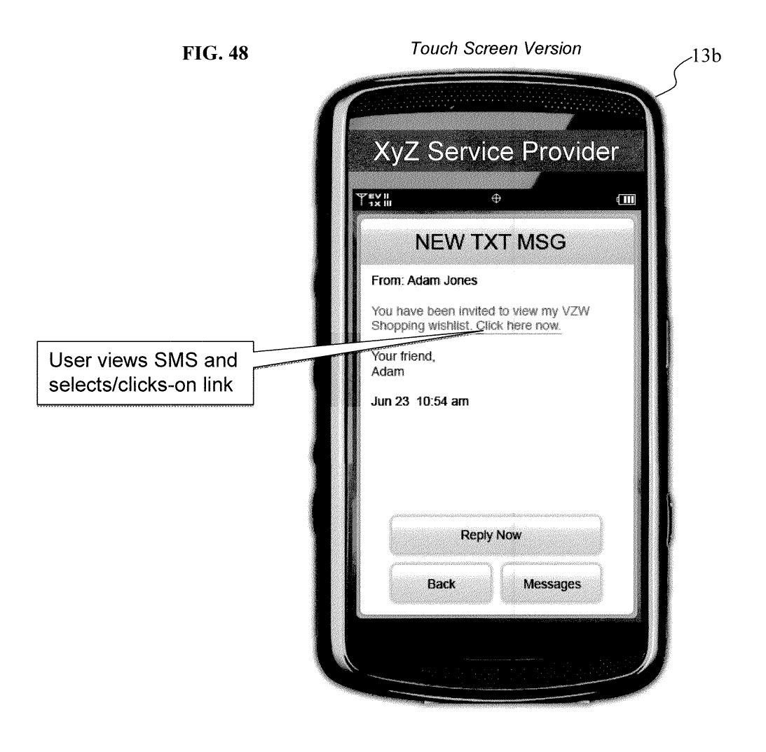

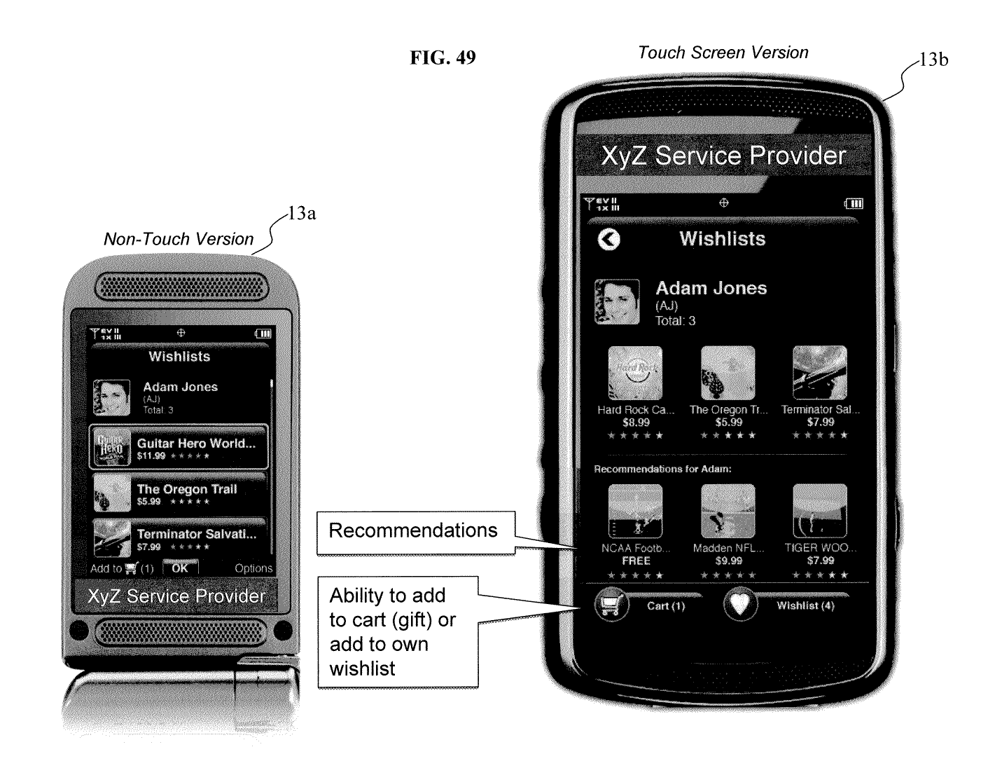

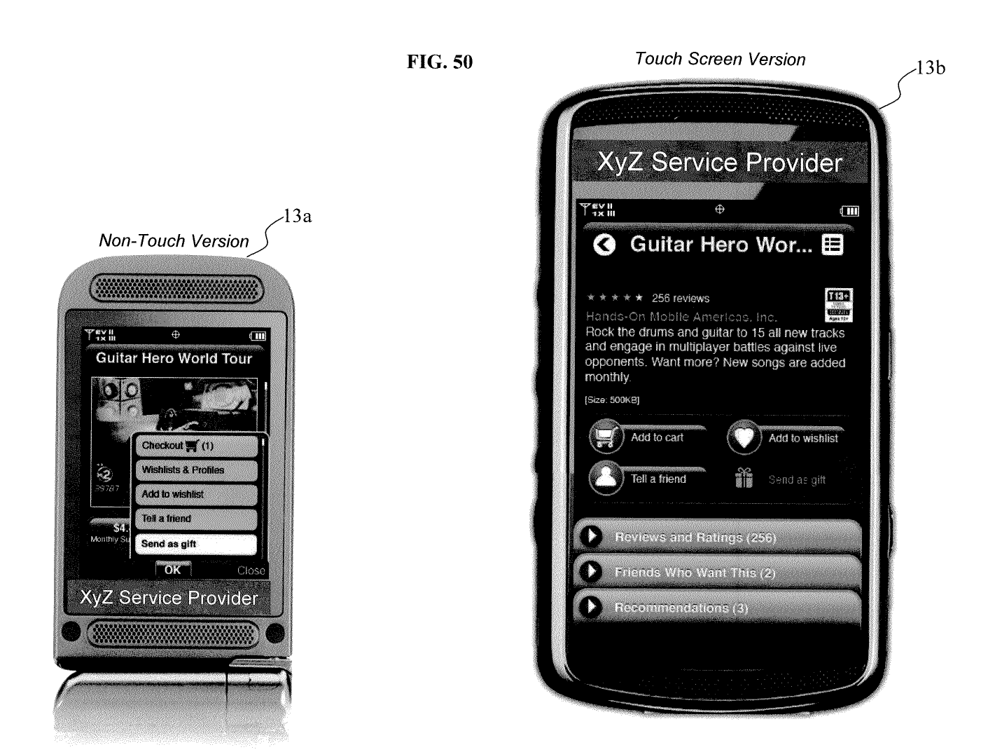

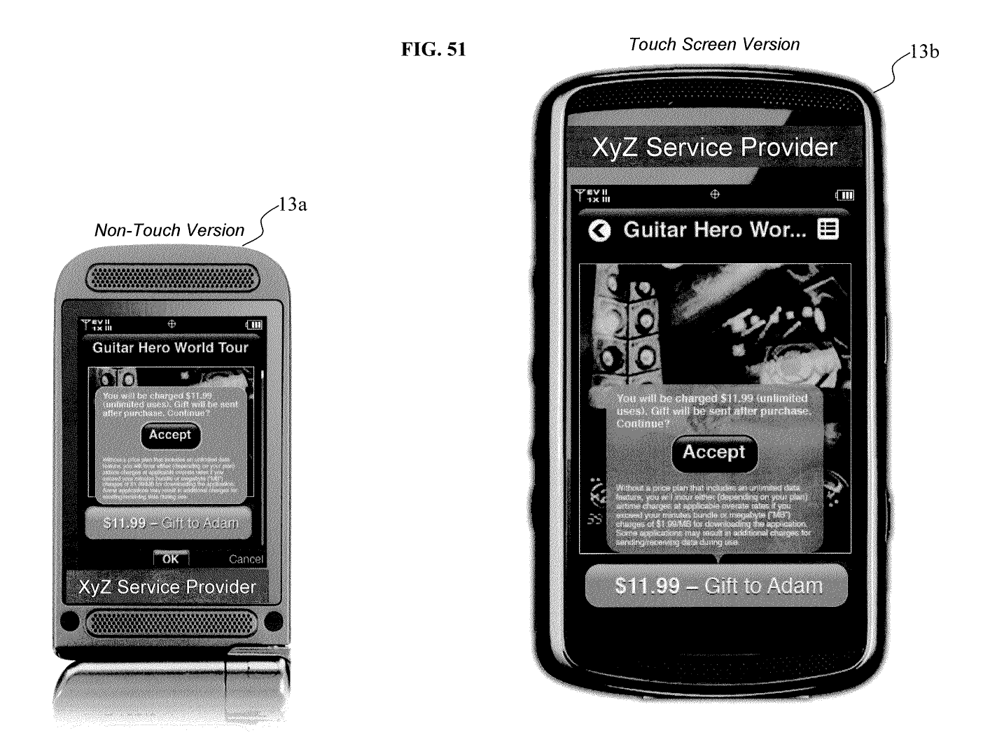

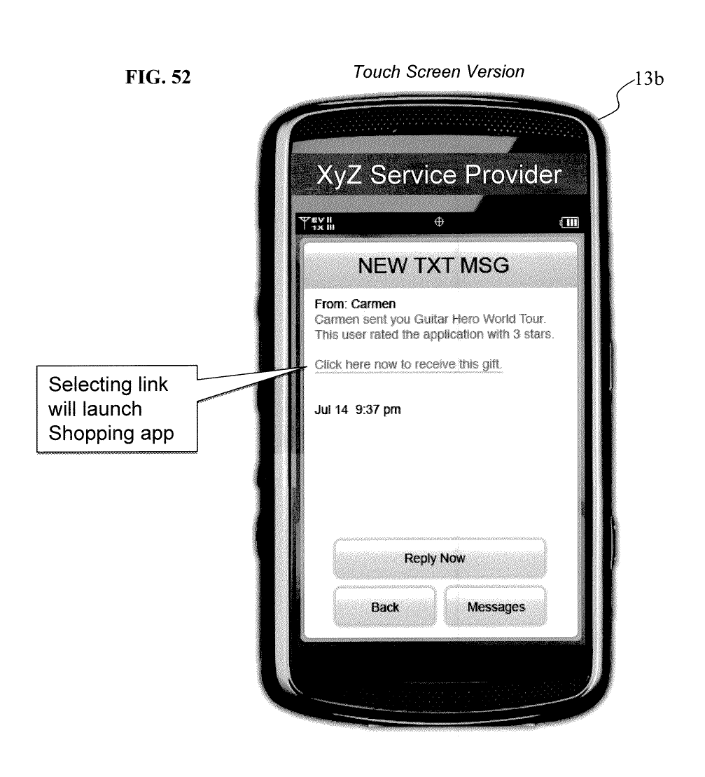

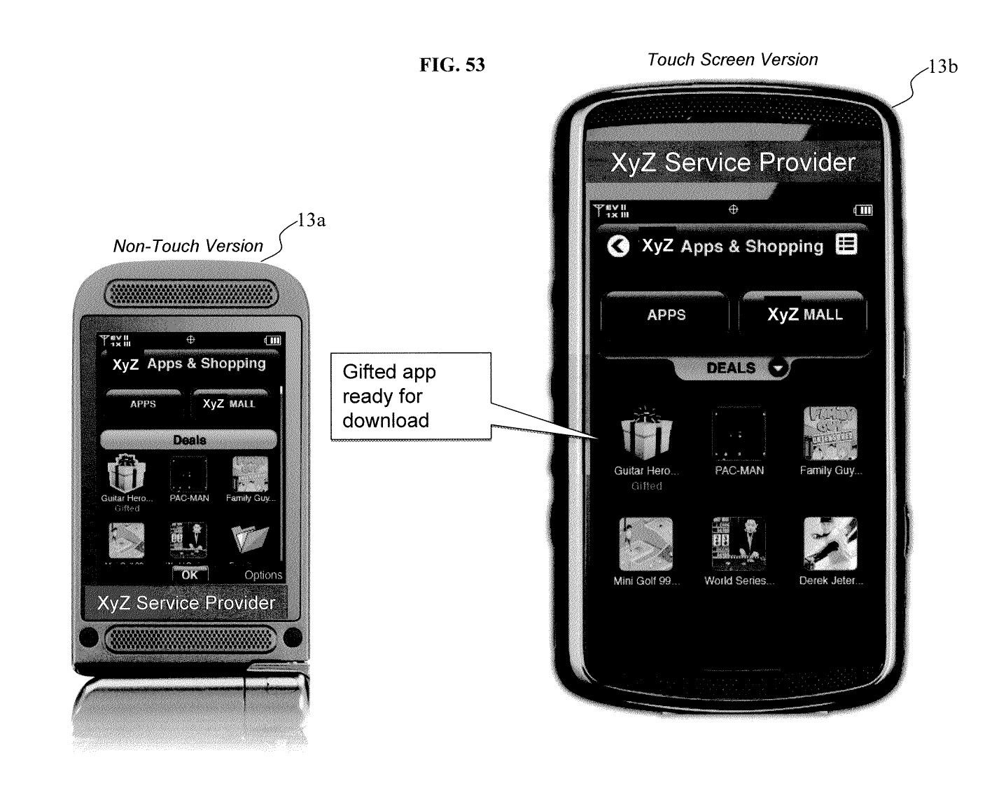

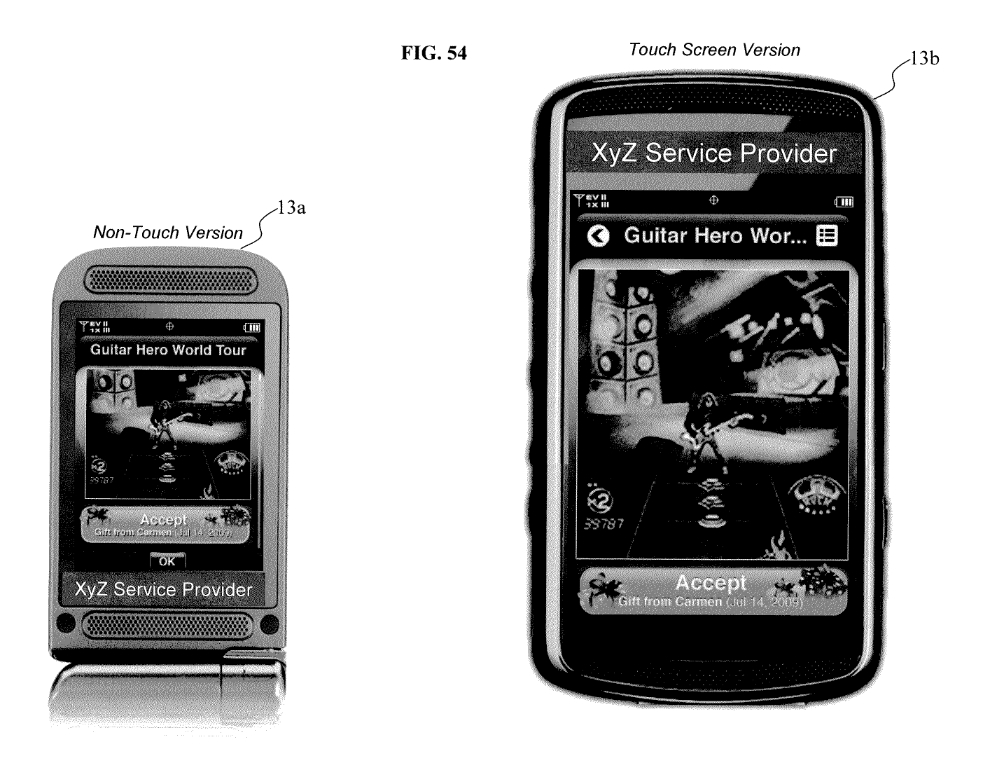

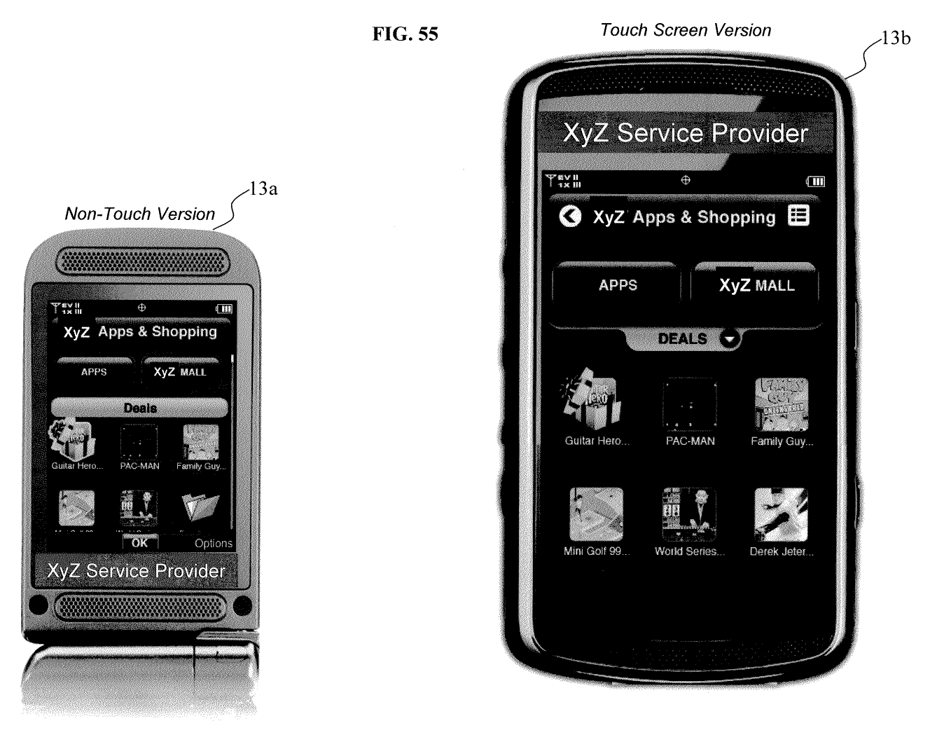

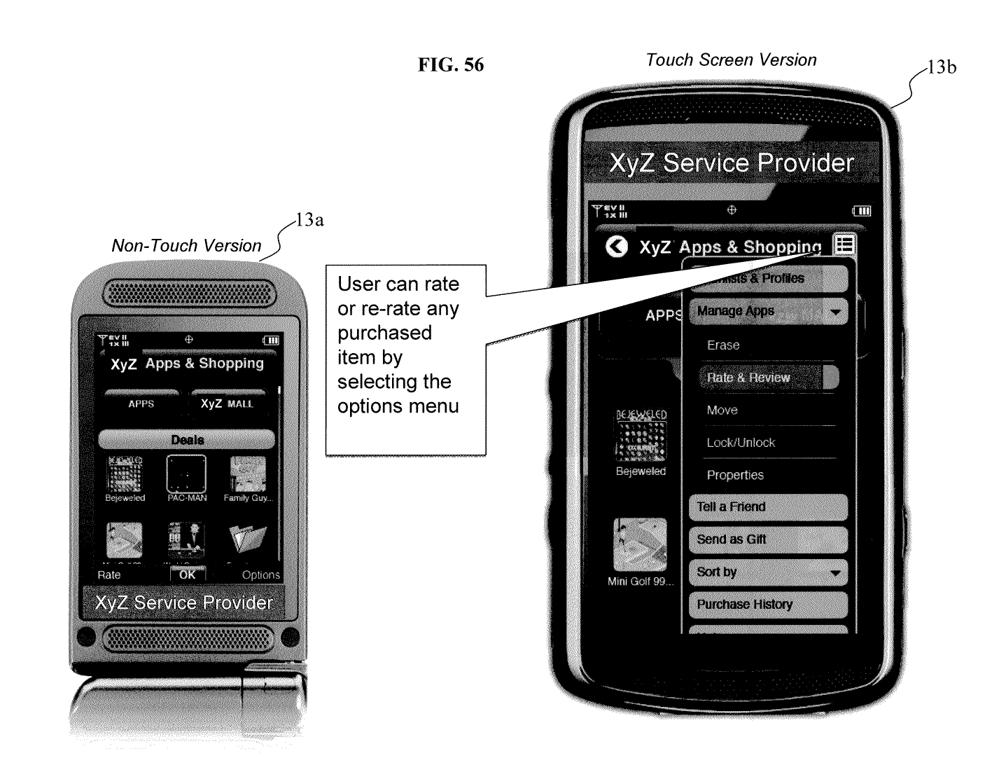

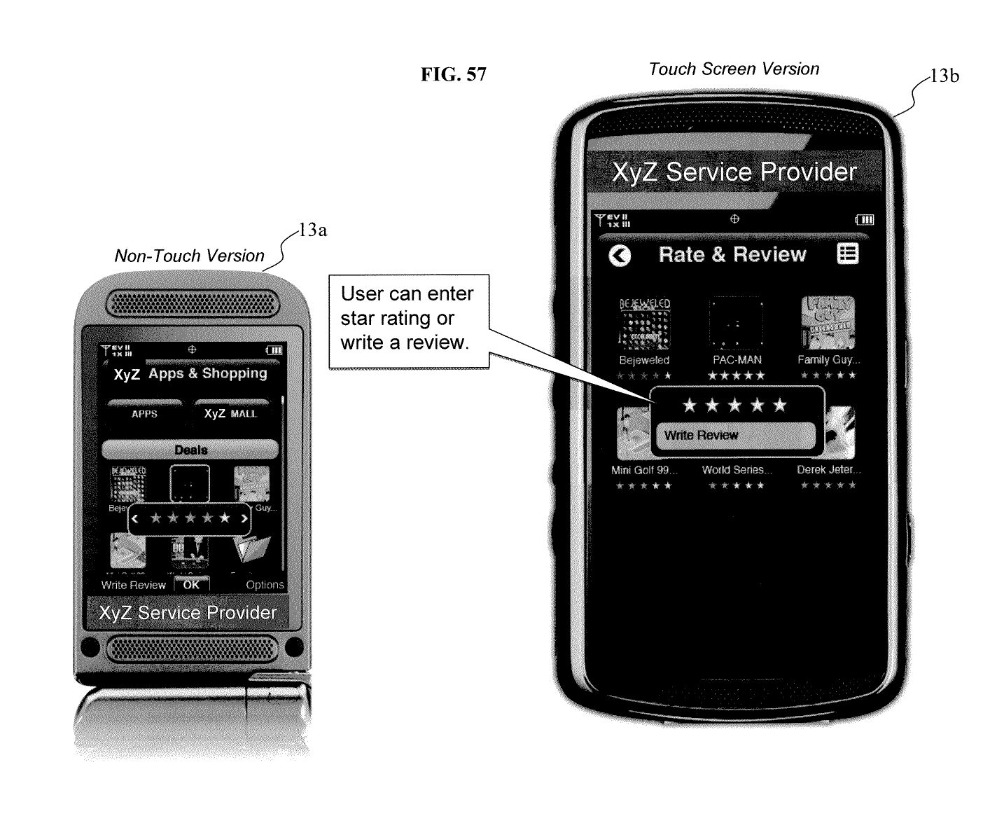

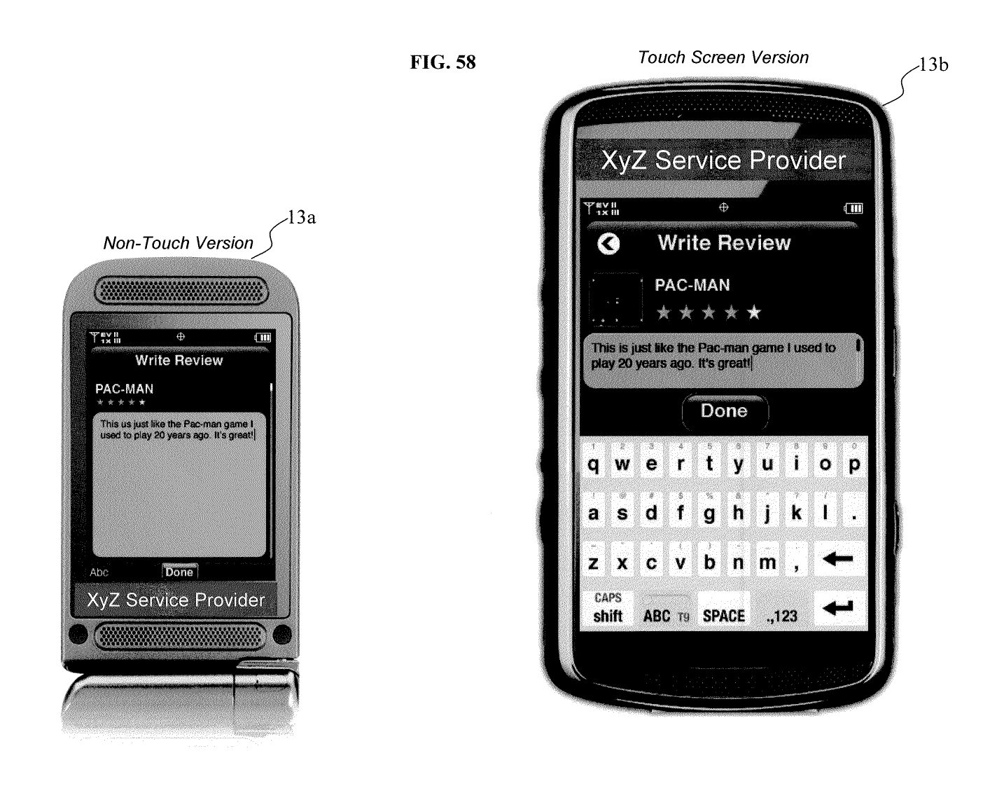

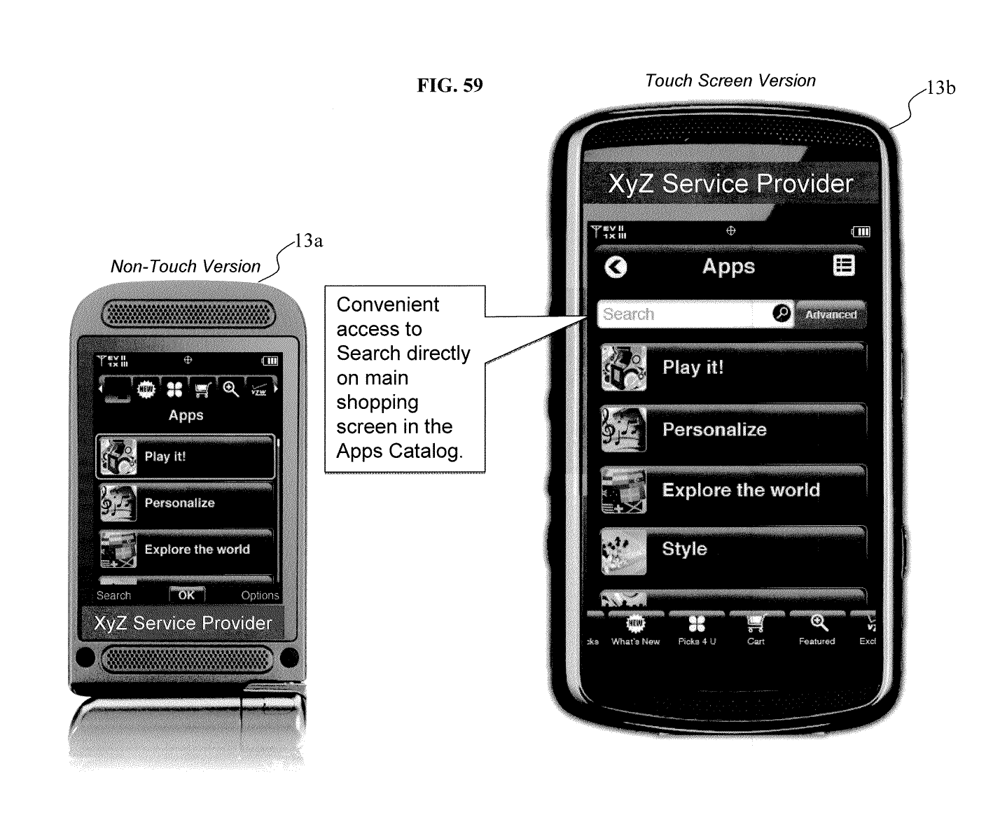

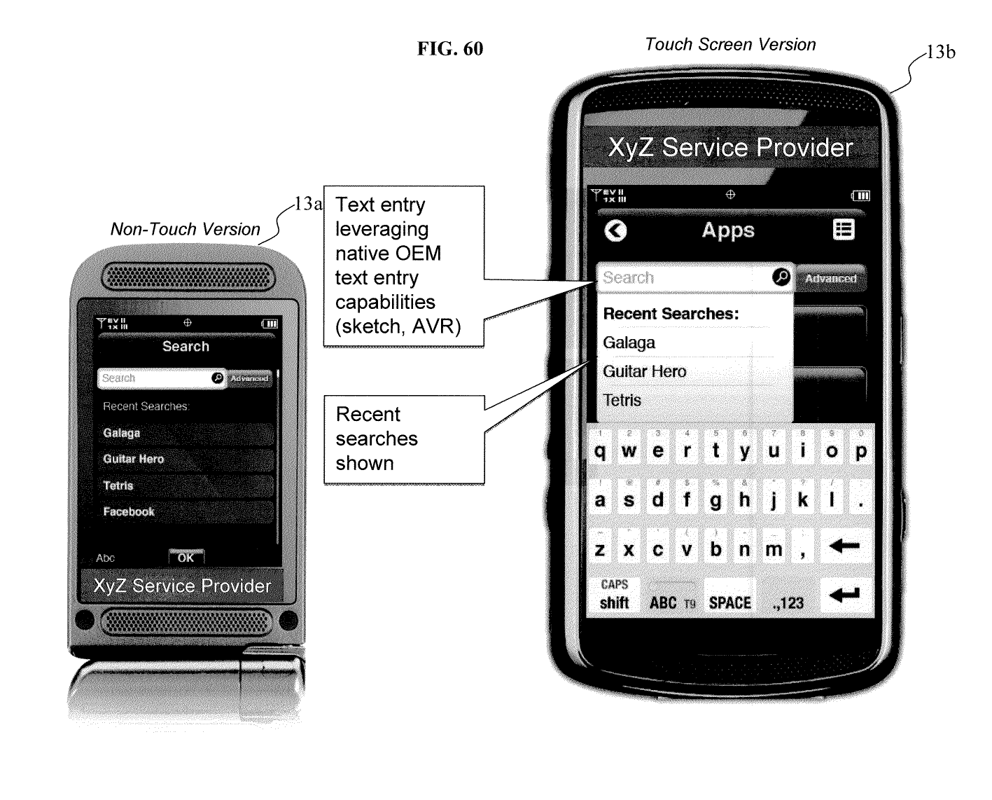

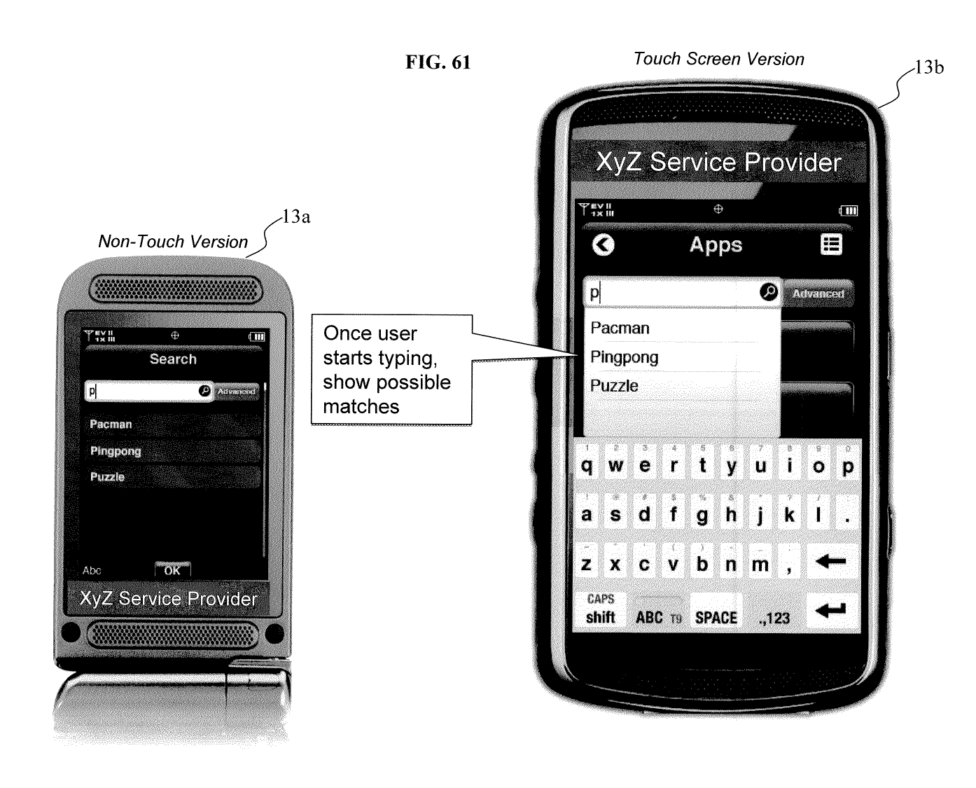

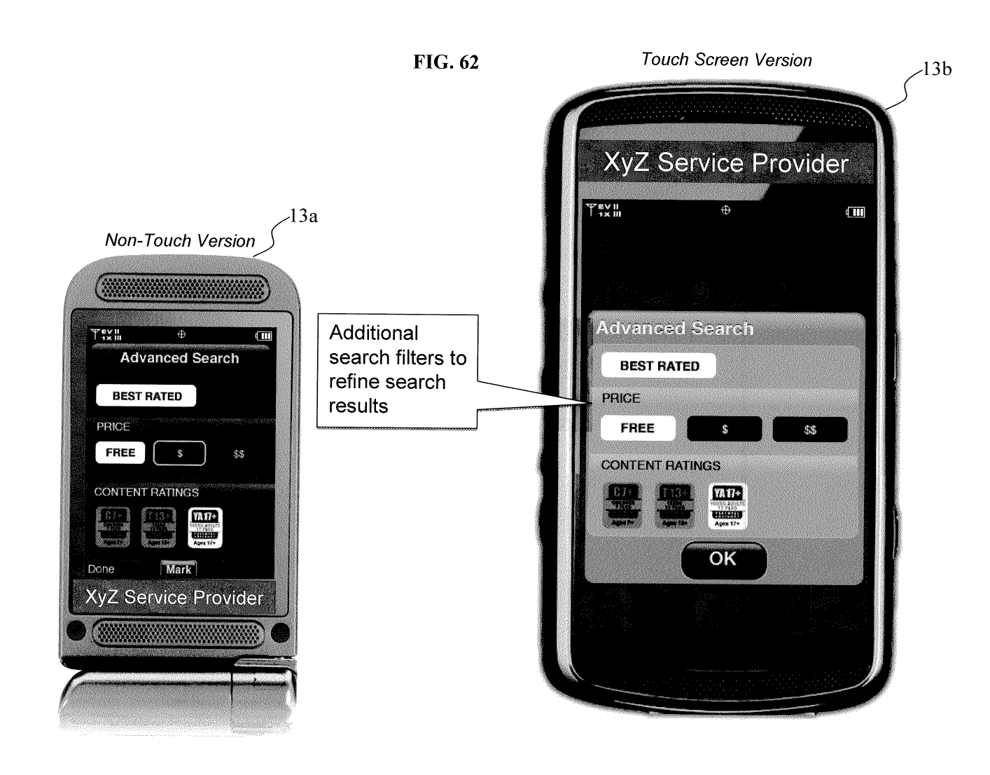

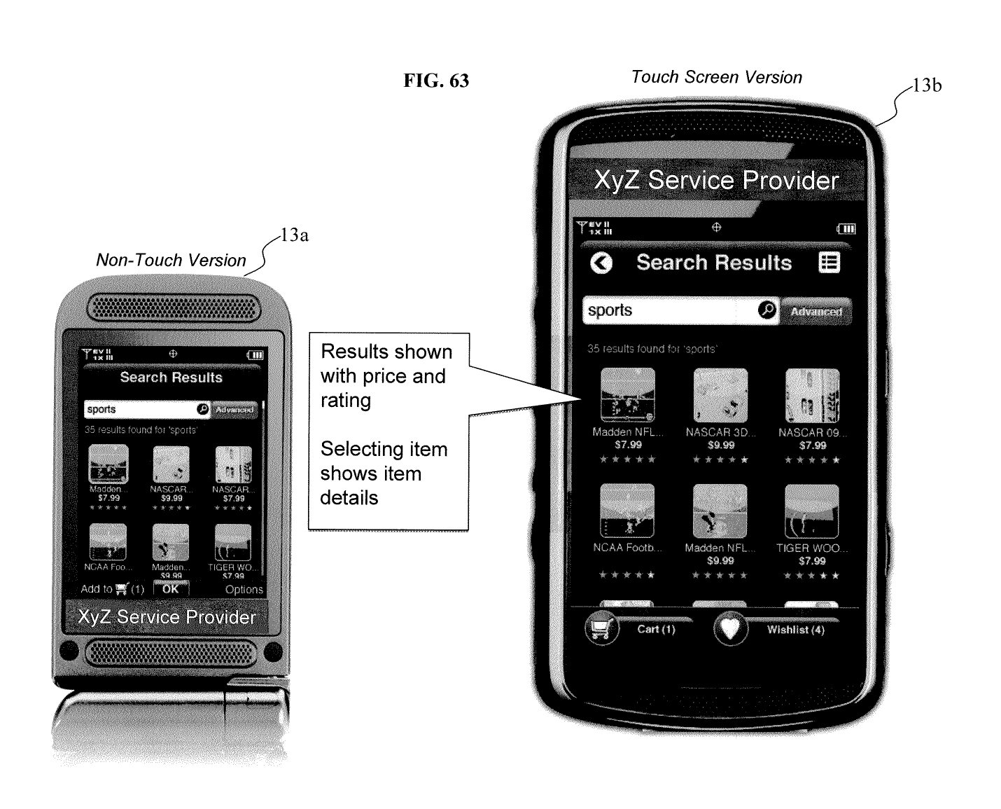

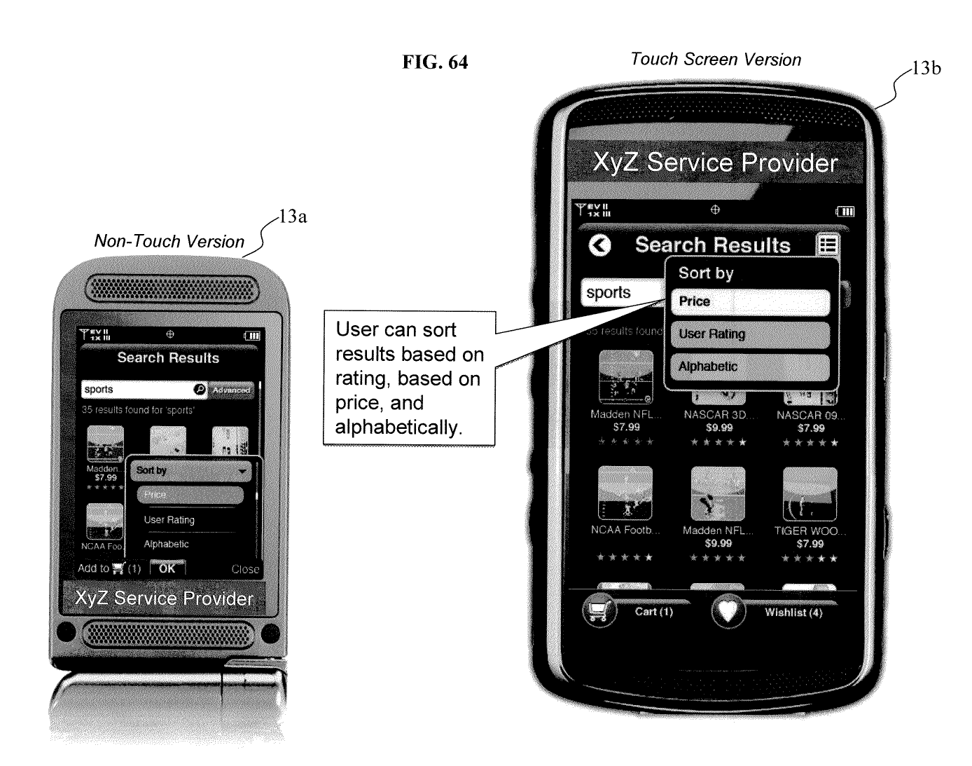

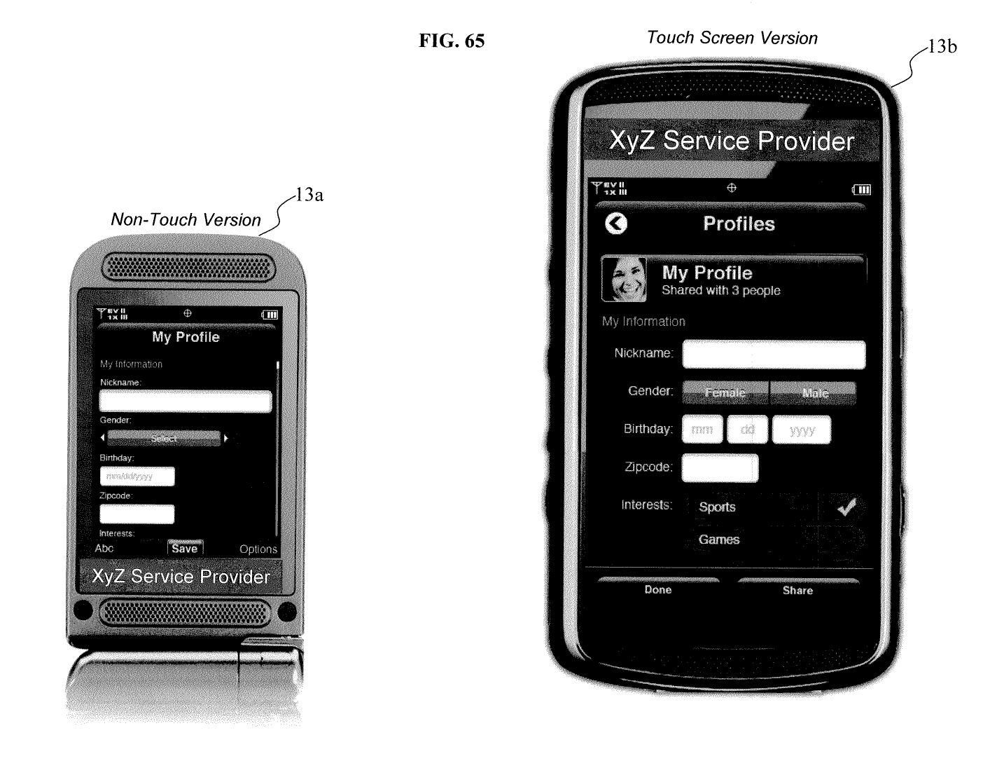

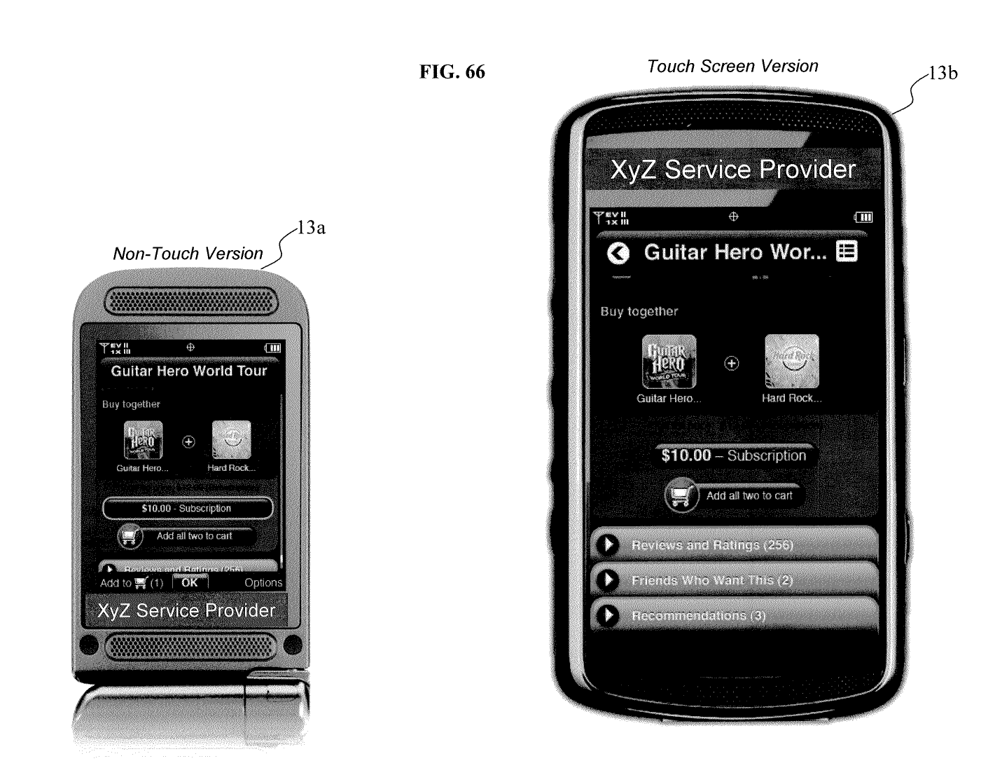

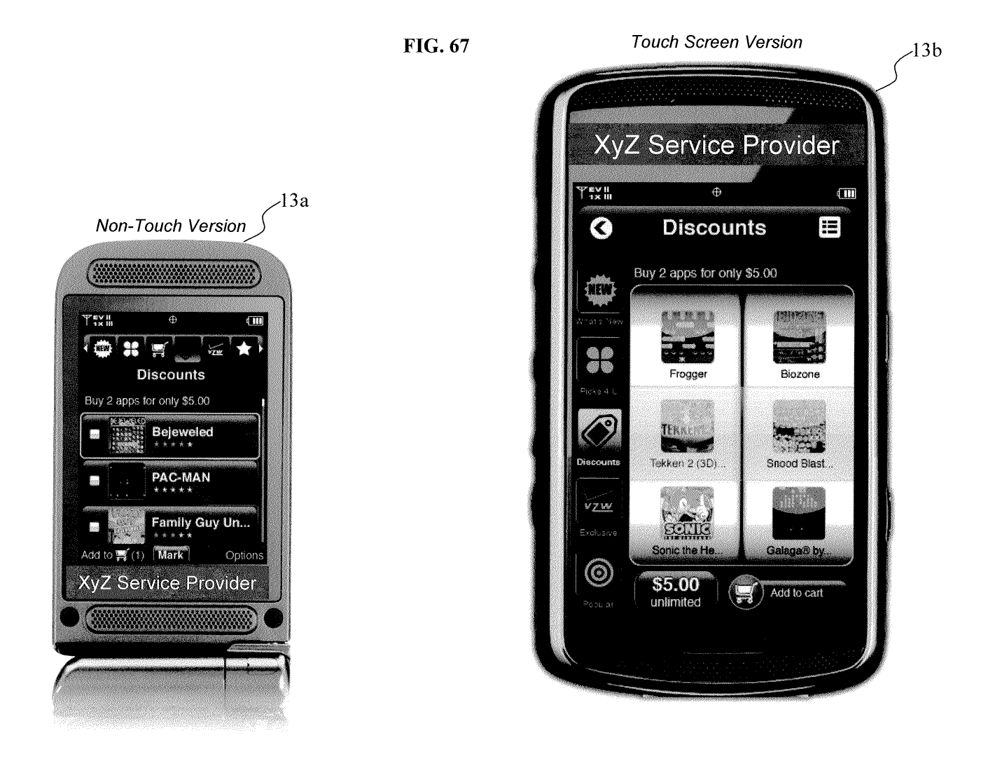

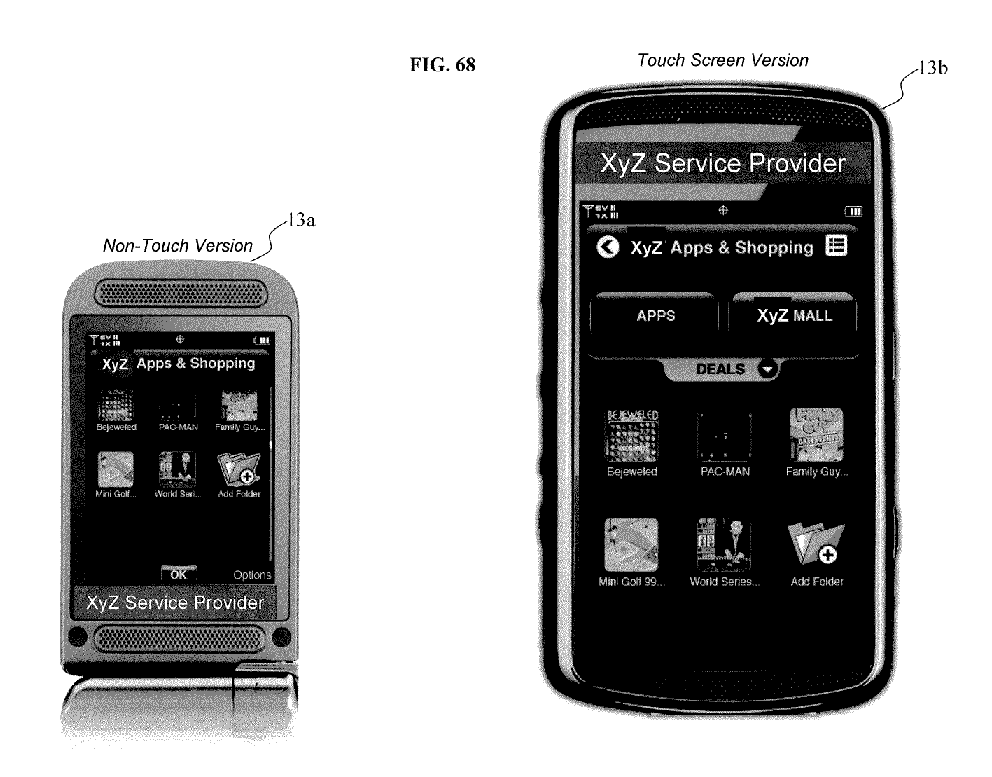

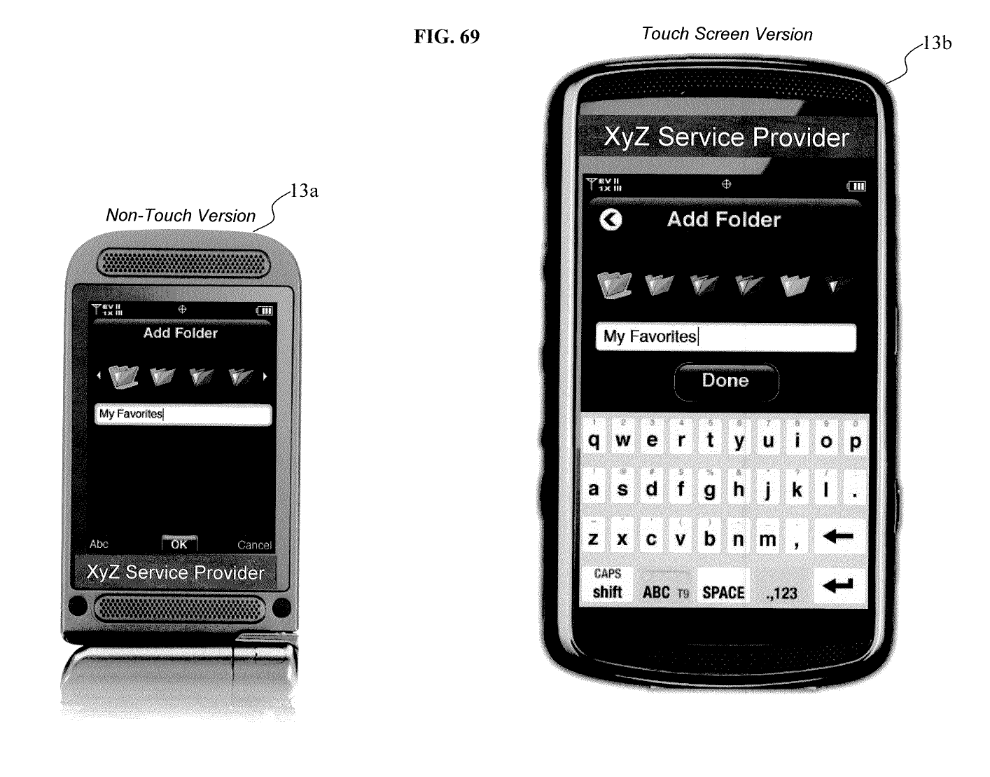

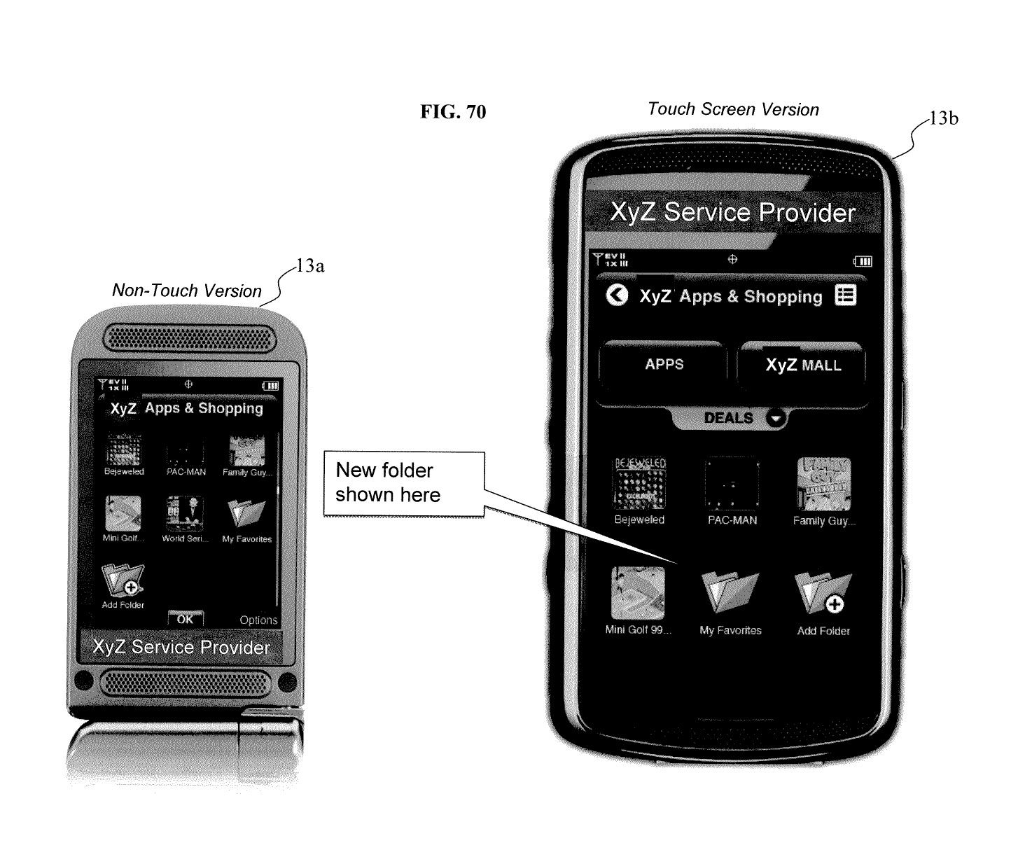

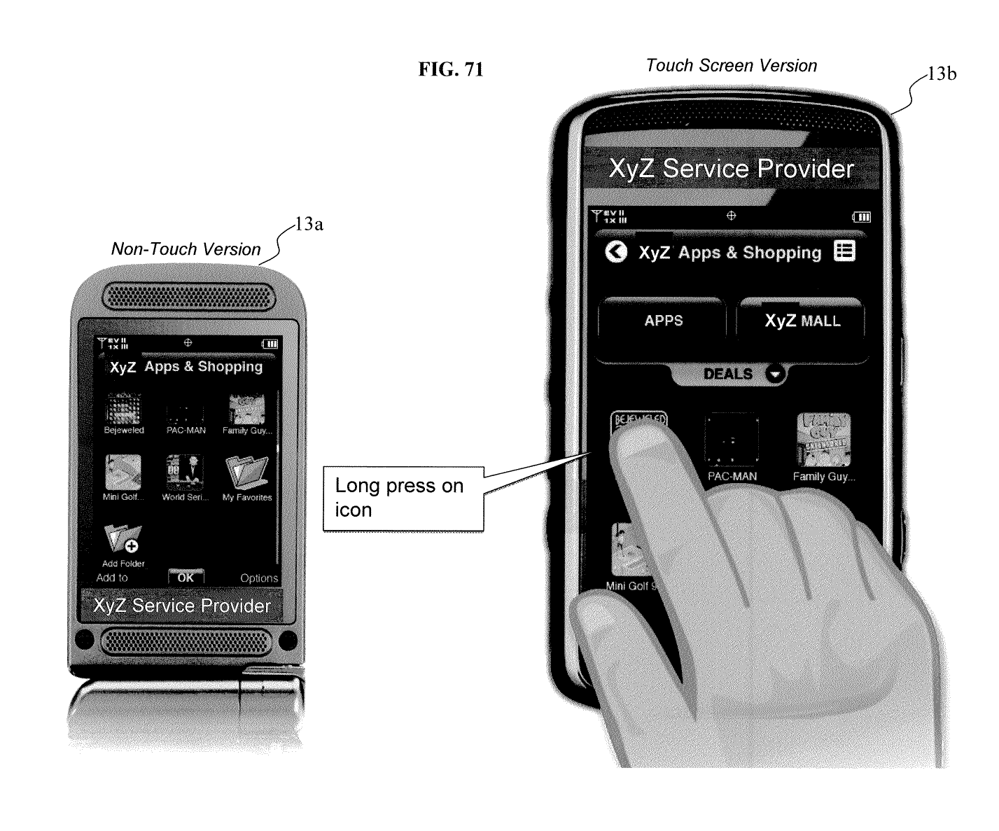

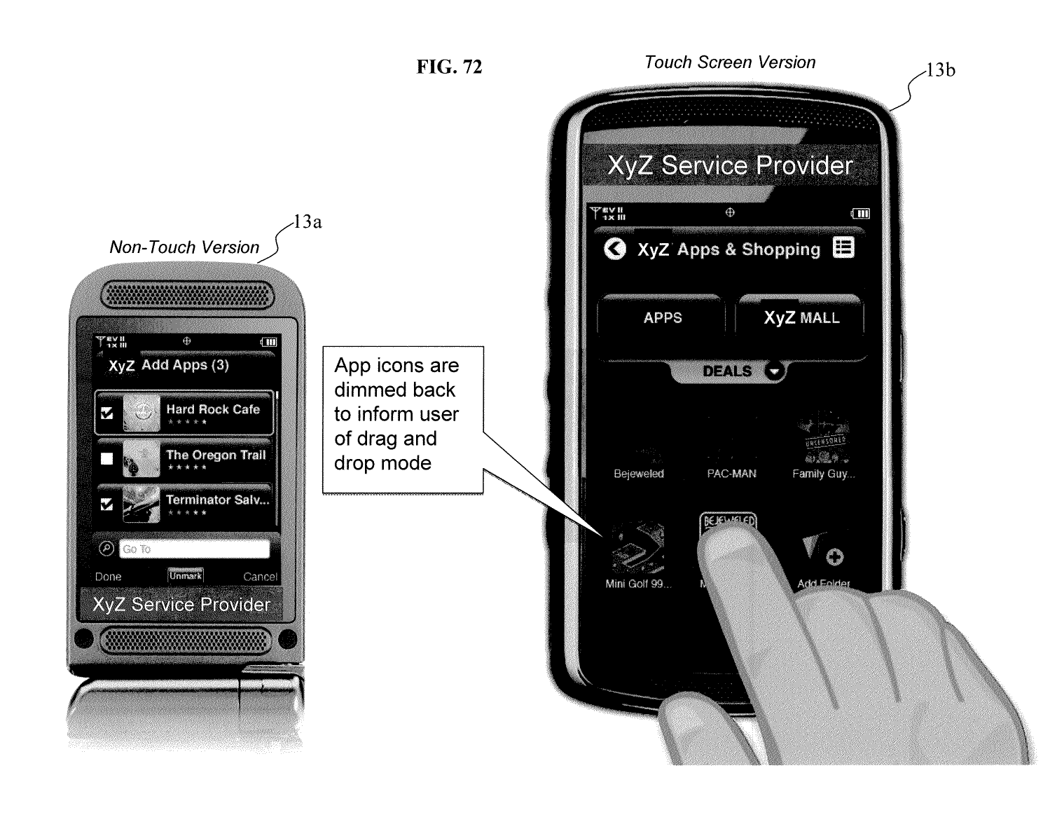

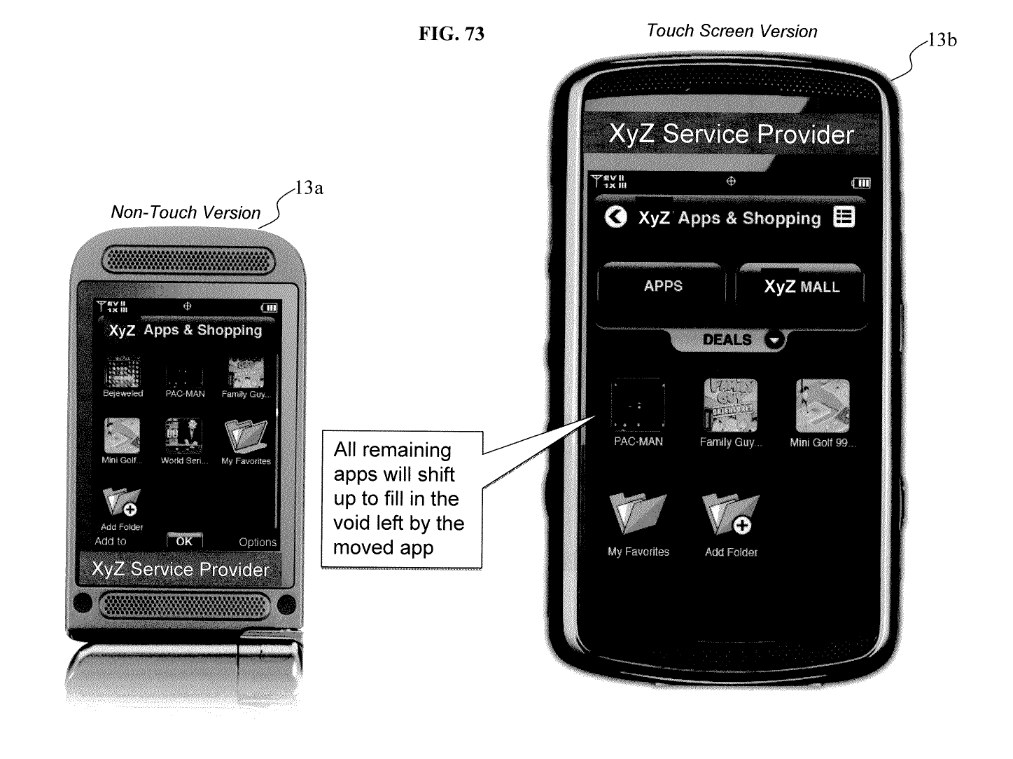

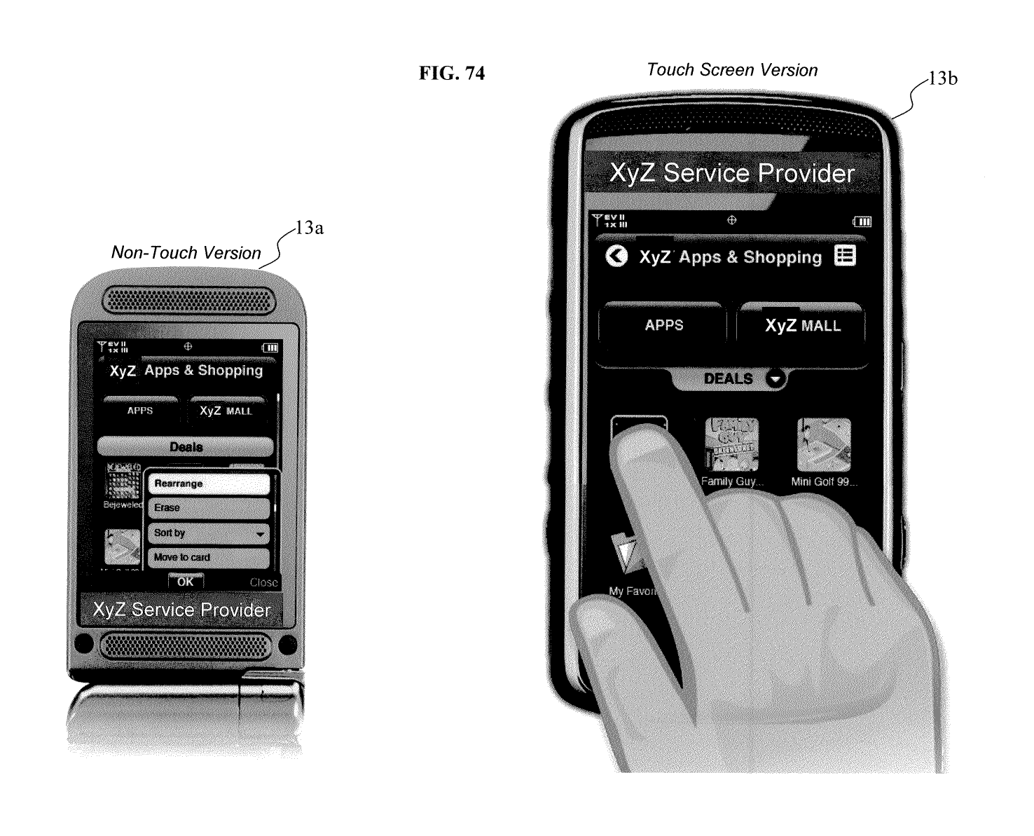

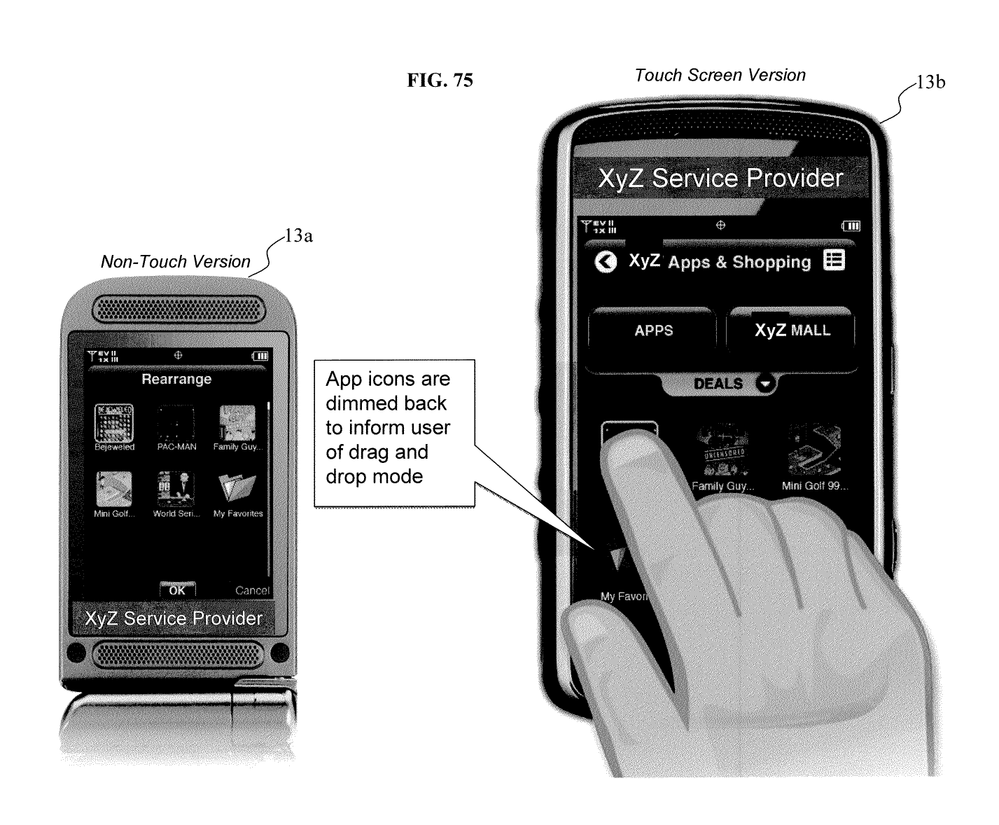

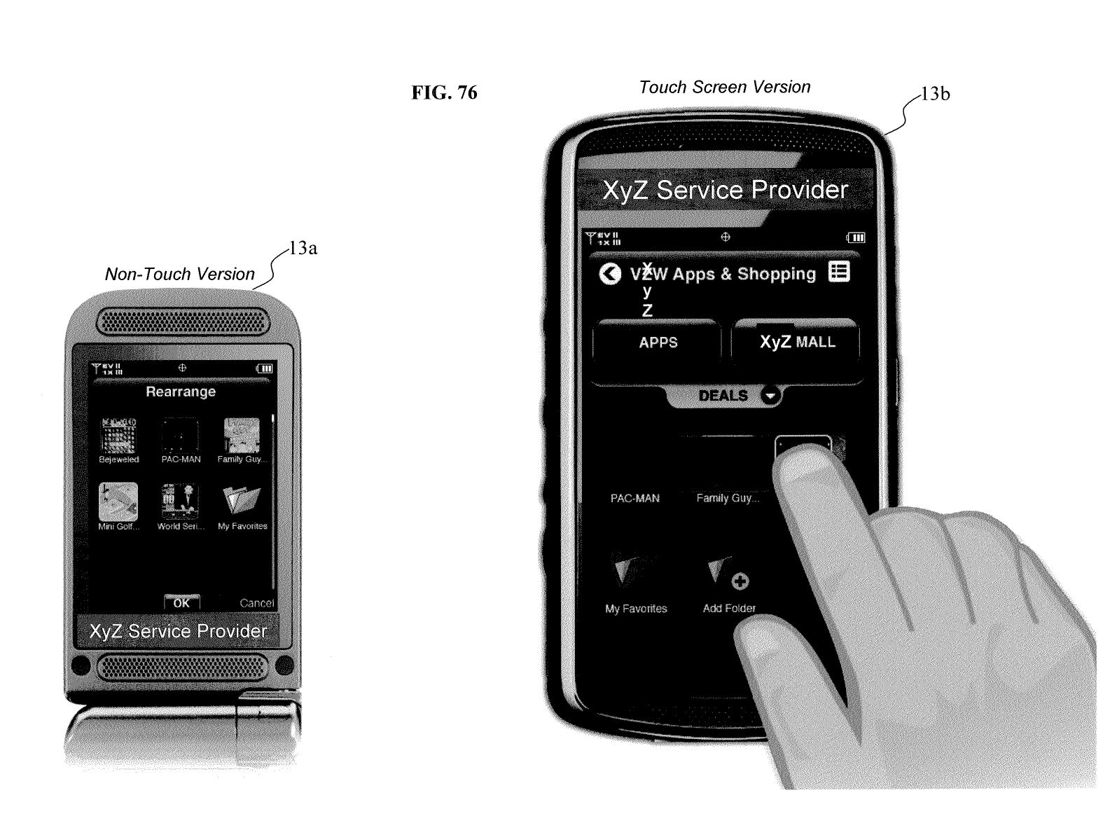

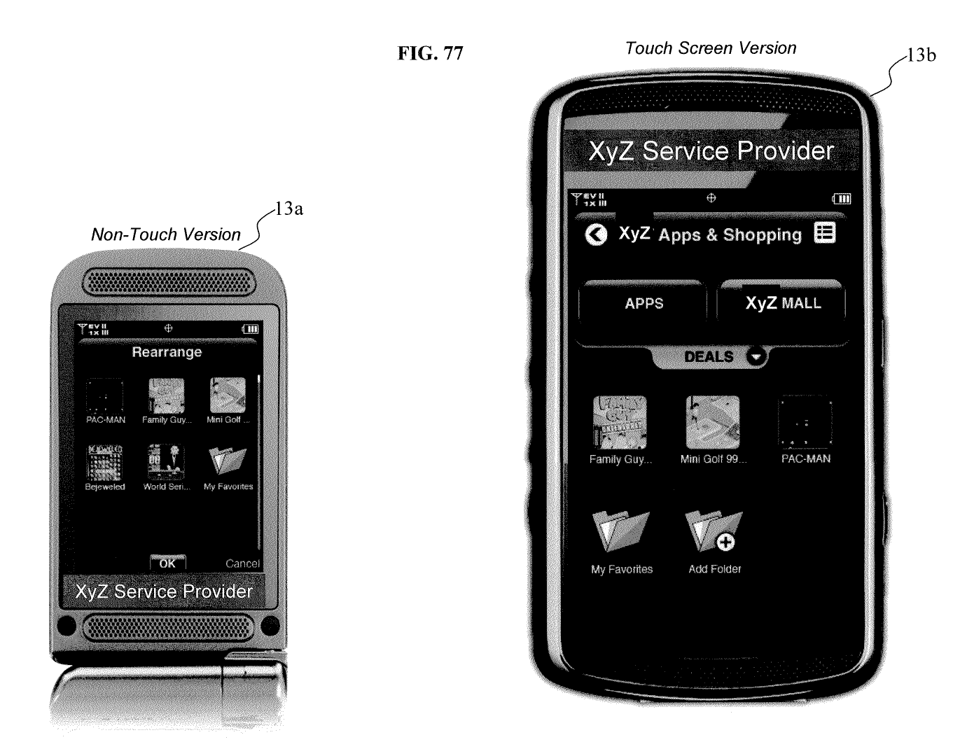

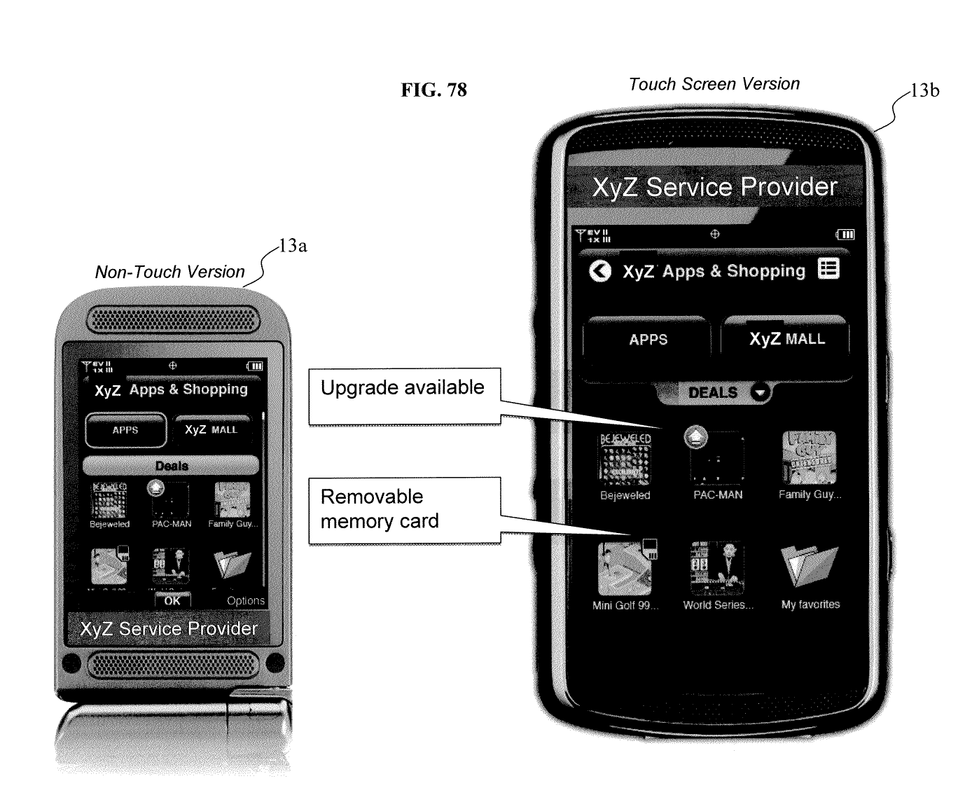

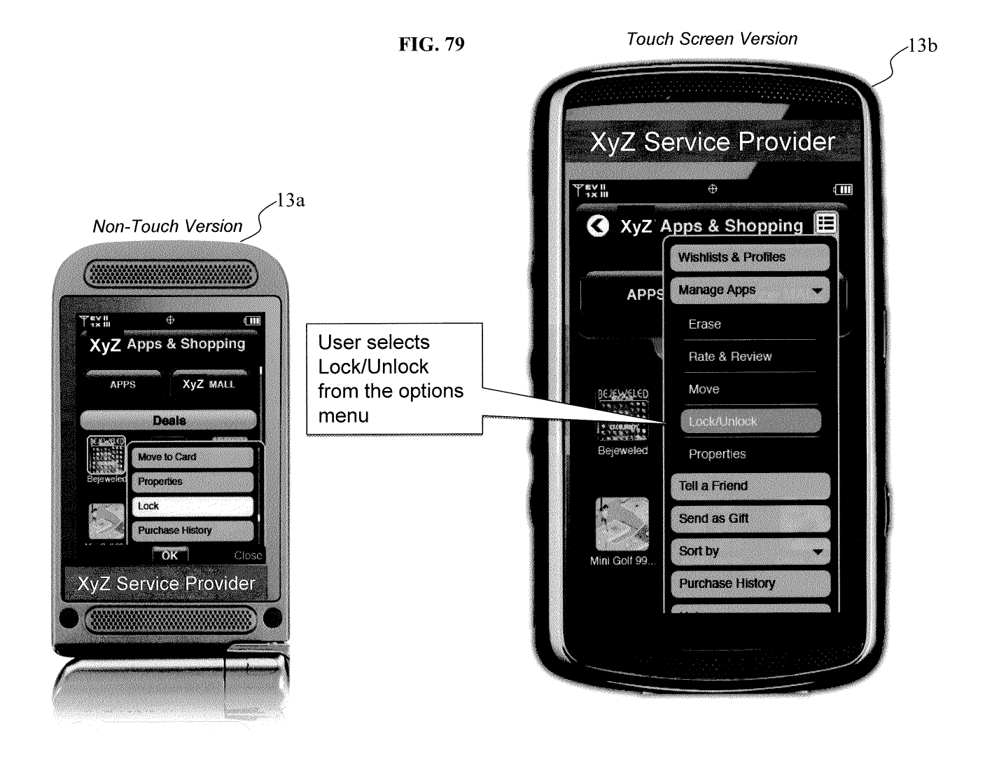

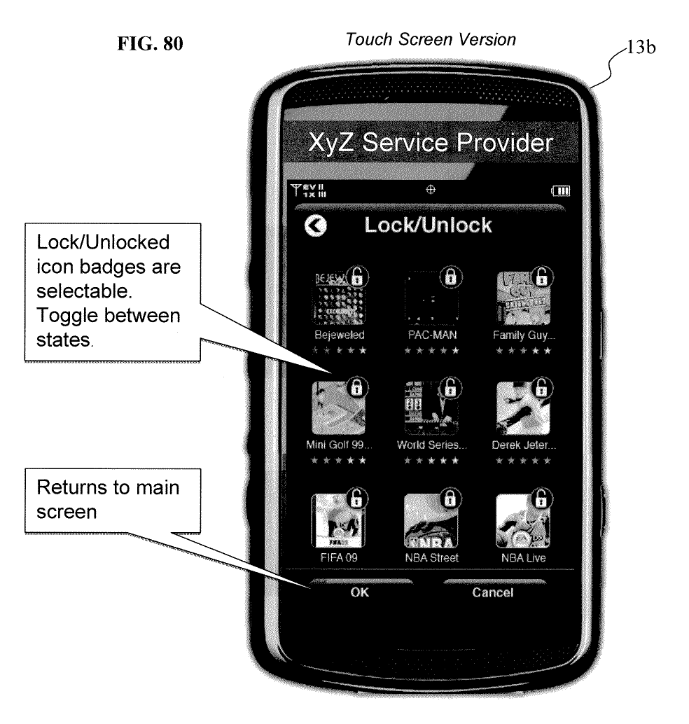

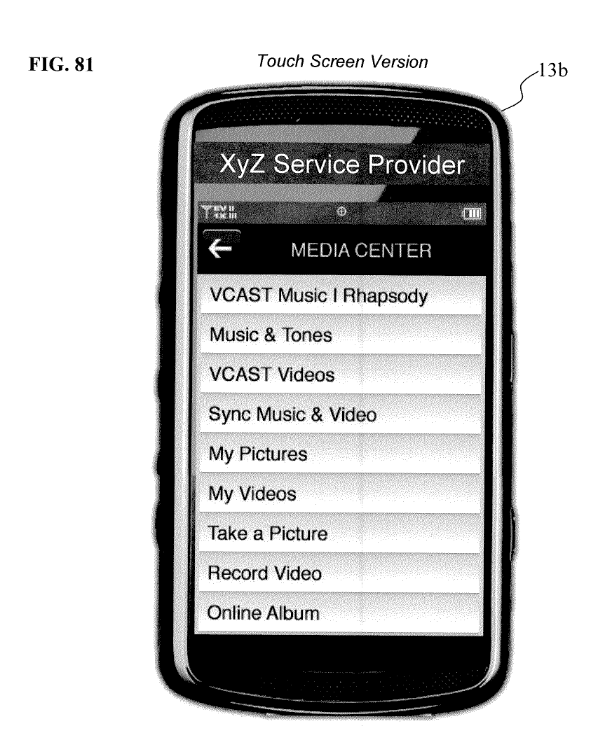

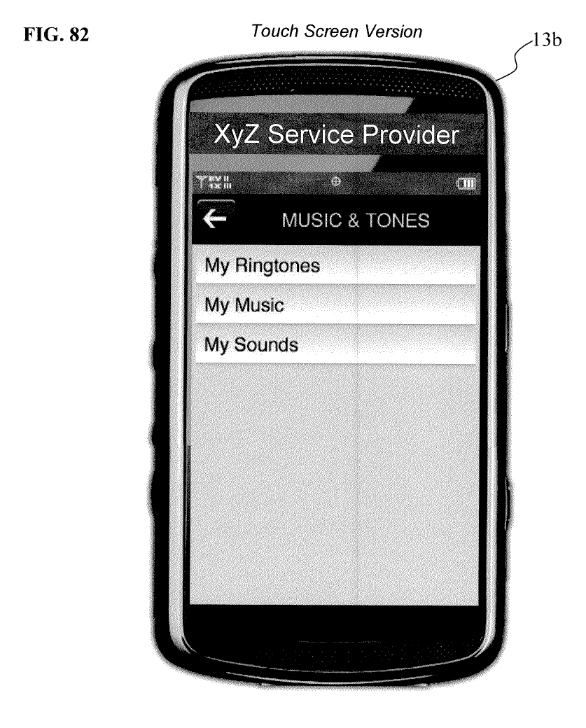

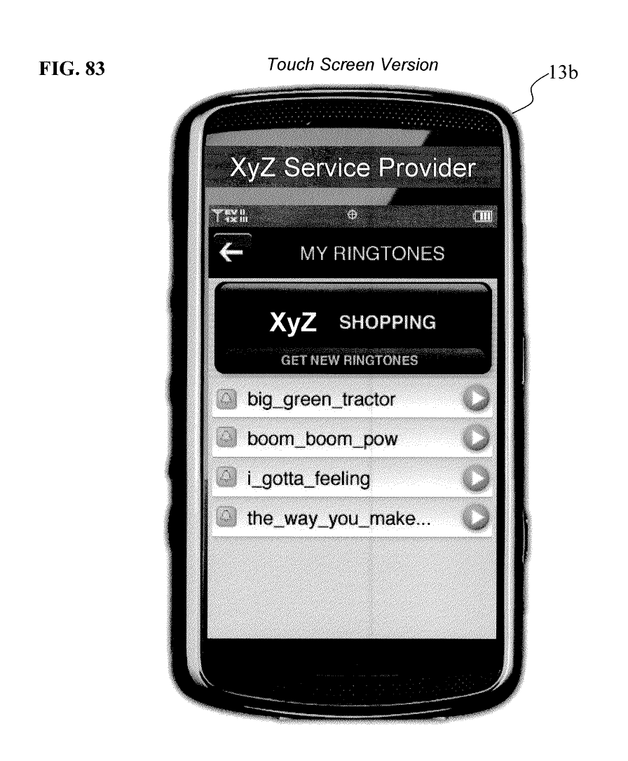

Reference now is made in detail to the examples illustrated in the accompanying drawings and discussed below. As outlined above, the drawings and detailed description encompass examples of an enhanced on-line shopping experience, offered via a user interface on a mobile station. FIGS. 1 to 83 illustrate examples of various stages of the shopping experience, as shopping related information might appear on one or two different types of exemplary mobile stations. Hence, FIGS. 1 to 83 show two exemplary types of mobile stations and user interface displays on those stations, as presented to a user at various stages of use of an example of the enhanced mobile on-line shopping service. The on-line store experience includes a catalog for applications (or other similar downloadable content items) as well as a virtual mall. Of these drawings, FIGS. 1 and 2 show screens or pages for accessing the store.

FIGS. 3 to 13 show screens or pages at various stages of browsing the application catalog portion of the on-line store and purchasing a single application from the catalog for downloading to the user's mobile station. FIGS. 14 to 22 show screens or pages at various stages of browsing the application catalog portion of the on-line store and purchasing a number of applications from the catalog, in one purchase transaction, for downloading to the user's mobile station at the same time.

FIGS. 23 to 30 show screens or pages at various stages of browsing through the virtual mall. FIGS. 31 and 32 show screens or pages allowing the user to view the special deals available via the on-line store. FIGS. 33 to 40 show screens or pages that may be presented in examples of several impulse buying scenarios. FIGS. 41 to 46 show screens or pages that may be presented to the user when desiring to ‘share my wishlist’ from the on-line store with another user, whereas FIGS. 47 to 49 show screens or pages that may be presented to a user who receives a friend's wishlist from the on-line store. FIGS. 50 and 51 show screens or pages that may be presented to the user when desiring to purchase and send an application to another user from the on-line store, whereas FIGS. 52 to 55 show screens or pages that may be presented to a user who receives such an application gift from a friend via the on-line store service.

FIGS. 56 to 58 show screens or pages that may be presented to a user to allow the user to rate an item and write a review, whereas FIGS. 59 to 64 show screens or pages that may be presented to a user to allow the user to search for an item. FIG. 65 shows a screen or page on which a user can set up a profile. FIG. 66 shows a screen or page offering the user discounted bundles of applications pre-picked by the on-line shopping service provider, whereas FIG. 67 shows a screen or page offering the user a discounted bundle of applications where the bundle is picked by the user. FIGS. 68 to 80 show screens or pages that may be presented to a user to allow the user to organize applications. FIGS. 81 to 83 show screens or pages related to the Media Center.

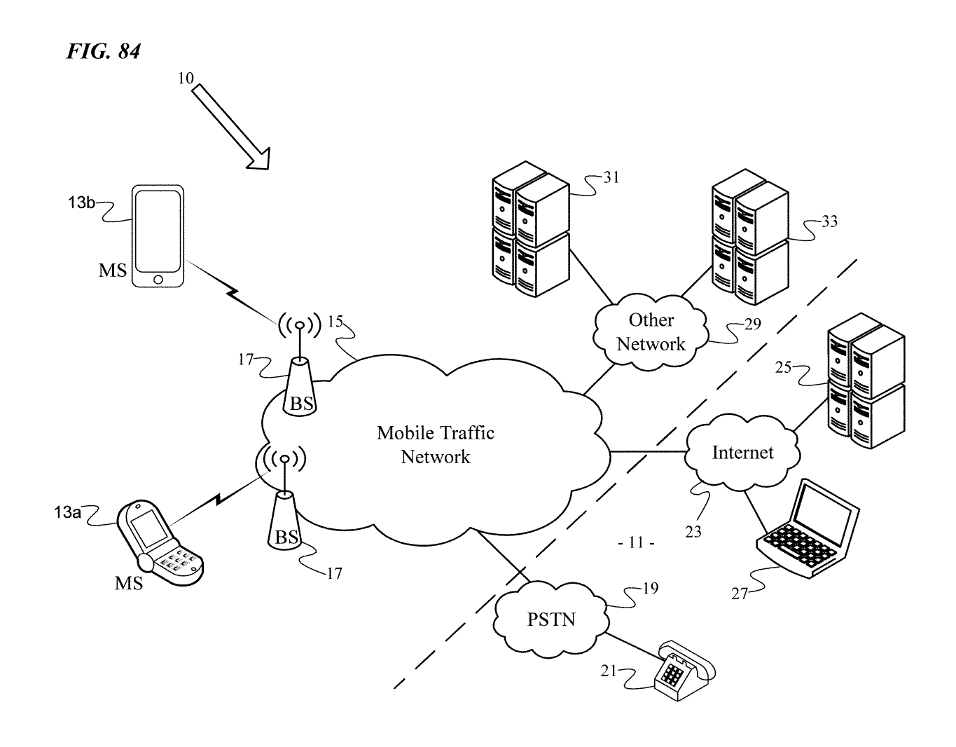

The shopping experience may be provided to mobile users via a variety of different types of wireless mobile communication networks and/or implemented via a variety of different types of mobile stations. To help understand how the mobile shopping experience might be delivered, it may be useful to consider an example of a suitable network as well as examples of a couple of different types of mobile stations, with respect to FIGS. 84 to 86, before discussing various aspects of the shopping experience exemplified by FIGS. 1 to 83 in more detail.

FIG. 84 illustrates a system 10 offering a variety of mobile communication services, including communications for on-line shopping by mobile station users. The example shows simply two mobile stations (MSs) 13a and 13b as well as a mobile communication network 15. The stations 13a and 13b are examples of mobile stations that may be used for the on-line shopping. However, the network will provide similar communications for many other similar users as well as for mobile devices/users that do not participate in the on-line shopping. The network 15 provides mobile wireless communications services to the stations exemplary stations 13, 13b as well as to other mobile stations (not shown), for example, via a number of base stations (BSs) 17. The present techniques may be implemented in any of a variety of available mobile networks 15 and/or on any type of mobile station compatible with such a network 15, and the drawing shows only a very simplified example of a few relevant elements of the network 15 for purposes of discussion here.

The wireless mobile communication network 15 might be implemented as a network conforming to the code division multiple access (CDMA) IS-95 standard, the 3rd Generation Partnership Project 2 (3GPP2) wireless IP network standard or the Evolution Data Optimized (EVDO) standard, the Global System for Mobile (GSM) communication standard, a time division multiple access (TDMA) standard or other standards used for public mobile wireless communications. The mobile stations 13a and 13b may be capable of voice telephone communications through the network 15, and for the on-line shopping services, the exemplary devices 13a and 13b are capable of data communications through the particular type of network 15. The users of the mobile stations may have a voice plan, and at least users of stations 13a and 13b will have subscribed to a data service plan through the network.

The network 15 allows users of the mobile stations such as 13a and 13b (and other mobile stations not shown) to initiate and receive telephone calls to each other as well as through the public switched telephone network or “PSTN” 19 and telephone stations 21 connected to the PSTN. The network 15 typically offers a variety of data services via the Internet 23, such as downloads, web browsing, email, etc. By way of example, the drawing shows a laptop PC type user terminal 27 as well as a server 25 connected to the Internet 23; and the data services for the mobile stations 13 via the Internet 23 may be with devices like those shown at 25 and 27 as well as with a variety of other types of devices or systems capable of data communications through various interconnected networks. The mobile stations 13a and 13 of users of the shopping service also can receive and execute applications written in various programming languages.

Mobile stations 13 can take the form of portable handsets, smart-phones or personal digital assistants, although they may be implemented in other form factors. Program applications, including an application to assist in the shopping service and/or any an application purchased via the on-line shopping service can be configured to execute on many different types of mobile stations 13. For example, a mobile station application can be written to execute on a binary runtime environment for mobile (BREW-based) mobile station, a Windows Mobile based mobile station, Android, I-Phone, Java Mobile, or RIM based mobile station such as a BlackBerry or the like. Some of these types of devices can employ a multi-tasking operating system.

The mobile communication network 10 can be implemented by a number of interconnected networks. Hence, the overall network 10 may include a number of radio access networks (RANs), as well as regional ground networks interconnecting a number of RANs and a wide area network (WAN) interconnecting the regional ground networks to core network elements. A regional portion of the network 15, such as the network serving mobile stations 13, can include one or more RANs and a regional circuit and/or packet switched network and associated signaling network facilities.

Physical elements of a RAN operated by one of the mobile service providers or carriers include a number of base stations represented in the example by the base stations (BSs) 17. Although not separately shown, such a base station 17 can include a base transceiver system (BTS), which can communicate via an antennae system at the site of base station and over the airlink with one or more of the mobile stations, when the mobile stations are within range. Each base station can include a BTS coupled to several antennae mounted on a radio tower within a coverage area often referred to as a “cell.” The BTS is the part of the radio network that sends and receives RF signals to/from the mobile stations such as 13a and 13b that are served by the base station 17.

The radio access networks can also include a traffic network represented inside the cloud 15 over mobile network 15, which carries the user communications and data for the mobile stations between the base stations 17 and other elements with or through which the mobile stations communicate. The network can also include other elements that support functionality other than voice and data communication services, such as text and multimedia messaging services. Specific elements of the network 15 for carrying the voice and data traffic and for controlling various aspects of the calls or data sessions through the network 15 are omitted here form simplicity. It will be understood that the various network elements can communicate with each other and other aspects of the mobile communications network 10 and other networks (e.g., the public switched telephone network (PSTN) and the Internet) either directly or indirectly.

The carrier will also operate a number of systems that provide ancillary functions in support of the communications services and/or application services provided through the network 10, and those elements communicate with other nodes or elements of the network 10 via one or more private IP type packet data networks 29 (sometimes referred to as an Intranet). Generally, such systems that systems that provide ancillary functions are part of or connected for communication via the private network 29. A person skilled in the art, however, would recognize that systems outside of the private network could serve the same functions as well. Examples of such systems, in this case operated by the network service provider as part of the overall network 10, which communicate through the intranet type network 29, include one or more application servers 31 and a related authentication server 33 for the application service of server 31.

A mobile station 13 communicates over the air with a base station 17 and through the traffic network 15 for various voice and data communications, e.g. through the Internet 23 with a server 25 and/or with application servers 31. If the mobile service carrier offers the on-line shopping service, the service may be hosted on a carrier operated application server 31, for communication via the networks 15 and 29. Alternatively, the on-line shopping service may be provided by a separate entity (alone or through agreements with the carrier), in which case, the service may be hosted on an application server such as server 25 connected for communication via the networks 15 and 23. Servers such as 25 and 31 may provide any of a variety of common application or service functions in support of or in addition to an application program running on the mobile station 13. However, for purposes of further discussion, we will focus on functions thereof in support of the on-line mobile shopping service. For a given service, including the on-line shopping service, an application program within the mobile station may be considered as a ‘client’ and the relevant application programming at 25 or 31 may be considered as the ‘server’ application for the particular service.

To insure that the application service offered by server 31 is available to only authorized devices/users, the provider of the application service also deploys an authentication server 33. The authentication server 33 could be a separate physical server as shown, or the authentication server 33 could be implemented as another program module running on the same hardware platform as the server application 31. Essentially, when the application server (server 31 in our example) receives a service request from a client application on a mobile station 13a or 13b, the server application provides appropriate information to the authentication server 33 to allow server application 33 to authenticate the mobile station. Upon successful authentication, the server 33 informs the application server 31, which in turn provides access to the service via data communication through the various communication elements (e.g. 29, 15 and 17) of the network 10. A similar authentication function may be provided for shopping service(s) offered via the server 25 on the public Internet 25, either by the server 33 if there is an appropriate arrangement between the carrier and the operator of server 24, by a program on the server 25 or via a separate authentication server (not shown) connected to the Internet 23.

The presentation of shopping related information and the associated receipt and processing of user inputs related to shopping will be implemented by execution of client application programming on the user's mobile station. The client application allows the mobile station to obtain and incorporate components into the various presentations to the user from a server via network communication. The client application programming could be a general purpose browser application, in which case the programming would cause the mobile station to query a web site or other server for appropriate information in response to each user input and then receive the pages or other media content from a server in response to the queries, for presentation to the user. Browser programming of this type can present sophisticated animation, audio and video content as part of the enhanced shopping presentation, either in catalog or virtual mall presentation formats.

For purposes of the illustrated example, however, we will assume that each mobile station 13a, 13b runs a special purpose application to support the shopping related functions discussed here. The application would control the form or style of the various presentations. Some of the requisite content may be pre-stored as part of or in association with the application program, in the mobile station. However, somewhat like a browser, the shopping client application will still facilitate communications via the network with one or more servers, both to pull specific information and/or content to supplement various shopping presentations to the user and to implement the user's shopping transactions.

The browser or special purpose shopping programming would be written in a program language or to an application program interface (API) standard that is appropriate for the user's particular mobile station. For example, the application can be written to execute on a binary runtime environment for mobile (BREW) type API, in a Windows Mobile operating system, Android operating system, an I-Phone operating system, via Java Mobile, or for the operating system of a particular BlackBerry device.

The enhanced on-line shopping service under consideration here may be delivered to touch screen type mobile stations as well as to non-touch type mobile stations. Hence, our simple example shows the mobile station (MS) 13a as a non-touch type mobile station and shows the mobile station (MS) 13b as a touch screen type mobile station. Implementation of the on-line shopping service will involve at least some execution of programming in the mobile stations as well as implementation of user input/output functions and data communications through the network 15, to and from the mobile stations.

Those skilled in the art presumably are familiar with the structure, programming and operations of various types of mobile stations. However, for completeness, it may be useful to briefly consider the functional elements/aspects of two exemplary mobile stations 13a and 13b, at a high-level.

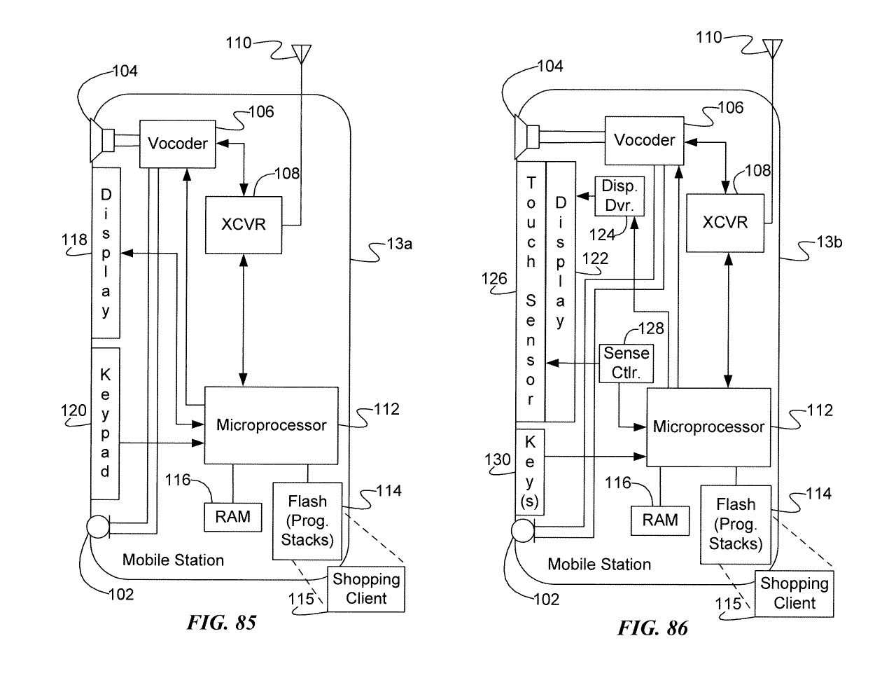

For purposes of such discussion, FIG. 85 provides a block diagram illustration of an exemplary non-touch type mobile station 13a. Although the mobile station 13a may be a smart-phone or may be incorporated into another device, such as a personal digital assistant (PDA) or the like, for discussion purposes, the illustration shows the mobile station 13a in the form of a handset. The handset embodiment of the mobile station 13a functions as a normal digital wireless telephone station. For that function, the station 13a includes a microphone 102 for audio signal input and a speaker 104 for audio signal output. The microphone 102 and speaker 104 connect to voice coding and decoding circuitry (vocoder) 106. For a voice telephone call, for example, the vocoder 106 provides two-way conversion between analog audio signals representing speech or other audio and digital samples at a compressed bit rate compatible with the digital protocol of wireless telephone network communications or voice over packet (Internet Protocol) communications.

For digital wireless communications, the handset 13a also includes at least one digital transceiver (XCVR) 108. Today, the handset 13a would be configured for digital wireless communications using one or more of the common network technology types. The concepts discussed here encompass embodiments of the mobile station 13a utilizing any digital transceivers that conform to current or future developed digital wireless communication standards. The mobile station 13a may also be capable of analog operation via a legacy network technology.

The transceiver 108 provides two-way wireless communication of information, such as vocoded speech samples and/or digital information, in accordance with the technology of the network 15. The transceiver 108 also sends and receives a variety of signaling messages in support of the various voice and data services provided via the mobile station 13a and the communication network. Each transceiver 108 connects through RF send and receive amplifiers (not separately shown) to an antenna 110. The transceiver may also support various types of mobile messaging services, such as short message service (SMS), enhanced messaging service (EMS) and/or multimedia messaging service (MMS).

The mobile station 13a includes a display 118, for displaying messages, menus or the like, call related information dialed by the user, calling party numbers, etc., including catalog pages and virtual three-dimensional views of the on-line shopping mall. A keypad 120 enables dialing digits for voice and/or data calls as well as generating selection inputs, for example, as may be keyed-in by the user based on a displayed menu or as a cursor control and selection of a highlighted item on a displayed screen. The display 118 and keypad 120 are the physical elements providing a textual or graphical user interface. Various combinations of the keypad 120, display 118, microphone 102 and speaker 104 may be used as the physical input/output elements of the graphical user interface (GUI), for multimedia (e.g., audio and/or video) communications. Of course other user interface elements may be used, such as a trackball, as in some types of PDAs or smart phones.

In addition to normal telephone and data communication related input/output, such as message input and message display functions, the user interface elements also may be used for display of menus and other information to the user and user input of selections. For purposes of a shopping example, the user interface elements of the mobile station 13a provide displayed information to the user and receive appropriate user inputs with regard to the enhanced shopping experience for the non-touch device as illustrated to the left side in most of the earlier drawing figures.

A microprocessor 112 serves as a programmable controller for the mobile station 13a, in that it controls all operations of the mobile station 13a in accord with programming that it executes, for all normal operations, and for operations involved in the on-line shopping procedure under consideration here. In the example, the mobile station 13a includes flash type program memory 114, for storage of various “software” or “firmware” program routines and mobile configuration settings, such as mobile directory number (MDN) and/or mobile identification number (MIN), etc. For purposes of the present discussion of the on-line shopping experience, the programming in memory 114 includes the shopping client program 115 and any data (e.g. page templates) for the various page presentations. The mobile station 13a may also include a non-volatile random access memory (RAM) 116 for a working data processing memory. Of course, other storage devices or configurations may be added to or substituted for those in the example. In a present implementation, the flash type program memory 114 stores firmware, such as a boot routine, device driver software, an operating system, call processing software and vocoder control software, and any of a wide variety of other applications, such as client browser software and/or a shopping service application. If a user purchases an application via the shopping service, the flash memory 114 may also receive and store the purchased application program for future use. The memories 114, 116 also store various data, such as telephone numbers and server addresses, downloaded data such as multimedia content, and various data input by the user. As noted earlier, the memory 114 stores the shopping client program 115 and any associated templates or other data for implementing the on-line shopping experience. Programming stored in the flash type program memory 114 is loaded into and executed by the microprocessor 112, directly or via the RAM 116.

As outlined above, the mobile station 13a includes a processor, and programming stored in the flash memory 114 configures the processor so that the mobile station is capable of performing various desired functions, including in this case the functions involved in the technique for providing the enhanced on-line shopping experience. The example of FIG. 85 was a non-touch type mobile station, however, the enhanced on-line shopping experience may also be offered to a user via a touch screen type mobile station.

For purposes of discussion, FIG. 86 provides a block diagram illustration of an exemplary touch screen type mobile station 13b. Although possibly configured somewhat differently, at least logically, a number of the elements of the exemplary touch screen type mobile station 13b are similar to the elements of mobile station 13a, and are identified by like reference numbers in FIG. 86. For example, the touch screen type mobile station 13b includes a microphone 102, speaker 104 and vocoder 106, for audio input and output functions, much like in the earlier example. The mobile station 13b also includes at least one digital transceiver (XCVR) 108, for digital wireless communications, although the handset 13b may include an additional digital or analog transceiver. The concepts discussed here encompass embodiments of the mobile station 13b utilizing any digital transceivers that conform to current or future developed digital wireless communication standards. As in the station 13a, the transceiver 108 provides two-way wireless communication of information, such as vocoded speech samples and/or digital information for messaging and other data services, in accordance with the technology of the network 15. The transceiver 108 also sends and receives a variety of signaling messages in support of the various voice and data services provided via the mobile station 13b and the communication network. Each transceiver 108 connects through RF send and receive amplifiers (not separately shown) to an antenna 110.

As in the example of station 13a, a microprocessor 112 serves as a programmable controller for the mobile station 13b, in that it controls all operations of the mobile station 13b in accord with programming that it executes, for all normal operations, and for operations involved in the on-line shopping procedure under consideration here. In the example, the mobile station 13b includes flash type program memory 114, for storage of various program routines and mobile configuration settings. The mobile station 13b may also include a non-volatile random access memory (RAM) 116 for a working data processing memory. Of course, other storage devices or configurations may be added to or substituted for those in the example. Hence, as outlined above, the mobile station 13b includes a processor, and programming stored in the flash memory 114 configures the processor so that the mobile station is capable of performing various desired functions, including in this case the functions involved in the technique for providing on-line shopping.

In the example of FIG. 85, the user interface elements included a display and a keypad. Some touch screen devices include full keyboards. In our touch screen example of FIG. 86, the mobile station 13b may have one or a limited number of keys 130, but for most purposes, the user interface functions of the display and keypad are replaced by a touch screen display arrangement. At a high level, a touch screen display is a device that displays information to a user and can detect occurrence and location of a touch on the area of the display. The touch may be an actual touch of the display device with a finger, stylus or other object, although at least some touch screens can also sense when the object is in close proximity to the screen. Use of a touch screen display as part of the user interface enables a user to interact directly with the information presented on the display than when using a mouse or the like to select information from a display.

Hence, the exemplary mobile station 13b includes a display 122, which the microprocessor 112 controls via a display driver 124, to present visible outputs to the device user. The mobile station 13b also includes a touch/position sensor 126. The sensor 126 is relatively transparent, so that the user may view the information presented on the display 122 through the sensor 126. A sense circuit 128 senses signals from elements of the touch/position sensor 126 and detects occurrence and sufficient information about the touch for the sensor the microprocessor to determine position of each touch of the screen formed by the display 122 and sensor 126. Via the information from the touch sense circuit 128, the microprocessor 112 can correlate position of a touch to the information currently displayed via the display 122, to determine the nature of user input via the screen. The processing may detect a touch at a particular position related to a displayed item of information. The processing may also detect multiple concurrent touches, and many devices today, the processing may also track position of a moving touch to determine a gesture of a user touch input such as an expanding movement by two fingers or a contracting motion of two fingers while contacting the touch screen display.

The display 122 and touch sensor 126 (and possibly one or more keys 130, if included) are the physical elements providing the textual and graphical user interface for the mobile station 13b. The microphone 102 and speaker 104 may be used as additional user interface elements, for audio input and output, including with respect to some shopping related functions.

The structure and operation of the mobile stations 13a and 13b, as outlined above, were described to by way of example, only.

With that description of the network, servers and mobile devices that may be used to implement the on-line shopping experience, we will now return to FIGS. 1 to 83, to discuss various aspects of the enhanced on-line mobile shopping experience in greater detail.

FIG. 1 depicts an example of a home screen, such as may be provided by an original equipment manufacturer (OEM) of a touch screen type smart mobile station. The user operates the mobile station by touching the screen at a location corresponding to displayed information. The mobile station may interpret a touch at a location as a selection input, for example, to select and activate a function corresponding to an icon located at the touched position on the screen. The mobile station may also interpret a moving touch, such as movement of the touching finger across the screen, as a gesture to provide alternative types of inputs.

In the example of FIG. 1, the home screen includes a selected background or ‘wall paper’ and a number of logos for functions of the device and/or services offered by the network service provider. The exemplary home screen includes a tool bar near the bottom, containing icons for a number of common functions, such as messaging, recent calls, contacts, etc. The user might select a group of functions associated with one of the icons by touching the one icon on the tool bar portion of the screen. The exemplary home screen also includes a tab arrow on the right hand side for turning the page to a main menu (FIG. 2). The user might input a selection to go to the next page, in this case the main menu, by touching the screen in the vicinity of the tab and while still touching the screen moving the touching finger to the left. As the finger moves, the device would display a page turning transition from the home screen to the main menu screen.

The mobile station may come with a home screen that includes one or more icons in the main section of the screen; or the user may be able to configure the mobile station to add icons to the home screen, much like adding icons to the desktop of a personal computer (PC). Either because configured by the user or added by agreement between the OEM and the service provider, the home screen in the example of FIG. 1 also includes an icon for the on-line shopping service, represented here by a down arrow in a circle. FIG. 2 depicts the main menu for the mobile station, including icons for a number of functional groupings relating to various types of operations that may be implemented by the mobile station. The main menu also includes a shopping icon.

Various icons, menus, images and other information are shown in FIGS. 1-83 by way of examples of user selectable objects, only. The shopping icon shown in FIGS. 1 and 2 takes the form of a shaded circle with a downward pointing arrow. Those skilled in the art will appreciate that any of a variety of other forms of an icon could be adopted as the icon for the shopping functions(s) offered by a particular mobile wireless communication service provider.

From either the home screen or the main menu, the user can touch the region of the displayed shopping icon to select the on-line shopping. In this first example, the mobile station detects that touch and transitions the display to an initial shopping page. FIG. 3 shows the touch screen mobile station, displaying the initial shopping page, on the right side of that drawing. The left side of the drawing shows a similar display as might be provided on a non-touch mobile station. Although not shown in FIGS. 1 and 2, the non-touch type mobile station would provide an initial screen or home page and a main menu and allow navigation through those screens to the initial shopping page display of FIG. 3 using cursor control and selection elements (e.g. right/left/up/down keys and an OK or Enter key). Other user inputs may be provided to allow navigation on respective types of mobile station to the initial shopping page.

In either case, the initial shopping page like either of those shown in FIG. 3 offers two types of shopping, in our example, catalog browsing for content available for purchase and download to mobile stations and a virtual mall. Each available type of shopping is displayed as a user selectable object. Here, the content available for purchase and download to mobile stations is exemplified by mobile station applications software, and the catalog for browsing and purchasing such applications is indicated by a button type icon object on the screen labeled APPS. The more general type of shopping through a virtual mall type user experience is indicated by a button type icon object on the screen labeled XyZ Mall. The shopping services under consideration are those offered by the particular mobile wireless communication service provider, and the icon for the shopping mall is branded with the XyZ logo for that service provider.

The tool bar that includes the APPS button and the Mall button provides prominent placement of application shopping and virtual mall features indicated by those buttons.

The tool bar that includes the APPS button and the Mall button also offers a ‘deals’ tab which may provide a link to a pull-down menu of applications or other services/merchandise that the service provider is offering at discount rates. The lower portion of the initial shopping page shows user selectable objects for applications that the user has previously purchased and downloaded to the particular mobile device. FIG. 3 shows the objects for previously purchased items as a grid of icons, whereas FIG. 4 shows the information in a list format comprising bars for the purchased items. The grid or list of downloaded applications, if longer than can be displayed on the allotted area of the screen, may be scrolled up or down to show objects for other downloaded applications. In the grid of FIG. 3, this field of the displayed page also includes a favorites icon, in the form of a folder icon, for a link to a folder listing various shopping related pages that the user has previously identified as favorites for return browsing visits.

At least for the larger touch screen version, the tool bar that includes the APPS button and the Mall button may offer some other related functionalities. In the example, the shopping tool bar offers an Options icon (shown above the upper right corner of the Mall button). Touch selection of the Options icon on the screen may cause the mobile station to offer the user a variety of related optional functions, such as Wishlists & Profiles; Manage Apps for example to Erase, Rate & Review, Move or Lock/Unlock a specific application, etc.; Tell a Friend about an application; Send an application as Gift; Sort applications By parameters such as My Rating, Alphabetic, Date, Properties, Purchase History, etc.; and Help. On the non-touch mobile station, the screen displays ‘Options’ in a position near the lower right corner, which would associate the ‘Options’ with a soft key on the upper right portion of the keypad (not visible in the illustration). Operation of the soft key would cause the non-touch mobile station to display a similar list of options for the user, for selection via cursor control and ‘OK’ input or via operation of specific keys on the keypad.

The examples of FIG. 3 show the downloaded applications in the form of a grid. FIG. 4 shows an alternative arrangement of the application icons/data in the form of a list. The programming to implement the shopping related functions and displays may provide one presentation or the other, or the programming may allow the user or the service provider to configure the device to present the application information in the grid view (FIG. 3) or the list view (FIG. 4). In either case, the information presented, and the available shopping related functions are essentially the same.

At this point in our example, we will assume that the user wants to browse the application catalog to buy an application for downloading to the user's mobile station. For this example, we will also assume that the user's device is configured for the list type view. Hence, from either type of device showing a main shopping page like in FIG. 4, the user selects the APPS shopping bar (touches the APPS bar on the touch screen version or moves the cursor and enters a selection of the APPS bar from the non-touch screen version of the station). In response, the mobile station will now display a top-level list of application categories, like either of the respective lists on the exemplary page displays of FIG. 5. Transition to the top-level application page display may involve communication with the server to obtain some or all of the information for the page.

In the example, the list of top-level content categories on the page may be longer than the particular mobile station can display at one time, therefore, the mobile station offers the user the ability to scroll up or down the list, by use of cursor or direction keys on the non-touch station or by an appropriate touch or touch gesture on the touch screen version of the mobile station. In the example, the list includes button or bar type categories for Play it, Personalize, Explore and Style. Other top-level content categories would be displayed by scrolling down the displayed category list. Each category bar includes a corresponding icon and a descriptive text label.

The list display also includes a tool bar. In the non-touch example, the tool bar is above the list, whereas in the touch screen example, the tool bar is below the list. The tool bar includes buttons for various functions, like What's New and the shopping Cart for items selected for purchase. In the examples, the number of functions offered on the tool bar exceeds the number that can be readily shown on the display screens of the particular stations, therefore the stations offer the user the ability to scroll the tool bars right or left to see other function buttons associated with the tool bar.

Both versions also offer a search function and options. On the non-touch mobile station, the Search and Options functions are displayed at the bottom of the screen. On the touch screen mobile station, the Options function icon is displayed on the APPS bar at the top of the screen to the right of the APPS label, and a Search bar is shown just below the APPS bar for quick access. From the APPS list screen, the options include a cart for information about items the user has selected and thereby ‘placed’ in the user's shopping cart for purchase, wishlist and profile options, and a help option.

Assume now that the user of either type of mobile station selects a top-level content category from the respective list display of FIG. 5. By way of a specific example, we will consider a selection of the ‘Play it’ category. Hence, from either type of device showing a shopping page like one of those in FIG. 5, the user selects the ‘Play it’ bar (touches the ‘Play it’ bar on the touch screen version or moves the cursor to highlight the ‘Play it’ bar and presses the softkey ‘OK’ function from the non-touch screen version of the station). In response to such a selection, each mobile station will navigate to a list display of intermediate categories (sub-categories under the selected top-level content category) in the applications catalog, such as shown by way of example in FIG. 6. Navigation to display the intermediate category page may involve mobile station communication with the server to obtain some or all of the information for the page.

As shown, each type of mobile station will show the title of the top-level for the selected category (in this case the ‘Play it’ top-level category) in a bar at or near the top of the display screen. Also, each type of mobile station will offer the search function and options, like in the top level category page display of FIG. 5. Each sub-category bar includes a corresponding icon and a descriptive text label.

In the example of FIG. 6, the intermediate or sub-categories under ‘Play it’ relate to game applications; and the list on the intermediate category page includes button or bar type objects for sub-categories for Action, Board, Classic, Play and Win, and Puzzle type games. If the list is longer than the mobile station can display at one time, some bars for the sub-categories may not be shown, but the mobile station offers the ability to scroll up or down to see the bars representing the additional sub-categories.

In the intermediate category display screen (FIG. 6), the sub-category bars do not extend as far across the lateral width of the display screen as did the category bars in the top level category page of FIG. 5. In each intermediate category display screen of FIG. 6, a portion of the screen is reserved for icons for the higher level categories, to make it easy for the user to navigate to another of the top-level categories of the catalog. In the examples, each station displays the icons for the top-level categories to the left of the intermediate category bars. However, the icons for the top-level categories could be at other locations on the display in either or both of the touch and non-touch implementations. The higher level category icon for the selected category, the ‘Play it’ icon in our example, is highlighted in bright color as are the bar at the top and the sub-category bars. The icons for the other higher level categories are displayed in a darkened state. When a sub-category bar is selected, items available from the catalog sub-category are displayed brightly, but with the other sub-category bars displayed in a darkened state. This unique nested navigation allows for increased discoverability and ease of use via the ability to return backwards from one screen to a screen that came earlier in the menu structure without complications.

The examples show one intermediate level category page for the ‘Play it’ applications. Depending on the numbers and classifications of items available under any given top-level content category for the catalog, there may be additional intermediate level navigation pages to further levels of sub-categories. Any such additional intermediate level pages may be formatted in a manner similar to the examples of FIG. 6, although they would provide different icons and text on the bars to identify the relevant intermediate categories for the items available in the catalog.

Assume now that the user of either type of mobile station selects a sub-category from the respective intermediate list display of FIG. 6. By way of a specific example, we will consider a selection of the ‘Classic’ sub-category. Hence, from either type of device showing the shopping page like in FIG. 6, the user selects the ‘Classic’ bar (touches the ‘Classic’ bar on the sub-category screen version or moves the cursor and enters a selection of the ‘Classic’ bar and presses the OK function key from the non-touch screen version of the station), as an input to navigate further down into the catalog. In response to such a selection, each mobile station may perform communications with the server and will navigate to a page display of available items from the catalog, classified in the selected sub-category, such in the ‘Classic’ sub-category as shown by way of example in FIG. 7.

The item display could be a list type display, but in the example, the display is a grid arrangement of icons. Below the icon for each respective application, the screen shows text identifying the application as well as the price for purchasing the application. As shown, each type of mobile station will show the title of the selected sub-category (in this case Classic) at or near the top of the display screen. Also, each type of mobile station will offer the options, like in the higher level pages of FIGS. 5 and 6. At this level, the options may include the shopping cart, wishlists and profiles, help and several options to sort the displayed icons. For example, this level may offer the user options to sort the icons for the items by alphabetical order, price, or rating. If the user selects such a sort option, the mobile station will reorganize the grid display accordingly. Although included in the options menu, the larger touch screen version may also show buttons for the shopping cart and wishlist, in the example, near the bottom of the screen. As in the earlier screens, Options are provided at the bottom of the screen in association with a soft key, on the non-touch mobile station. The options available via selection of the Options may be similar to those offered on the Options menu on the touch screen device. The non-touch screen device also may offer the Add to Cart functionality near the lower left corner of the display, for association with a soft key (not shown in FIG. 7) on the upper left portion of the keypad.

In the example, the number of items in the sub-category, available for display on the page, may be longer than the particular mobile station can display at one time. Hence, the mobile station offers the user the ability to scroll down the icon grid, by use of cursor or direction keys on the non-touch mobile station or by an appropriate touch or touch gesture on the touch screen version of the mobile station.

In the specific content item display page, such as that of FIG. 7, the grid of icons does not extend across the lateral width of the display screen (compare to the main menu of FIG. 2 and the high level grid view of FIG. 3). Instead, the specific content item display page of FIG. 7 includes a portion for icons for the intermediate level sub-categories, to make it easy for the user to navigate to any other of the next higher level categories of the catalog. In the examples, each station displays the icons for the intermediate level categories to the left of the grid of application item icons. However, the icons for the categories of the preceding level could be at other locations on the display in either or both of the touch and non-touch implementations. The category icon for the selected category, the ‘Classic’ icon in our example, is highlighted in bright color as are the bar at the top and the icons for the specific content items available for purchase and download from the sub-category. The icons for the other categories are displayed in a darkened state.

As shown and described, the exemplary item page for a selected sub-category shows icons, descriptive text and price for the items in the respective sub-category, in this case, the sub-category for Classic applications available for purchase and download to a user's mobile station. The prices in the example of FIG. 7 are those for an unlimited usage, although other pricing arrangements may be available for some or all of the items. From such a display screen, selection of an item in combination with selection of the Add to Cart function (either before or after selection of the item) will add the item to the user's shopping cart, at the displayed price and plan, for later purchase.

From the screen displaying available items of the selected sub-category, on either type of device, the user may select an icon object icon a specific content item of further interest (touches the icon for the content item in the sub-category in the touch screen version or moves the cursor to highlight the item icon on the screen and enters a selection of the item by operation of the OK input key from the non-touch screen version of the station). In response, the mobile station may communicate with the server and obtain information to enable display of details regarding the selected item, in the example, about the selected classic application. Details may include a preview, review, price, etc. Examples of touch and non-touch screen versions of a detail information screen display page, for one selected classic application, appear in FIG. 8.

By way of example, each type of item detail screen display page (FIG. 8) includes a label for the selected content item, in this case, near the top of the screen. The item display may also include at least a relevant image. Display of the page related to a specific item selected from the content may include an animated preview. The image and/or any software for the animation, e.g. instructions and video and/or audio content, may be sent from the shopping application server to the mobile station in response to the selection of the item from the previous display screen of FIG. 7. In the case where an item has an animation, when the item is selected, an automatic preview is displayed on the screen, e.g. for promotional purposes. The video content for the preview may be sent from the shopping application server to the mobile station.

Both versions also offer an Options function similar to those of the earlier pages. The touch screen version shows the Options menu near the upper right corner of the page, whereas the non-touch screen version shows the Options in the lower right corner. The Add to Cart function is shown in the lower left corner of the non-touch screen version of this type of page, in a manner similar to the specific content item display page of FIG. 7.

In the example of FIG. 8, the particular item selected at this stage of browsing through the catalog has multiple purchase options, two of which are shown by way of example. The examples include a subscription type of purchase and a one-time unlimited usage type of purchase. The offer price varies amongst the different types of purchase agreements. The offer price may also vary between device types of mobile stations, as shown by the difference for the unlimited price agreement as between the touch and non-touch screen versions in the example, e.g. because the software for one type of station may be more complex/expensive than software for the same application to run on a different type of mobile station. Each type of item detail page shows each of the pricing options as a respective user selectable button.

Like at least some of the earlier pages, the detail information page for a selected item will often include more information or functions than can readily be shown on the screen of the mobile station at any one time, therefore the page is scrollable. Hence, at this stage in our example, each type of mobile station will offer the user the ability to scroll the page display for the selected catalog content item to see additional detail information related to that item. The station displays could be scrollable up or in either sideways direction, however, in the example of FIG. 8, the stations allow the user to scroll the page down to see additional details such as shown by way of example in FIG. 9.

In the example of FIG. 9, the additional details include some descriptive text, such as one of the available reviews for the selected content item, as well as buttons or display bars for user selection of additional related functions. Both types of display screens offer several function selection bars. In the example, these bars include a bar for Reviews and Ratings, a bar for Friends Who Want This Item (have added it to their wishlist) and a bar for Recommendations of other similar items. Both versions still offer the Options functions similar to those of the earlier pages. The touch screen version still shows the Options menu near the upper right corner of the page, whereas the non-touch screen version shows the Options in the lower right corner. The Add to Cart function is shown in the lower left corner of the non-touch screen version of this type of page.

In the example, the version of the shopping service for the touch screen type mobile station causes that type of station to produce a display that further includes a number of buttons on the detail page. In the example, these additional function buttons include an Add to Cart button, an Add to Wishlist button, a Send as Gift button and a Tell a Friend button. Similar functionality may be available on the non-touch mobile station via the Options menu.

At any given stage in the process, selection of the Add to Cart function adds the selected content item to a list (the cart) of items selected for a later combined purchase at ‘checkout’ when the user is finished browsing through the shopping experience. The Add to Wishlist function allows the user to add the selected content item to a list of items that the user would like to have, for use in future purchasing decisions or for sharing with other users who might purchase an item as a gift for this user. The Send as Gift function allows the user to select and purchase the content item for transmission to another user, and the Tell a Friend function allows the user to send a message about this item to another user.

On either type station, the user may select amongst the bars, buttons and/or options on the different display versions to see additional information related to any selected one of the functions, from the respective display of FIG. 9.

For example, selection of one of the several function selection bars from a display of FIG. 9 will cause the mobile station to expand the display of information under the selected function. FIG. 10 shows an expanded view of the reviews and ratings and might be shown upon user selection of the Reviews and Ratings bar from a detail display like either of those in FIG. 9. The expanded view in our example offers the user two or three additional reviews of the content item selected to this point in the browsing process as well as a button to select to view all such reviews and ratings. The View All button is selected by touch or cursor control, as in the earlier screen examples. In the example of FIG. 10, the next available function selection bar is shown below the expanded view associated with the currently selected function. The mobile station also offers the capability to scroll, in this example to scroll down, to view and select the other function selection bars.

FIG. 11 shows the display screens for the two types of mobile stations as they might appear after the users have scrolled down and selected both of the other function selection bars for the friends who want this item and the recommendations of related items. Upon selection of either one or both of the additional function selection bars, the mobile station will provide an expanded view of the associated information about the content item currently under consideration by the user. In the example of FIG. 11, the expanded view under the Friends Who Want This bar shows two friends who have this item on their wishlist as indications to the shopping application server that they would like to have this item. Selection of either friend would cause the mobile station to offer options to send the item to either one or both friends. In the example, the friends who may be chosen to receive the item as a gift purchase are shown in a list, although icons, images or other display options are possible. In the example of FIG. 11, the expanded view under the recommendations bar shows selectable objects for other related content items. In the example, the mobile station shows three recommendations from the server, although the display may show fewer or more recommended items in a list or other format.

As noted in the discussion of FIG. 8, each type of item detail page shows each of the price offers as a respective user selectable button. Either when the user initially browses to that item display page, or by scrolling the page back to the top, the user can see the pricing/purchase options for the item, and if the user intends to buy the item, the user may select one of the pricing/purchase options. On the touch screen version, the user desiring to buy the application selects one of the price offers and touches the button for that type of purchase agreement on the touch screen. On the non-touch screen version, the user moves the cursor to highlight the desired pricing/purchase option for the item and enters a selection of the desired pricing/purchase agreement by pressing the key associated with the ‘OK’ function, to enter the desired purchase selection input. Selection of an offered purchase price in this manner causes the mobile station to offer a confirmation display such as one of those shown in FIG. 12.

In FIG. 12, either version of the mobile station will display a dialog box for purchase confirmation, in the example, with some explanatory text and with a button for acceptance of the purchase terms (e.g. to Accept the offered purchase price and related transaction terms). The user can complete the transaction to purchase the selected content item for downloading to the user's mobile station by selectively actuating the displayed Accept bottom on the respective mobile station. On the touch screen version, the user desiring to complete the transaction merely touches the Accept button on the touch screen. On the non-touch screen version, the user may press the key associated with the ‘OK’ function, to indicate acceptance of the purchase transaction for the selected content item.

In our example, the purchased content item was an application for downloading into the user's mobile station. Actuation of the Accept function causes the mobile station to send the relevant information to the shopping application server. The server initiates the appropriate accounting to charge the purchase price to the user's account, which may be on their mobile communication service bill, on a regular account with a third party shopping service provider or on a credit/debit card account. The shopping application server will also initiate the appropriate process steps to download the purchased content item to the user's mobile station. The server may store the content, in which case, it would transmit the purchased item through the network in packets addressed to the user's mobile station. Alternatively, the shopping application server may cause another server system to initiate the download communication. In either case, the client software on the mobile station receives and stores the application in memory within the device to make the application or other type of purchased content item available for future use on the mobile station.

While the transaction is being completed and downloading is ongoing, the mobile station changes its display back to an updated form of the initial shopping page. The page is similar to that shown in FIG. 3 and will allow the user to continue shopping for other content available from the catalog. However, as shown in FIG. 13, the lower portion of the initial shopping page showing the applications that the user has purchased and downloaded to the particular mobile device is updated to include an icon for the newly purchased application. This shows the user where the application will reside in future after downloading is completed. While the downloading is ongoing in the background, however, the icon may be altered, e.g. by an animation to show the installation is in progress. The mobile station then would change the icon for the newly purchased content item to its regular state, similar to the other content items in the example but unique to the newly purchased application, when the downloading and installation procedures have been successfully completed.

In the example of FIGS. 3 to 13, the user navigated through various levels of the catalog hierarchy of the on-line store to purchase a single application from the catalog for downloading to the user's mobile station. However, the on-line shopping service also offers a shopping cart functionality to allow a user to shop for and select several content items and then purchase all the selected items in one financial transaction at check out. An example of the flow of such a shopping experience and purchase will be discussed now with respect to FIGS. 14 to 22, where the user of the mobile station browses the application catalog portion of the on-line shopping service and purchases a number of applications from the catalog, in one purchase transaction. The purchased applications are then downloaded to the user's mobile station at the same time, in this example.

The initial navigation to enter the catalog and browse down to a sub-category display page may be similar to that in the earlier example. In the example of FIG. 14, the user has operated the touch screen type mobile station to navigate to the ‘Classic’ sub-category page in a manner similar to that to reach the page as shown in FIG. 7. The items and functions available on the page are the same as described above with respect to FIG. 7. In the flow in this second example, at FIG. 14, the user touches or presses on the icon that the user wants to add to the shopping cart for purchase, for a relatively long period of time, sufficient for the mobile station to distinguish this as a long touch gesture as opposed to a momentary touch at a position. Without lifting the finger from the screen, the user moves the touching finger across the screen to the ‘Cart’ icon, to drag the icon for the selected content item over to the Cart icon. An example of the drag gesture is illustrated in FIG. 15. During this operation, the mobile station moves the icon for the selected item along with the moving touch gesture and keeps the moving icon brightly lit in the display as a highlighted icon. However, the mobile station dims back on the brightness of the other icons on the displayed page. The highlighted/bright movement of the selected item icon together with the dimming of the other icons informs the user of the drag and drop mode, as the user drags the item and drops it in the shopping cart. The user can continue browsing the catalog and select other items for addition to the shopping cart, in a similar manner. When the user has selected all items of current interest during this session, or when the user wants to view the items in the cart, the touch screen device user merely taps on the Cart icon (FIG. 16). Although not shown in detail, the non-touch mobile station will allow the user to select and add items to the shopping cart and then view the items in the shopping cart.

FIG. 17 shows the screens for both types of mobile stations when the devices display the items in the user's shopping cart. The shopping cart display offers Options in a manner similar to earlier pages. The lower portion of the shopping cart screen shows the number of items selected for purchase. At this point in our exemplary process flow, the user has not yet selected an item for purchase from the list in the shopping cart. The touch screen version displays an Accept button, near the bottom in the example. The Accept function is shown in the lower left corner of the non-touch screen version of this type of page

In the example, the user has two items in the shopping cart, and the vendor offers at least two pricing plans for each selected content item. The display screen therefore shows the icon for each selected item and bars for each pricing option, in the example, one for an unlimited use one time purchase option and one for a monthly subscription. Prices for the various options may vary as between different content items and/or as between different types of mobile stations to which respective users' will download the content items.

From the shopping cart view of FIG. 15, the user can navigate to a detail display with respect to a content item by selecting the icon for any of the items in the shopping cart. On the touch screen type mobile station, the user touches the icon for the content item in the shopping cart display page, whereas on the non-touch screen version the user operates keys on the mobile station to move the cursor to highlight the item icon on the screen and enters a selection of the item by operation of the OK or Mark input key. In either case, in response to the icon selection, the mobile station will display details regarding the selected item, in the example, about the selected classic application. The mobile station may communicate with the server to obtain the appropriate detailed information, or the mobile station may have stored the detailed information during an earlier communication. Details may include a preview, review, etc. Examples of touch and non-touch screen versions of a detail screen display page, as displayed after such navigation from the shopping cart pages, appear in FIG. 18.

By way of example, each type of item detail screen display page (FIG. 18) includes a label for the selected content item, in this case, near the top of the screen. The item detail display may also include at least a relevant image. Display of the page related to a specific item selected from the content may include an animated preview. The image and/or any software for the animation, e.g. instructions and video and/or audio content, may be sent from the shopping application server to the mobile station in response to the selection of the item from the shopping cart display screen of FIG. 17, although it may be cached in memory if received earlier in the browsing through the catalog.

Like several of the earlier pages, the detail page for a selected item displayed after selection from the shopping cart page will often include more information or functions than can readily be shown on the screen of the mobile station at any one time, therefore the page is scrollable. Hence, at this stage in our example, each type of mobile station will offer the user the ability to scroll the page display for the selected catalog content item to see additional detail information related to that item. The station displays could be scrollable up or in either sideways direction, however, in the example of FIG. 18, the stations allow the user to scroll the page down to see additional details such as shown by way of example in FIG. 19.

In the example of FIG. 19, the additional details include some descriptive text, such as one of the available reviews for the selected content item, as well as one or more buttons or display bars for user selection of additional related functions. Both types of display screens offer several function selection bars, which may appear and activate further functions similar to the buttons discussed above relative to the detail page shown in FIGS. 8-11, although only the reviews and ratings bar is visible in the exemplary screen displays of FIG. 19.

Both mobile station versions also offer an Options function similar to those of the earlier pages. The touch screen version shows the Options menu near the upper right corner of the page, in the example, whereas the non-touch screen version shows the Options in the lower right corner in association with a soft key of the device keypad (not shown).

After reviewing the detailed information on the selected item, the user can activate the return to cart function shown on the respective detail screen for the content item. To return to the shopping cart page, the touch screen version shows an appropriate bar below the descriptive text in the scrolled down page (FIG. 19), which the user can select by touching the button on the display screen. A return to shopping cart function is shown in the lower left corner of the non-touch screen version (at both stages as shown in FIGS. 18 and 19), which can be selected by actuation of a soft key on the upper left corner of the key pad of the non-touch mobile station.

FIG. 20 again shows touch and non-touch examples of the shopping cart display screen. As noted in the discussion of FIG. 17, the shopping cart page on either device shows one or more pricing options for each item in the cart. The examples of FIGS. 17 and 20 show two pricing options for each of the two items selected at this stage of our catalog shopping example. The user selects an item for purchase by selecting the desired one of the purchasing options from the shopping cart screen (see e.g. FIG. 20). On the touch screen version, the user desiring to buy the application selects one of the pricing options and touches the button for that type of purchase agreement on the touch screen. On the non-touch screen version, the user moves the cursor to highlight the desired pricing/purchase option for the item and enters a selection of the desired pricing/purchase agreement by pressing the key associated with the ‘MARK’ function, to enter the desired purchase selection input. Selection of an offered purchase price in this manner causes the mobile station to add the item to the total number of items selected for purchase as displayed in a bar near the bottom of each of the screens in our examples and to add the price for the selected item and purchase option to a dollar amount shown in that bar. The total number of items and the total purchase amount is calculated on the fly as the user selects items for purchase from the shopping cart page. FIG. 20 shows the totals before a price/item selection, and FIG. 21 shows the totals after two selections. During this process, the bars for the selected price options may be shown in a different manner to show the user of the exact selections entered.

In this manner the user may select any number of items and associated offered purchase price terms from the items displayed via the shopping cart page. In our example, the user selects a purchase price for each of the two items added to the cart early in the shopping process.

As shown in FIGS. 17 and 20, before selection of an item and price for purchase, each mobile station will display an accept functionality, but in manner that shows that the function is inactive, e.g. as dim letters on the non-touch version or as a pale bar on the touch screen version. However, once the user has selected at least one item and associated purchase price, each type of mobile station will change the manner of displaying the accept function to indicate that the function is not active. As shown in FIG. 21, the non-touch version displays “Accept” as bright letters, and the touch screen version shows the Accept button as a full color button.

When the user has decided as to price terms for all of the items that the user wants to purchase during the current shopping session, the user activates the accept function. On the non-touch mobile station, the user activates the soft key (not shown) below Accept on the display screen. On the touch screen version, the user touches the Accept button on the display.

When the user accepts the content purchase to complete the transaction (FIG. 21), the mobile station communicates through the wireless network elements with the server(s) of the shopping service provider to complete the financial aspects of the transaction. When completed, the mobile station communicates with one or more servers to initiate the content download procedures outlined above to actually download the purchased content item or items. While the transaction is completed and downloading is ongoing, the mobile station changes its display back to an updated form of the initial shopping page. The page is similar to that shown in FIG. 3 and will allow the user to continue shopping for other content available from the catalog. However, as shown in FIG. 22, the lower portion of the initial shopping page showing the applications that the user has purchased and downloaded to the particular mobile device is updated to include an icon for each newly purchased application. Hence, in the example of FIG. 22, each type of device shows icons for the two newly purchased applications. This shows the user where each new application will reside in future after downloading is completed. While the downloading is ongoing in the background, however, each icon may be altered, e.g. by an animation to show the installation is in progress. The mobile station then would change each icon for a newly purchased content item to its regular state, similar to the other content items in the example but unique to the respective application, as the downloading and installation procedures for each respective new item is successfully completed.

As noted earlier, the initial shopping page of FIG. 3 or that of FIG. 4 offers two types of shopping, in our example, catalog browsing for content available for purchase and download to mobile stations and more general shopping via a virtual mall. Several examples of browsing through the application type catalog for purchase and downloading of one or more content items have been discussed with respect to FIGS. 5 to 22. Assume now that from an initial shopping page of FIG. 3 or of FIG. 4, the user selects the service provider's shopping mall. On the non-touch mobile station, the user moves the cursor to highlight the Mall button and presses the keypad button associated with the OK function. On the touch screen mobile station, the user touches the display screen at a location corresponding to the displayed shopping mall button. Upon selection of the shopping mall button from either type of device, the mobile station will transition to an initial entry display for the virtual mall. This transition may entail communication through the network with the shopping application server to obtain information for the virtual mall presentation.

FIGS. 23 to 30 show screens or pages at various stages of browsing through the virtual mall. At various points in the navigation flow, the mobile station may communicate with the server to obtain further information to continue the virtual navigation through the mall in response to user inputs. For ease of illustration, these drawings depict the mall as it might be shown on a touch screen type mobile station. Movement through the mall is responsive to sensing touch gestures on the screen of such a mobile station. A similar mobile station functionality would be available, although perhaps more limited in appearance and functionality, for the non-touch type mobile stations. Navigation through the virtual mall for the non-touch type mobile stations would be responsive to directional control on the keypad.

The Virtual Mall is an immersive shopping experience that mimics aspects of physical malls, with a streamlined, fun approach to discovering and buying physical and digital goods. Stores will provide access to interactive promotional content geared toward motivating purchases. The shopping service provider may operate virtual stores for different types of goods, but the shopping service may also offer portal type functions for other vendors with whom the on-line service provider has contracted to rent shop space in virtual mall.

The view presented may be a clear aisle type view, as if the user was looking into the mall through the display of the mobile station. The view can also be changed through user customizations via a configuration communication process with the shopping application server. These customizations allow for variations in physical indoor mall type, holiday season decorations, etc. These customizations could be purchased gaining additional revenue for the service provider. In the illustrated examples, the user has an avatar, and the view is from proximity to the avatar. The particular avatar may be selected and/or customized for each user, via an enrollment and/or configuration communication process with the shopping application server.

In the touch screen example, the user touches a finger to the display screen and moves the touching finger across the display to indicate a direction of movement through the mall. In response, the mobile station changes the position of the avatar within the virtual mall and thus the portion and perspective of the mall shown on the display of the touch screen mobile station. As the mobile station displays aspects of the virtual mall, it shows a bar branded and labeled as the service provider's mall, near the top of the screen in the examples. The bar may also offer other functions, such as an Options menu similar to that in the earlier catalog screens. FIGS. 23 and 24 show various sections or hallways of the mall, as the user virtually strolls through the mall, past store fronts of the virtual shops. When the user sees a shop of interest, the user may touch the screen of the mobile station to make a turning gesture toward the shop of interest. The mobile station may then show a virtual store front for the selected shop, like the example shown in FIG. 25.

The example of FIG. 25 represents a virtual game store of a particular vendor with whom the on-line shopping service provider has a contractual agreement to place the vendor's shop in the mall. The appearance of the store front may be designed by or for the vendor. In the game example, the games may be for downloading to the mobile station or the games may be games for other types of electronic devices. The implementation of the virtual mall may allow the user to navigate into and around in any of the virtual shops, to view virtual displays of various goods offered by the vendors/merchants.

During the shopping mall experience, the mobile station may allow the user to communicate with other parties. In the example of FIG. 26, the user exchanges instant messages with a friend to get a recommendation for a game that the user may be considering in the virtual game store.

The exemplary game store emphasizes graphical content to generate interest. Users can view application previews or interact with rich promotional experiences via the audiovisual capabilities of the mobile station and the digital communications of that station through the network with the shopping application server. FIGS. 26 to 30 are included as still image examples of animated displays that may be presented with respect to a product, in this case a game, that the user is experiencing via the virtual store in the mall. The animation and/or video displays may be accompanied by audio information to further enhance the user experience.

At one or more points in the animation, the presentation may offer the user with additional related selection opportunities, such as the buttons shown on the display in FIG. 29. FIG. 30 represents a related screen as may be shown in response to the user selection of one of the buttons from the screen of FIG. 29. Although not separately shown, when finished with the interactive screens for a particular product, the virtual mall presentation on the mobile station may display a detail screen analogous to that of FIGS. 8-11 with various other functionalities, including functionalities to purchase the item, add the item to a shopping cart, or navigate back to the store or to the mall corridor. The design of the item detail screen for the product in the virtual store, however, may have a look and feel that is different from that of the catalog items. The detail screen at this point in our example may be unique to the virtual mall or unique within the mall with respect to the particular virtual store.

The enhanced shopping experience may offer a variety of other shopping scenarios to users of the various mobile stations. FIGS. 31 and 32 show screens or pages allowing the user to view the special deals available via the on-line store. FIG. 31 again shows the initial shopping page. As noted in the discussion of FIG. 3, the tool bar that includes the APPS button and the Mall button also offers a ‘deals’ tab which may provide a link to a pull-down menu of applications or other services/merchandise that the on-line shopping service provider is offering at discount prices. On the touch screen version of the mobile station, the user desiring to see the deals currently offered by the on-line shopping service provider merely touches the Deals tab on the touch screen display. On the non-touch version of the mobile station, the user operates the cursor control to highlight the Deals bar and presses the key associated with the ‘OK’ function.

In either case, the mobile station may respond by showing a display screen like the respective one of the screens or pages shown by way of example in FIG. 32. This may involve a network communication with the server to obtain information on items in the deals menu. The mobile station will provide an expanded or overflow view of the deals bar or menu with icons and short text identifying one or more items that the provider is offering at a special price. If the number of deals exceeds the amount of information that the mobile station may display in the expanded view, the mobile station may offer the ability to scroll to display additional items. In the example of FIG. 32, the mobile stations offer side to side lateral scrolling, although the mobile stations may offer vertical scrolling to display other deal related items. The user interface (UI) offered by the deals display enables the user to browse directly to a detail screen or page, for example, similar to that of FIG. 8, by selection of the icon of any item displayed among the offered deals. However, a detail page reached from the deals menu would highlight the special price arrangement for the deal, although the page may offer alternative purchase price and/or terms.

On the touch screen version of the mobile station, the user desiring to see the details of an item from the deals currently offered by the shopping service provider merely touches the appropriate icon on the expanded Deals tab on the touch screen display. On the non-touch version of the mobile station, the user operates the cursor control to highlight the appropriate icon on the expanded Deals bar and presses the key associated with the ‘OK’ function. Responsive to such a user input, the mobile station displays the detailed information page for the selected item as discussed in earlier examples. Further information and purchase functions would be available on the detail page like in earlier examples. The detail page for the selected item would also offer add to card and/or purchase capabilities like in the earlier examples.

The deals in the example are for applications downloadable to the mobile station. However, the deals functionality may be applied to other types of downloadable content and/or to other types of goods offered by the catalog and/or in the virtual mall.

FIGS. 33 to 40 show screens or pages that may be presented in examples of several impulse buying scenarios, which enable direct navigation to detail pages for items that the shopping service provider wants to promote for impulse buying. The various impulse promotional functions may be triggered by a variety of different activities on the mobile station, for example, by each time that the user navigates to the main shopping page (see FIG. 3) or to the initial applications page (FIG. 4 or FIG. 5).

In a first example (FIGS. 33 and 34), the communication with the shopping application server and/or the client application running in the respective mobile station may generate a promotional animation super-imposed on any of main shopping screens. As shown by way of an example in FIG. 33, the illustrated promotional animation is a moving black bat surrounded by a white hallow effect, although a wide variety of other animations may be used to attract a user's attention to a promotion. Software or other information for implementing the animation may be received from the server with other information for the relevant shopping service page. On the touch screen version of the mobile station, the user desiring to see the details of a promotional offer represented by the animation merely touches the appropriate location on the screen where the animation is displayed. On the non-touch version of the mobile station, the center section of the bar at the bottom is labeled View, while the animation is displayed. The user desiring to see the details of a promotional offer represented by the animation presses the OK or other key temporarily associated with the View function.

Responsive to such a user input, the mobile station displays the basic information about the promotional item as an overlay, somewhat like a pop-up ad. This may involve communication with the server to obtain information for presentation of the overlay. An example of this basic detail display for the promotional item is shown in FIG. 34. In the example, the basic information includes title and the promotional price offer. The pop-up ad showing the basic information also includes a Details button. Selection of the Details button from the pop-up advertisement, on either type of mobile station, would cause the mobile station to navigate directly to the details page (e.g. a page analogous to one of those shown in FIG. 8), for the product promoted for impulse purchase. The detailed information page for the promotional item would provide information as well as add to cart and purchase functionalities similar to those offered by item detail screen display pages discussed in earlier examples. The pricing offered would include an option to purchase at the advertised promotional price/terms, although one or more other pricing options may be offered on the item.

Another approach to attracting impulse shopping, illustrated by way of example in FIGS. 35 and 36 involves use of an animated icon for the item being promoted. The animated icon may be overlaid on the main screen, or in the example of FIG. 35, the animated icon may be overlaid on the applications screen of FIG. 4. If the mobile station is configured to use an icon view like that of FIG. 3 for the high level applications screen, the animated icon may be overlaid on that type of screen, e.g. on the bar for the top-level content category in which the item being promoted is classified. The user selects the animated icon in a fashion similar to selecting the promotional animation of FIG. 33, and such a user input causes the mobile station to convert the animated icon to an overlay with basic information about the item corresponding to the animated icon. FIG. 36 depicts an example of the overlay of basic information, corresponding to the animated icon of FIG. 35. The overlay may include an image related to the item and some descriptive text about the item and/or any special purchase offer associated with the promotion. The overlay showing the basic information also includes a Details button. Selection of the Details button from the overlay, on either type of mobile station, would cause the mobile station to navigate directly to the details page (e.g. a page analogous to one of those shown in FIG. 8), for the product promoted for impulse purchase. The detailed information page for the promotional item would provide information as well as add to cart and purchase functionalities similar to those offered by item detail screen display pages discussed in earlier examples. The pricing offered would include an option to purchase at the advertised promotional price/terms, although one or more other pricing options may be offered on the item.

FIGS. 37-38 and 39-40 show two other examples for impulse shopping promotions using animated icons and associated overlays of basic information. The items promoted for impulse buying may be applications from the application store catalog, multimedia content such as audio or video for downloading to the mobile station, products or services associated with mobile station use (such as the Bluetooth headset in the example of FIGS. 39-40), other products or services offered by the shopping service provider or by partner vendors in the virtual shopping mall.

As noted earlier, many of the screens or pages displayed in the enhanced shopping experience provide access to a context sensitive options menu. FIG. 41 shows an example of the options menus of the two types of devices as might be offered in response to a selection of Options from the icon type main shopping screen of FIG. 3 (although a similar Options menu may be provided from the list versions of the main shopping screen of FIG. 4). In the example of FIG. 41, the Options menu gives the user access to various application manager functions.

FIGS. 41 to 46 show screens or pages that may be presented to the user when desiring to ‘share my wishlist’ from the on-line store with another user. As in the earlier examples, displaying menus and shopping pages at various stages of this type of shopping experience may entail network communications between the mobile station and the server providing the on-line shopping service. In FIG. 41, the wishlists and profiles option is highlighted in the options menu. On the touch screen mobile station, the user selects the item in the menu by touching the bar with the text label for the desired option. On the non-touch mobile station, the user activates the cursor control to highlight the desired selection and presses the key corresponding to the ‘OK’ function.

In our wishlist example, selection of the wishlist option from the Options menu causes the mobile station to transition to a wishlists and profiles page, examples of which are shown in FIG. 42. In each example, a bar at the top of the displayed screen or page identifies that page as that for wishlists and profiles page and contains a first selectable tab for wishlists stored on the mobile station and a second selectable tab for profiles associated with the mobile station. In the drawing, the user of each type of mobile station has selected the Wishlists tab, therefore each mobile station is showing various wishlists under the open selected tab.

At this stage in the present example, the page on each type of device includes a wishlist of the user labeled My Wishlist as well as wishlists for various other persons, e.g. friends and/or family of the user, from whom the user has received shared lists. In the examples, the mobile station represents each wishlist as a bar with an icon and a text label for the person associated with the list. Each bar may also indicate the number of items currently in the respective wishlist. If there are more lists than can be shown on the display of a particular mobile station at a given time, then the mobile station will allow the user to scroll the display to obtain views of similar bars relating to other wishlists. The user selects a bar, to select a desired wishlist from the displayed page, in a manner analogous to selecting a displayed bar from various pages discussed in earlier examples.

Selection of the My Wishlist bar will cause the mobile station to transition to display a My Wishlist page, like one of the pages shown by way of examples in FIG. 43. The non-touch mobile station page in this example is a list type display of a series of bars for the items in the user's wishlist. Each bar shows an icon for the content item or other product in the wishlist, a title and price and a number of stars corresponding to a rating for the item. The touch screen mobile station page in this example is an icon grid type display, with the title, price, and number of stars for the rating shown below the icon for each item. The non-touch mobile station may be configured to provide a grid icon display for the wishlist similar to that shown for the touch screen mobile station, and/or the touch screen mobile station may be configured to provide a list type display for the items in the wishlist similar to that shown for the non-touch mobile station. Again, if the list requires more area to display than is available on the mobile station display, then the mobile station will allow scrolling of the wishlist display to show the bar(s) or icon(s) for any initially hidden items.

On either type of mobile station, the My Wishlist display screen offers an Option menu that the user can select in the same manner as in many of the earlier examples. Here, the options, for example, may allow the user to edit her or his personal wishlist. On the non-touch mobile station, the user may also be able to share her or his wishlist and/or to add an item from the displayed list to the shopping cart. On the touch screen type mobile station, the My Wishlist display screen offers buttons for the add to cart function and for a share wishlist function. The add to cart function operates in a manner similar to the add to cart function discussed in the earlier examples.

For discussion purposes here, in this example, the user selects the share wishlist function from the display of either type of device in FIG. 43. Further discussion of the sharing of the user's wishlist, with regard to FIGS. 43 to 46 will assume that the user has a touch type mobile station for convenience, although similar functionality may be provided for the non-touch mobile station. In the touch screen example, the user touches the Share Wishlist button on the screen shown in FIG. 43, and in response, the mobile station transitions to a display like that shown in FIG. 44.

The share wishlist functionality may implemented in a variety of different ways, and the page or screen illustrated in FIG. 44 is just one example of a touch screen type user interface for such a function. The example allows the mobile station to leverage the native user interface functionality associated with short messaging service (SMS) text communications. Hence, the shopping service application program automatically initiates a SMS text message and inserts an appropriate text such as an invitation to view the user's wishlist and link to the list on the shopping application server. To select one or more destinations for the SMS message regarding the user's wishlist, the display screen may include buttons or bars for various types of address input functions, represented by buttons for Favorite, Contacts and New number, in the example.

In an example of the process flow, the user may touch the contacts button, which causes the mobile station to transition to a display like that of FIG. 45 showing a list of names and associated information of various contacts stored in the user's contact directory in the mobile station. The contact display may be a list or an icon grid or may take other forms. From the contact display, the user can touch a desired one or more of the displayed contacts, to select those contacts and addressees for the wishlist sharing message. When the user has selected all of the desired addressees from among her or his contacts, the user touches the Done button.

After completion of the input of the addressees, the mobile station returns to a display of the message screen, although at this point in the process (FIG. 46), the selected destination addressees (selected from the contact list in our example) are shown in the destination bar above the text pane of the message. In the text message display (either FIG. 44 or 46), the mobile station will allow the user to edit the text of the wishlist sharing message. From the point in the process represented by the exemplary display of FIG. 46, the user can touch the Send button on the display, at the bottom of the screen in the example, to cause the mobile station to transmit the SMS text message with the wishlist sharing invitation through the mobile communication network to the one or more parties identified as addressees of the message.

As on many other pages, the new text message page used for sharing the wishlist (e.g. as shown in FIGS. 44 and 46) may include an icon or button for Options, to allow the user to access an appropriate options menu. The options in such a menu may be those offered for other SMS text messages that the user may send from the touch screen type mobile station.

The network (FIG. 84) will forward the SMS text message regarding sharing the user's wishlist to the intended recipient's mobile station, in the normal manner for communication of SMS messages. The recipient's mobile station may be a non-touch device, but for purposes of the present discussion it is assumed that the recipient's mobile station is a touch screen device similar to that of the user who sent the wishlist sharing message. FIGS. 47 to 49 show screens or pages that may be presented to a user who receives a friend's wishlist from the on-line store, and of those drawings, FIGS. 47 and 48 show only the touch screen mobile station examples.

As represented by the touch screen example in FIG. 47, the recipient's mobile station will display a notification that the station has received a new text message. This display uses the standard SMS message processing functions and notification format resident on the recipient's mobile station. In the example, the notification display indicates the sender of the message, the date received and the time received and offers the user options (represented by touchable buttons) to view the message now or view the message later.

When the recipient operates the mobile station to view the message, the mobile station displays the received message, in this case the wishlist sharing message. This display uses the standard SMS message processing functions and message display format resident on the recipient's mobile station. In the example, the message display on the mobile station shows that the message is from the particular sender, shows the text of the message, shows the date received and shows the time received. The message display offers the user options (represented by touchable buttons) to reply to the message now, go back to the previous display screen or to navigate to a messages folder in the example.

For the wishlist sharing, the received message includes a link, offering the recipient the opportunity to ‘Click here now’ to view the wishlist. The Click here now portion of the message may be highlighted in some way (e.g. by display as underlined text and/or in a different color or type font), to indicate to the recipient user that there is an active link to additional content. Hence, the recipient user can review the SMS message and select to activate the link, for example, by touching the ‘Click here now’ portion of the displayed message.

Assuming the shopping client application is not already running on the mobile station, the user selection of the link in the SMS text message about sharing the sender's wishlist causes the mobile station to launch the shopping client application in the recipient's mobile station and to provide information about the wishlist link to that application. In response, the shopping client application will use the link information to access the sender's wishlist on the shopping application server and download that wishlist to memory in the recipient's mobile station. The shopping client application will also initiate a page display that presents the sender's shared wishlist to the user of the recipient mobile station.

FIG. 49 shows touch and non-touch versions of a shared wishlist display as might be provided in response to selection of the embedded link from the SMS wishlist sharing message. In the example, the shopping client application causes the mobile station to open a Wishlists page and within that page to display an open or expanded view of the newly received wishlist. In each example, a bar at the top of the displayed screen or page identifies that page as that for wishlists. Under the bar, each page displays the newly received wishlist.

For either type of device, the display of the received wishlist may be a list type view or an icon grid view. The drawing shows an example of a list view on the non-touch mobile station and shows an example of an icon grid view on the touch screen version of the mobile station. If the wishlist contains more items than can be viewed at one time, the respective mobile station will allow scrolling as in several earlier examples.

On the non-touch mobile station page, each bar in the list display shows an icon for the content item or other product in the sender's wishlist, a title, a price and a number of stars corresponding to a rating for the item. In the touch screen mobile station display, each item in the icon grid type display includes an icon associated with the title, price, and number of stars for the rating shown below the icon for each item. The received wishlist may also include recommendations from the sender, as shown in the touch screen example in FIG. 49.

On the touch screen version of the mobile station, touching the display screen at a location corresponding to an icon on the wishlist will cause the mobile station to navigate to a page providing more detailed information about the item represented by the icon, for example, in a manner to display a page like any of those discussed above relative to FIG. 8-11 or 18-19.

The touch screen version of the mobile station display for the received wishlist also shows a button for the user's own wishlist, which allows the recipient to add any desired or recommended item from received wishlist to the recipient's own wishlist. A similar functionality may be available on the non-touch version, e.g. via an Options functionality, which would be displayed and selected/activated in a manner similar to various options on the earlier non-touch examples.

On either type of mobile station, the wishlist display offers an add to cart functionality like in several earlier examples. The add to cart functionality may allow the recipient to purchase an item added to the cart for the recipient, as discussed with regard to earlier exemplary purchase transactions. The add to cart functionality may allow the recipient to purchase an item added to the cart as a gift for the sender of the wishlist.

FIGS. 50 and 51 show screens or pages that may be presented to the user when desiring to purchase and send an application to another user from the on-line shopping service as a gift, whereas FIGS. 52 to 55 show screens or pages that may be presented to a user who receives such an application gift from a friend via the on-line store service. As in the earlier examples, displaying menus and shopping pages at various stages of this type of shopping experience may entail network communications between the mobile station and the server providing the on-line shopping service.

For this part of the discussion, assume that the user of either type of mobile station has navigated to a detailed information page for a particular item, like the page discussed above relative to FIG. 8. On the non-touch version of the mobile station, the user can activate a soft key associated with the Options functions. In response, the mobile station overlays an options menu on the current screen display, such as shown for example on the left side of FIG. 50. On the touch screen non-touch version of the mobile station, the user touches the screen in such a manner as to cause the station to scroll down to a portion of the page that further includes a number of buttons on the detail page. As noted in the earlier discussion of FIG. 9, these additional function buttons include an Add to Cart button, an Add to Wishlist button, a Send as Gift button and a Tell a Friend button.

In the examples of FIG. 50, the user now selects the Send as Gift operation. On the non-touch version, the user operates the cursor control key(s) of the station to move the cursor to highlight Send as Gift on the Option menu and then presses the key associated with the ‘OK’ function. On the touch screen mobile station, the user touches the location on the display corresponding to the Send as Gift button.

Responsive to the selection of the Send as Gift functionality, the mobile station transitions to a purchase type display, examples of which are shown in FIG. 51. Either version of the mobile station will display a dialog box for purchase confirmation, in the example, with some explanatory text and with a button for acceptance of the purchase terms (e.g. to Accept the purchase price and related transaction terms). If the user reached this point in the gift purchase process from another user's wishlist, such from a friend's wishlist as in the example of FIG. 49, then the mobile station automatically fills-in the name of the person associated with the wishlist as the intended recipient of the gift. If the user navigated to send a gift feature in a different manner, the mobile station and/or server may provide one or more additional display pages or screens to allow the sender to input information about the recipient to facilitate delivery of the gift.

In either of the examples of FIG. 51, the user can complete the transaction to purchase the selected content item for sending to the other user by selectively actuating the displayed Accept bottom on the respective mobile station. On the touch screen version, the user desiring to complete the transaction merely touches the Accept button on the touch screen. On the non-touch screen version, the user may press the key associated with the ‘OK’ function, to indicate acceptance of the purchase transaction for the selected content item.

In response to transaction acceptance, the mobile station communicates through the network with the store application server to complete financial aspects of the purchase transition, e.g. to charge the purchase price to the sending user's account. Successful completion of the financial aspects of the transaction also causes the shopping application server to initiate procedures for delivery of the gift to the intended recipient. Although the gift may be another type of good, for purposes of a specific example, we will consider delivery of a gift of downloadable content such as an application for the recipient's mobile station.

As with the wishlist functionality, delivery of gifted content to the recipient's mobile station may leverage the native user interface functionality and network communications capabilities associated with SMS text communications. The shopping service application program in the mobile device could automatically initiate a SMS text message transmission as in the example of the sharing of a wishlist. However, as the shopping service provider may prefer to control delivery, e.g. to insure appropriate completion of the financial aspects of the gift purchase, in the present situation, the SMS message transmission is initiated by the shopping application server. The server therefore generates a SMS message addressed to the mobile station of the intended recipient of the gift and sends the message through the network for delivery to that mobile station.

The network (FIG. 84) will forward the SMS text message regarding the gift from the shopping application server to the intended recipient's mobile station, in the normal manner for communication of SMS messages. The recipient's mobile station will display a notification that the station has received a new text message, similar to that discussed earlier with regard to FIG. 47, in the regular SMS message notification format, for example, indicating the sender of the message, the date received and the time received. The notification also offers the user options to view the message now or view the message later.

When the recipient operates the mobile station to view the message, the mobile station displays the received message, in this case the message regarding the gift. The recipient's mobile station may be a non-touch device, but for purposes of the present discussion it is assumed that the recipient's mobile station is a touch screen device. Hence, FIG. 52 shows the gift message display as it might be presented to a user who receives a gift via the on-line store on a touch screen mobile station.

This display uses the standard SMS message processing functions and message display format resident on the recipient's mobile station. As represented by the touch screen example in FIG. 52, the message includes text about the gift and the sender as well as the date and time received. Other information may be provided, such as a rating of the downloadable application gift in the illustrated example. The message display offers the user options (represented by touchable buttons) to reply to the message now, go back to the previous display screen or to navigate to a messages folder, in the example.

To facilitate delivery of the downloadable gift application in our example, the SMS message also includes a link to the gift, offering the recipient to the opportunity to ‘Click here now to receive this gift.’ The Click here now portion of the message may be highlighted in some way (e.g. by display as underlined text and/or in a different color or type font), to indicate to the recipient user that there is an active link to additional content. Hence, the recipient user can review the SMS message and select to activate the link, for example, by touching the ‘Click here now . . . ’ portion of the displayed message.

Assuming the shopping client application is not already running on the mobile station, the user selection of the link in the SMS text message about the gift causes the mobile station to launch the shopping client application in the recipient's mobile station and to provide information about the gift link to that application. In this gifting example, in response to selection of the link, the shopping client application will initially navigate to the main shopping page. As noted, the main page may be a list page FIG. 4 or an icon grid page. In the examples of FIG. 53, the main shopping page on each type of mobile station is configured in an icon grid format. The lower portion of the initial shopping page showing the applications that the user has purchased and downloaded to the particular mobile device is updated to include an icon for the gift application. This shows the user where the application will reside in future after downloading is completed.

However, actual receipt of the gift may be at the option of the recipient mobile station user. Hence, the gift icon in this example represents a link to an information page about the gift application. The gift icon is selected from either the non-touch mobile station or the touch screen, in a manner similar to icon selections in earlier examples. User selection of the gift icon from either type screen shown in FIG. 53 causes the respective mobile station to communicate with the shopping application server to navigate to the information page for the gift application, examples of which are shown in FIG. 54. The information page may provide a variety of information. In the example, a bar near the top of the display provides the title of the gifted application and an image or animation relating to the application may appear below. Additional information may be provided, as in several of the earlier discussed detailed information pages.

In FIG. 54, either version of the mobile station will also display a user selectable bar or button intended to allow the user to indicate an acceptance of the gifted item. The user can complete the transaction and initiate downloading of the gifted content item by selectively actuating the displayed Accept bottom on the respective mobile station. On the touch screen version, the user desiring to accept the gift merely touches the Accept button on the touch screen. On the non-touch screen version, the user may press the key associated with the ‘OK’ function, to indicate acceptance of the gifted content item.

In our example, the purchased gifted item was an application for downloading into the user's mobile station. Actuation of the Accept function causes the mobile station to send the relevant information to the shopping application server. The server initiates the appropriate accounting to charge the purchase price to the sending user's account, which may be on their mobile communication service bill, on a regular account with a third party shopping service provider or on a credit/debit card account. The shopping application server will also initiate the appropriate process steps to download the gifted content item to the user's mobile station. The server may store the content, in which case, it would transmit the gifted item through the network in packets addressed to the user's mobile station. Alternatively, the shopping application may cause another server system to initiate the download communication. In either case, the client software on the mobile station receives and stores the application in memory within the device to make the application or other gifted content available for future use on the mobile station.

While the downloading is ongoing, the mobile station changes its display back to an updated form of the initial shopping page. The page is similar to that shown in FIG. 53 and will allow the user to shop for other content available from the catalog. However, as shown in FIG. 55, the lower portion of the initial shopping page showing the applications that the user has purchased and downloaded to the particular mobile device is updated to show a modified form of the gift icon for the new application, e.g. to show the installation is in progress. When downloading is complete, the mobile station may leave the icon in its second gift state or change the icon for the newly received content item to its regular state, similar to the example of FIG. 13.

As noted in earlier discussions the main shopping page (e.g. either of FIGS. 3 and 4) and many of the other pages offer a variety of different functions under the Options menu. At least from the main shopping screen, as shown for example on the touch screen mobile device in FIG. 56, one of the options is to Rate and Review an item offered via the on-line shopping service. The Rate and Review function allows the user to rate or re-rate any purchased item by selecting the item from the displayed screen, selecting the options menu and then selecting the Rate and Review entry in the options menu, by appropriate touches on the touch screen mobile station or by cursor control and operation of the key associated with the ‘OK’ function on the non-touch version.

FIG. 57 shows how each mobile station might change the display to show an overlay for entering the number of stars from 0 to 5 for rating the selected item. On the touch screen mobile station, the user touches the highest number of stars for the desired rating. On the non-touch version, the user might actuate the appropriate number key on the key pad or navigate the cursor. When the appropriate number of stars is indicated, the user would press the key on the keypad associated with the ‘OK’ function. After entering the rating, each type of mobile station will provide a window display for entry of text for an associated review (see FIG. 58). The touch screen mobile station shows a keyboard, and the user touches displayed keys to enter and edit text for the review. Similar text entry functions may be available on a smartphone version of the non-touch mobile station. However, if the non-touch mobile station has a limited keypad, the user may actuate keys multiple times to enter some characters, in a manner analogous to the techniques used to enter text for SMS message texting. When the user completes entry of the review, the user actuates the done function, by touching a Done button displayed on the touch screen or by actuating a key associated with the displayed Done function on the non-touch version of the mobile station. In either case, the mobile station responds by sending the input rating, the text of the review and an identification of the rated item through the network to the shopping application server. The server stores the rating and review for transmission to the mobile stations of users who view information about the item from the on-line service in the future.

The on-line shopping service also offers search functions, to allow mobile station users to search for items of interest. Search functions may be from any number of different pages or screens in the content or application catalog and may be available for stores and/or the entire mall in the virtual mall. FIGS. 59 to 64 show screens or pages that may be presented to a user to allow the user to search for one or more items in the application catalog, by way of a few examples. As in earlier examples, displaying menus and shopping pages at various stages of this type of shopping experience may entail network communications between the mobile station and the server providing the on-line shopping service.

For the touch screen version of the mobile station in FIG. 59, the search option is shown on a bar below the APPS bar from the first high level category page or main shopping screen in the application catalog (see also FIG. 5). A similar function may be provided on the non-touch mobile station from selection of the Options menu. Once selected on either type of mobile station, the mobile station transitions the display to a search input page, examples of which are shown in FIG. 60.

The touch screen mobile station shows a keyboard, and the user touches displayed keys to enter and edit text for the search. Similar text entry functions may be available on a smartphone version of the non-touch mobile station. However, if the non-touch mobile station has a limited keypad, the user may actuate keys multiple times to enter some characters, in a manner analogous to the techniques used to enter text for SMS message texting. Text may also be entered by automated voice recognition (AVR).

The mobile station may show possible matches as the user enters letters/terms. When the user completes entry of the search query, the user inputs an OK on the non-touch mobile station or touches the displayed return arrow key on the touch screen mobile station. In either case, the mobile station responds by sending the input search query to the shopping application server. The server searches a database of available items, for available applications in our example, to identify available content items meeting the search query within some range of certainty and sends the results back to the mobile station to allow the mobile station to display a results screen such as one of the pages shown by way of example in FIG. 63, as will be discussed more, later.

The search input page on either type of device (FIG. 60) also offers the user other search related information. For example, the search page may also show any recent searches requested via the mobile station. On the touch screen version, the user touches the display of the desired prior search query from the list of recent searches, to cause the mobile station to retrieve the query from memory and re-send the selected query to the shopping application server. On the non-touch version of the mobile station, the user operates the cursor control to highlight the desired prior search query from the list of recent searches and presses the key associated with the ‘OK’ function, to cause the mobile station to retrieve the query from memory and re-send the selected query to the shopping application server.

The mobile stations and the shopping application server may also offer advanced search functions. The user may selected the advanced search by touching the Advanced button beside the search query entry box, either on the main APPS shopping page of FIG. 59 or on the expanded search view of FIG. 60. For the non-touch version, the Advanced search is available as a button selectable by cursor control and OK input, from the search display of FIG. 60.

The on-line shopping service offered by the server and the mobile stations also may implement an automatic query completion feature as shown by way of an example on the touch screen version in FIG. 61.

FIG. 62 shows examples for touch screen and non-touch mobile stations of an Advanced search page offering additional search filters for retrieving user desired search results from the on-line shopping service. The illustrated examples include searches for best rated items, search for free items or in other price ranges and searches by ratings.

FIG. 63 shows touch and non-touch versions of search results displays. Although the results may be presented in a list format, in these examples the results are presented in the form of an icon grid. For each content item (application in our example) meeting search criteria related to the user's query, the mobile station displays an icon as well as a title and an offer price below the icon. In the examples, the mobile stations also display ratings for the various items found as a result of the search. If the results include more matching items than can be shown at one time in the results display, then the display is scrollable, as in several of the earlier page displays, to allow the user to scroll to and view all of the results.

Selecting an item from the search results causes a mobile station to navigate to a page display showing information details to provide more information and purchase functions, as in several of the earlier examples of navigation through the applications catalog. The results display also offers an add to cart functionality, like in several examples discussed earlier. The touch screen version offers a button to allow drag and drop of an item to the user's wishlist. A similar wishlist functionality may be available for the non-touch version of the mobile station from the options menu.

The options menu of the search results pages on the different versions of the mobile station also offer various results sorting capabilities. In the examples of FIG. 64, after selecting sort from an options menu, each mobile station offers its user the ability to sort results based on rating, price, and alphabetically. Other sort options may be offered in addition or as alternatives to those shown.

The client application on each mobile station alone or together with the server application for the shopping service may offer a variety of other related capabilities via the user interface capabilities of the different versions of the mobile stations. For example, FIG. 65 shows a screen or page on which a user can set up a personal profile. In each example, there is a field for a Nickname to be used for various functions like wishlist sharing and gifting, through the on-line shopping service. There may also be bars or buttons for input of the user's gender. Text boxes may be provided for input of other profile data like birthday and zipcode. Bars or buttons may be provided for selecting amongst common areas of interest like sports, games, etc. In the example, not all aspects of the profile input screens are visible on the mobile stations, therefore the mobile stations allow the user to scroll the page to view and interact with elements of the page that may not be initially displayed.

FIG. 66 shows a screen or page offering the user discounted bundles of applications pre-picked by the on-line shopping service provider, whereas FIG. 67 shows a screen or page offering the user a discounted bundle of applications where the bundle is picked by the user. These screens provide functions to obtain additional information about items in the bundles and to purchase the bundles, analogous to functionalities discussed with regard to earlier catalog navigation and purchase examples. Downloading of a purchased bundle could be implemented and displayed to the user in a manner similar to the purchase and downloading of multiple applications from the catalog discussed above relative to FIGS. 21 and 22.

Each of the icons or list bars for previously purchased and downloaded content items shown on a portion of the initial main shopping screen (e.g. FIG. 3 or FIG. 4) allows the user to navigate to a detailed information page about the corresponding item, by selection of the icon from the main shopping page. For example, this might allow a user to review information and upgrade to a better usage pricing option. As another example, such navigation might allow the user to enter a review/rating about the item, send a message about the item to a friend, or purchase a copy of the item as a gift for another user.

FIGS. 68 to 80 show screens or pages that may be presented to a user to allow the user to organize selectable objects for previously purchased applications as presented on the main shopping page. At least some of these organization functions may be implemented by the shopping client in the mobile station without communication with the server.

In the main shopping screen display like that of FIG. 68, the user might select the Add Folder icon on either the touch screen mobile station or non-touch mobile station. In response, the mobile station would offer functionality similar to earlier text entry functionalities to allow the user to enter a name for the new folder (see e.g. FIG. 69). When name entry is done, the mobile station would return to the main shopping screen display which would now show the newly created/named folder together with the icons for the applications that the user has previously purchased from the on-line shopping service (FIG. 70).

From the main shopping screen, the user can move icons representing previously purchased applications to the folder. On the touch screen mobile station, in the example of FIG. 71, the user touches or presses on the icon that the user wants to move to the folder, for a relatively long period of time, sufficient for the mobile station to distinguish this as a long touch gesture as opposed to a momentary touch at a position. Without lifting the finger from the screen, the user moves the touching finger across the screen to the new folder icon, to drag the icon for the selected content item over to the folder and drop the icon into the folder. An example of such a drag and drop gesture is illustrated in FIG. 72. During this operation, the mobile station moves the icon for the selected item along with the moving touch gesture and keeps the moving icon brightly lit in the display as a highlighted icon. However, the mobile station dims back on the brightness of the other icons on the displayed page. The highlighted/bright movement of the selected item icon together with the dimming of the other icons informs the user of the drag and drop mode, as the user drags the item and drops it in the folder. Once the move to the folder is complete, the mobile station removes the selected icon from the purchased application display field and reorganizes the icons for the remaining applications and folders (see FIG. 73 for an example). The non-touch mobile station will allow the user to select and move items to a folder and then reorganize the icons for the remaining applications and folders as shown on the non-touch versions of the screens in the examples of FIGS. 71 to 73. For example, after selecting an icon to move, a text entry bar enables entry of the folder name that the icon should go to (FIG. 72).

FIGS. 74 to 76 show another possible organization functionality, in which the user can manually arrange the icons displayed in the main shopping page. From that screen on the touch screen mobile station, the user touches or presses on the icon that the user wants to move to a new location, for a relatively long period of time, sufficient for the mobile station to distinguish this as a long touch gesture as opposed to a momentary touch at a position. In response, the mobile station dims back on the brightness of the other icons on the displayed page but keeps the selected icon brightly lit in the display as a highlighted icon (see FIG. 75). Without lifting the finger from the screen, the user moves the touching finger across the screen to the desired new location for the selected icon, to drag the icon for the selected content item over and drop the icon at the new location (see FIG. 76). During this operation, the mobile station moves the icon for the selected item along with the moving touch gesture. An example of such a drag and drop gesture is illustrated in FIG. 76. Once the move to the new location is complete, the mobile station reorganizes the icons for the various applications and folders (see FIG. 77 for an example). The non-touch mobile station may allow the user to select and move objects for content items to different locations and then reorganize the icons for the remaining applications and folders as shown on the non-touch versions of the screens in the examples of FIGS. 74 to 77.

From time to time, the shopping service may have available related or updated items with respect to the content items that the user has previously purchased. When the user navigates to the main shopping page, the server will transmit information to the mobile station to present a modified form of the icon for the previously purchased applications. The examples of FIG. 78 show two of the possible modifications of icons to indicate availability of a related product. An up arrow in a circle in association with the previously purchased content item icon might represent that an upgrade of the application corresponding to the icon is now available through the on-line shopping service. A modified icon combining a small or sub-icon for a card in association with all or part of the previously purchased content item icon might represent that a memory card is available for purchase. Now, if the user selects the modified icon, the mobile station and server will enable navigation to a detailed information page for the related item, to present a detailed information display page for the upgrade or for the memory card in the examples.

Another organizational functionality with regard to the purchased content icons is to lock and unlock the functions associated with the icons displayed in the main shopping screen. These functions are offered via the Options menu accessed from the main shopping page, as shown in the various examples of FIGS. 79 and 80. With reference to the touch screen version in FIG. 80, when the lock/unlock function has been accessed, a lock or unlock state can be displayed in association with each of the displayed icons and these states can be toggled by touching the location of each icon on the touch screen display. An OK button causes the mobile station to navigate back to the main shopping page, with any changed icon states, after the user has completed lock/unlock operation. Although the lock/unlock functions are depicted on a touch screen type device, by way of example, similar functions may be provided on the non-touch type device.

FIGS. 81 to 83 show screens or pages related to a Media Center functionality, for example, as presented on a touch screen type mobile station.

The various functions relating to the enhanced shopping experience via a graphical user interface of a mobile station may be implemented in application programming on the mobile station and/or in programming on computers connected for data communication via the components of a packet data network that operate as a shopping application server such as that shown at 25 or 31 in FIG. 84. Although special purpose devices may be used, server devices may be implemented using one or more hardware platforms intended to represent a general class of data processing device commonly used to run “server” programming so as to implement the shopping related server functions discussed above, albeit with an appropriate network connection for data communication.

As known in the data processing and communications arts, a general-purpose computer typically comprises a central processor or other processing device, an internal communication bus, various types of memory or storage media (RAM, ROM, EEPROM, cache memory, disk drives etc.) for code and data storage, and one or more network interface cards or ports for communication purposes. The software functionalities involve programming, including executable code as well as associated stored data, e.g. files used for the enhanced shopping experience offered via the graphical user interface of a mobile station. The software code is executable by the general-purpose computer that functions as the shopping application server and/or that functions as a mobile station type user terminal device. In operation, the server code is stored within the general-purpose computer platform whereas any client code is stored within the user's mobile station. At other times, however, the software may be stored at other locations and/or transported for loading into the appropriate general-purpose computer system or mobile station device. Execution of such code by a processor of the computer platform and/or by a processor of the mobile station enables the system of FIG. 84 to implement the methodology for the enhanced shopping experience via the graphical user interface of the mobile station, in essentially the manner performed in the implementations discussed and illustrated herein.

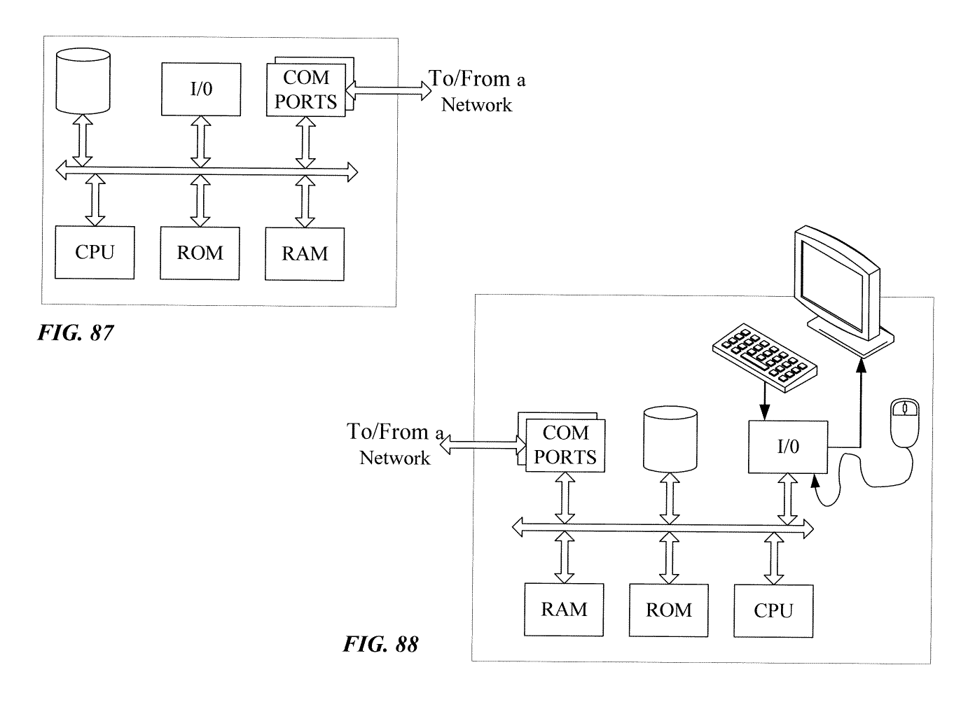

Examples of mobile stations have been discussed above. FIGS. 87 and 88 provide functional block diagram illustrations of general purpose computer hardware platforms. FIG. 87 illustrates a network or host computer platform, as may typically be used to implement a server. FIG. 88 depicts a computer with user interface elements, as may be used to implement a personal computer or other type of work station or terminal device, although the computer of FIG. 88 may also act as a server if appropriately programmed. It is believed that those skilled in the art are familiar with the structure, programming and general operation of such computer equipment and as a result the drawings should be self-explanatory.

The hardware for a server platform, for example, includes a data communication interface for packet data communication. The server platform also includes a central processing unit (CPU), in the form of one or more processors, for executing program instructions. The server platform typically includes an internal communication bus, program storage and data storage for various data files to be processed and/or communicated by the server, although the server often receives programming and data via network communications. The hardware elements, operating systems and programming languages of such server platforms are conventional in nature, and it is presumed that those skilled in the art are adequately familiar therewith. Of course, the server functions may be implemented in a distributed fashion on a number of similar platforms, to distribute the processing load.

Hence, aspects of the methods of the enhanced shopping experience via the graphical user interface of the mobile station outlined above may be embodied in programming. Program aspects of the technology may be thought of as “products” or “articles of manufacture” typically in the form of executable code and/or associated data that is carried on or embodied in a type of machine readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the network service provider or other shopping service provider into the computer platform of the shopping application server and/or into the mobile stations of various users of the shopping service. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

What is claimed is:

1. A method comprising steps of:
(a) displaying on a user's mobile station an initial shopping page of an on-line shopping service, the initial shopping page including a user selectable object for a catalog of downloadable content items, a user selectable object for a virtual mall for items offered by a plurality of vendors and a portion for identifications of any downloadable content items previously purchased and downloaded to the mobile station;
(b) responsive to user selection of the object for the catalog at a time when the initial shopping page is displayed on the mobile station, communicating with a shopping application server through a mobile communication network to obtain information and provide a display via the mobile station to the user of one or more pages of the catalog of downloadable content items, to allow the user to navigate to information about at least one user selected downloadable content item in the catalog;
(c) responsive to user input of an indication of acceptance of a price for the at least one user selected downloadable content item in the catalog on the mobile station, communicating with the shopping application server through the mobile communication network to complete a purchase transaction with respect to the at least one user selected downloadable content item;
(d) downloading the at least one user selected downloadable content item through the mobile communication network to storage in the mobile station;
(e) responsive to user selection of the object for the virtual mall at a time when the initial shopping page is displayed on the mobile station, communicating with the shopping application server to obtain information and provide a display of movement through a virtual representation of a shopping mall;
(f) responsive to further user input during the display of movement through the virtual representation of the shopping mall, displaying information on the mobile station regarding goods available from one of a plurality of virtual stores of the virtual mall;
(g) responsive to user selection of information regarding one of the goods available from the one virtual store, communicating with the shopping application server, and based on the communications, interactively providing information to the user regarding the selected one of the goods, via the mobile station; and
(h) responsive to user input of an indication of acceptance of a price for the selected one of the goods, communicating with the shopping application server through the mobile communication network to complete a purchase transaction with respect to the selected one of the goods.

2. The method of claim 1, further comprising steps of:
responsive to user input of the indication of acceptance of the price for the at least one user selected downloadable content item in the catalog on the mobile station, displaying the initial shopping page of the on-line shopping service on the user's mobile station; and
adding an icon for each of the at least one user selected downloadable content item in the portion for identifications of downloadable content items previously purchased and downloaded to the mobile station.

3. The method of claim 2, wherein:
during downloading, each of the added icons appears in a state indicating downloading is in progress; and
after downloading, each of the added icons appears in a state indicating a respective content item has been previously purchased and downloaded to the mobile station.

4. The method of claim 2, further comprising steps of:
upon a new content item or good related to a content item that has been previously purchased and downloaded to the mobile station becoming available, modifying the icon in the portion for identifications of previously purchased and downloaded content items representing the content item for which the related new content item or good has become available; and
responsive to a user selection of the modified icon, displaying information about the related new content item or good to the user via the mobile station.

5. The method of claim 1, wherein:
the at least one user selected downloadable content item consists of a single downloadable content item; and
the user input of the indication of acceptance relates to a price of the single downloadable content item on a detailed information page about the single downloadable content item displayed to the user via the mobile station.

6. The method of claim 1, wherein:
the at least one user selected downloadable content item comprises a plurality of selected downloadable content items;
the user selects the plurality of downloadable content items via an add to cart functionality on one or more of the pages displayed on the mobile station; and
the user input of the indication of acceptance relates to acceptance of a total price for the plurality of selected downloadable content items.

7. The method of claim 1, wherein:
the initial shopping page displayed in step (a) further includes a user selectable object for deals, and
the method further comprises a step of, responsive to user selection of the object deals at a time when the initial shopping page is displayed on the mobile station, communicating with the shopping application server through a mobile communication network to obtain information and provide a display via the mobile station to the user of at least one page presenting information about at least one special offer of an item in the catalog from the on-line shopping service.

8. The method of claim 1, wherein at least a first page of the catalog of downloadable content items provided in step (b) in response to the user selection of the object for the catalog includes a user selectable object for initiating a search of items in the catalog.

9. The method of claim 1, wherein step (b) includes steps of:
displaying an animation relating to a promotion over one of the pages provided in step (b); and
providing a display of information about the promotion responsive to user input indicating a selection based on the animation.

10. The method of claim 1, wherein the information about at least one user selected downloadable content item in the catalog includes an animated preview regarding the at least one user selected downloadable content item.

11. The method of claim 1, further comprising:
the mobile station communicating with the shopping application server regarding a user selected customization for the virtual mall,
wherein at least the display in step (e) is configured in accordance with the user selected customization for the virtual mall.

12. A method comprising steps of:
(a) displaying on a user's mobile station an initial shopping page of an on-line shopping service, the initial shopping page including a user selectable object for a catalog of downloadable content items and a portion for identifications of any downloadable content items previously purchased and downloaded to the mobile station;
(b) responsive to user selection of the object for the catalog at a time when the initial shopping page is displayed on the mobile station, communicating with a shopping application server through a mobile communication network to obtain information and provide a display via the mobile station of a page containing selectable objects representing top-level content categories for the downloadable content items in the catalog;
(c) responsive to user selection of the object representing one of the top-level content categories displayed on the mobile station, communicating with the shopping application server through the mobile communication network to obtain information and provide a display via the mobile station of a page containing selectable objects representing sub-categories for the downloadable content items in the catalog under the selected top-level content category;
(d) following a user selection of the object representing one of the sub-categories displayed on the mobile station, communicating with the shopping application server through the mobile communication network to obtain information and provide a display via the mobile station of a page containing selectable objects representing downloadable content items in the one sub-category;
(e) responsive to user selection of the object representing a downloadable content item displayed on the mobile station, communicating with the shopping application server through the mobile communication network to obtain information and provide a display via the mobile station of a page containing detail information about the selected downloadable content item, including an offer price;
(f) responsive to user input of an indication of acceptance of the offer price, communicating with the shopping application server through the mobile communication network to complete a purchase transaction with respect to the selected downloadable content item; and
(g) downloading the selected downloadable content item through the mobile communication network to storage in the mobile station.

13. The method of claim 12, wherein in step (c), the page containing selectable objects representing sub-categories for the downloadable content items in the catalog also includes icons representing the top-level content categories to allow the user to select and navigate to a page display of any selected other one of the top-level content categories.

14. The method of claim 13, wherein in step (d), the page containing selectable objects representing downloadable content items in the one sub-category includes icons representing the sub-categories under the selected top-level content category to allow the user to select and navigate to a page display of any selected other one of the sub-categories.

15. The method of claim 12, wherein in step (b), the objects representing top-level content categories for the downloadable content items in the catalog are displayed in a list format.

16. The method of claim 12, wherein in step (b), the objects representing top-level content categories for the downloadable content items in the catalog are displayed as a grid of representative icons.

17. The method of claim 12, further comprising steps of:
responsive to user input of the indication of acceptance of the price, displaying the initial shopping page of the on-line shopping service on the user's mobile station; and
adding an icon for the selected downloadable content item in the portion for identifications of any downloadable content items previously purchased and downloaded to the mobile station.

18. The method of claim 17, wherein:
during downloading, the added icon appears in a state indicating downloading is in progress; and
after downloading, the added icon appears in a state indicating the selected downloadable content item has been previously purchased and downloaded to the mobile station.

19. The method of claim 17, further comprising steps of:
upon a new content item or good related to a content item that has been previously purchased and downloaded to the mobile station becoming available, modifying the icon in the portion for identifications of previously purchased and downloaded content items representing the content item for which the related new content item or good has become available; and
responsive to a user selection of the modified icon, displaying information about the related new content item or good to the user via the mobile station.

20. The method of claim 12, wherein the display in step (d) includes a display in a darkened state of objects representing other sub-categories for the downloadable content items in the catalog under the selected top-level content category.

21. The method of claim 12, further comprising, in response to the user selection of the object representing the user selected downloadable content item, displaying an animated preview regarding the selected downloadable content item.

22. The method of claim 12, wherein:
responsive to the user selection in step (e) and responsive to user selection of the object representing at least one other downloadable content item displayed on the mobile station, the communicating with the shopping application server through the mobile communication network identifies a plurality of downloadable content items as user selections for purchase and providing the display of the page containing detail information about the selected downloadable content item displays a total price for purchase of the plurality of downloadable content items to the user via the mobile station,
the completed purchase transaction is a purchase transaction with respect to the plurality of downloadable content items, and
the downloading comprises downloading all of the plurality of downloadable content items through the mobile communication network to storage in the mobile station.

23. The method of claim 22, wherein the user selects the downloadable content items via an add to cart functionality on one or more of the pages displayed on the mobile station.

24. The method of claim 23, wherein the user selects the objects representing downloadable content items via a drag and drop gesture on a touch screen display of the mobile station to add items to the cart.

25. The method of claim 22, further comprising steps of:
responsive to the user input of the indication of acceptance, displaying the initial shopping page of the on-line shopping service on the user's mobile station; and
after downloading, adding an icon for each of the user selected downloadable content items in the portion for identifications of any downloadable content items previously purchased and downloaded to the mobile station.

26. The method of claim 25, wherein:
during downloading, each of the added icons appears in a state indicating downloading is in progress; and
after downloading, each of the added icons appears in a state indicating a respective content item has been previously purchased and downloaded to the mobile station.

27. The method of claim 25, further comprising steps of:
upon a new content item or good related to a content item that has been previously purchased and downloaded to the mobile station becoming available, modifying the icon in the portion for identifications of previously purchased and downloaded content items representing the content item for which the related new content item or good has become available; and
responsive to a user selection of the modified icon, displaying information about the related new content item or good to the user via the mobile station.

28. A method comprising steps of:
(a) responsive to user selections of objects of an on-line shopping service displayed on a mobile station of the user, communicating with a shopping application server through a mobile communication network to obtain information and provide display via the mobile station to the user of one or more pages of the catalog of items available from the on-line shopping service, to allow the user to navigate to information about a plurality of the items available from the on-line shopping service;
(b) responsive to input from the user via the mobile station, identifying one or more of the plurality of the items for inclusion in a wishlist for the user; and
(c) transmitting a short messaging service (SMS) message through the mobile communication network to a mobile station of a party selected by the user, the SMS message containing a link for activating a shopping client application program in the selected party's mobile station to initiate communication through the mobile communication network with the shopping application server to obtain the user's wishlist for presentation to the selected party via a user interface configured by the shopping client application program.
